(19) United States
(12) Patent Application Publication
(10) Pub. No.: US 2026/0018159 A1
(43) Pub. Date: Jan. 15, 2026

(54) TELECOMMUNICATIONS SWITCH-TYPE INFRASTRUCTURE FOR COMMUNICATIONS WITH CALL ROUTER AND AUDIO RECORD SERVER FOR COMPUTATIONAL SOURCE-TO-TARGET LANGUAGE CONVERSION VIA APPLICATION OF ARTIFICIAL INTELLIGENCE AGENTS

(71) Applicant: CHERYL EE-LIN CUNNINGHAM, PFLUGERVILLE, TX (US)

(72) Inventors: CHERYL EE-LIN CUNNINGHAM, PFLUGERVILLE, TX (US); JAMES DAVID HARLOW, SAN JOSE, CA (US)

(73) Assignee: CHERYL EE-LIN CUNNINGHAM, PFLUGERVILLE, TX (US)

(21) Appl. No.: 19/261,984

(22) Filed: Jul. 7, 2025

Related U.S. Application Data
(60) Provisional application No. 63/670,669, filed on Jul. 12, 2024.

(51) Int. Cl. G10L 13/00; G10L 15/16; H04L 51/02

(52) U.S. Cl. CPC G10L 13/00; G10L 15/16; H04L 51/02

(57) ABSTRACT

A class-4 telecommunications switch hosts artificial-intelligence agents that convert live speech to text, translate the text between languages, and synthesize natural speech in real time. The switch proxies calls among public trunks, PBX/media gateways, and cloud ACD/CRM services, embedding diacritic-rich transcripts and user-specific language-model personalization. Deployable at the customer edge, in the PSTN core, or as SaaS, the system supports one-to-one, one-to-many, many-to-one, and many-to-many call patterns. FPGA, ASIC, or SoC accelerators minimize latency and bandwidth, cutting capital cost while improving global voice interoperability and cybersecurity.

### CROSS-REFERENCE TO RELATED APPLICATIONS

This application claims priority to U.S. Provisional Patent Application No. 63/670,669, filed on Jul. 12, 2024, the entire disclosure of which is incorporated herein by reference.

### FEDERALLY SPONSORED RESEARCH OR DEVELOPMENT

Not applicable.

### BACKGROUND

### Field

The present disclosure relates generally to telecommunications infrastructures, and, more particularly, to a telecommunications switch-type infrastructure for computational source-to-target language conversion, such as in real or near-real time, for example, via application of one or more artificial intelligence agents.

### Information

In order to meet the ever-increasing demands for telecommunication or related services, efforts continue to be made to improve telecommunications or related technologies, such as, for example, to improve capacity, increase data transfer speeds, reduce costs, implement additional features or capabilities, or the like. Furthermore, as artificial intelligence (AI) applications become increasingly sophisticated, utilization of suitable AI agents, such as to assume a growing number of responsibilities, including helping to bring improvements to telecommunications or related technologies, for example, continues to be an area of development.

### BRIEF SUMMARY

A class-4 telecommunications switch cooperates with AI agents to perform real-time speech-to-text, language translation, and text-to-speech so that callers speaking different languages converse seamlessly over circuit- or packet-switched networks while diacritic-rich transcripts and personalized language models maintain fidelity and security.

### BRIEF DESCRIPTION OF THE DRAWINGS

Claimed subject matter is particularly pointed out and distinctly claimed in the concluding portion of the specification. However, both as to organization or method of operation, together with objects, features, or advantages thereof, it may best be understood by reference to the following detailed description if read with the accompanying drawings in which:

FIG. 1 illustrates a multi-layered telecommunications infrastructure (2500) designed to support real-time or near real-time computational language conversion using AI agents. At the top, the Geosynchronous Earth Orbit (GEO) satellite layer (2510) provides broad, high-latency global coverage. Below it, the Medium Earth Orbit (MEO) layer (2520) offers a balance between coverage and latency while the Low Earth Orbit (LEO) cubesats layer (2530) delivers low-latency, high-speed data transmission ideal for real-time communication. This space-based network is integrated with a terrestrial layer (2540) encompassing IoT consumer goods and gaming applications enabling connectivity for smart devices and interactive platforms. Supporting mobile and transport-based connectivity, the infrastructure includes aircraft (2532), vehicles and fleets (2542) and maritime systems (2544). End-user access is enabled through 5G/6G smartphones and internet-enabled devices forming a cohesive global communication ecosystem capable of supporting seamless, AI-driven multilingual interaction across diverse domains and platforms.

FIG. 2 depicts a telecommunications network (2200) that operates in a one-to-one configuration, enabling real-time or near real-time language conversion between individual users. In this implementation a Japanese speaker (330) communicates with an Arabic receiver (2620) through a network-enabled translation process. The system performs translation of foreign text to Japanese text (2602) and foreign text to Arabic text (2604) depending on the direction of communication. For audio-based interaction the translated text is further converted into spoken language audio files with foreign text translated to Japanese and converted to a Japanese .wav file (2612) for playback to the Japanese user and foreign text translated to Arabic and converted to an Arabic .wav file (2614) for playback to the Arabic user. This configuration allows seamless multilingual communication through automated translation and speech synthesis, enabling natural and efficient exchanges between users of different languages over the telecommunications network.

FIG. 3 illustrates an example telecommunications network (300) operating in a one-to-many configuration where a single English speaker (310) communicates simultaneously with multiple recipients in different languages. The process begins with speech-to-text conversion (350) where the English audible speech is transcribed to text (352). The transcribed English text then passes through an interpretation and translation module (360) which translates the content into multiple target languages, including Japanese (2602), Arabic (2604), English refinement or repetition (2606), and Mandarin (2608). Following translation, the system utilizes text-to-speech synthesis (370) to generate spoken audio outputs in the respective languages: translated text+Japanese .wav file (302), translated text+Arabic .wav file (304) and translated text+Mandarin .wav file (306). These audio files are delivered to the respective receivers, including the Japanese receiver (2610), Arabic receiver (2620) and Mandarin speaker (320). This configuration demonstrates a multilingual broadcasting capability, allowing one speaker to engage with a diverse, multilingual audience through AI-powered translation and voice synthesis in real or near real time.

FIGS. 3A-3D illustrates a schematic block diagram of an example one-to-many telecommunications network configuration designed to support real-time multilingual voice translation using AI-enabled cloud services. The system includes various speakers English Actor (310), Arabic Actor (330), Mandarin Actor (320) and Japanese Actor (340) each connected via laptops (312, 314, 316, 318) equipped with HTML5 browsers, user-specific channel management agents and a backend processing system called JOSH which stores pre- and post-translation text and .wav files in the DOM. The English speech is first processed through a Speech-to-Text GA (322) for low-latency, streaming transcription and trickled as JSON data to databases. This transcription is then handled by a Language Translation GA (324, 326) to convert text into target languages like Arabic, Mandarin, and Japanese. Each translated text is synthesized using a Text-to-Speech GA producing natural-sounding audio output in the respective language formats (e.g., Arabic .wav+Arabic.txt). The system relies on HTTP POST requests to IBM Watson endpoints for speech recognition and synthesis, and stores results in graph databases for personal and regional LLMs. A publish-subscribe message bus enables real-time updates and all data exchanges use secure APIs with authorization tokens. This architecture enables scalable multilingual communication where one speaker can be understood simultaneously by multiple recipients in different languages.

FIG. 4 illustrates a telecommunications network (400) configured to operate in a many-to-one configuration enabling multilingual inputs from various speakers to be interpreted and delivered to a single receiver in their preferred language. In this setup, users such as a Mandarin speaker (320) a Japanese receiver (2610) and an Arabic receiver (2620) communicate toward a centralized English receiver (2630). Spoken input from the Mandarin speaker undergoes speech-to-text conversion (350) with Mandarin audible speech transcribed to text (358). The resulting text is processed through an interpretation and translation module (360) where it is translated into multiple languages including English (2606), Japanese (2602) Arabic (2604) and Mandarin (2608). Each translated text is then converted into an audio file using text-to-speech synthesis (370) producing outputs such as translated text+English .wav file (308) Japanese .wav file (302) and Arabic .wav file (304). These audio outputs are directed to their respective recipients ensuring that regardless of the source language, the final message is received in the listener's native or selected language. This configuration supports converged multilingual communication toward a common recipient, streamlining global collaboration and multilingual conferencing.

FIG. 5 presents a telecommunications network operating in a many-to-many configuration enabling real-time multilingual communication among speakers and receivers of different languages. Participants include an English speaker (310), Mandarin speaker (320), Japanese speaker (330) and Arabic speaker (340). Each speaker's audible speech is first transcribed via speech-to-text modules Japanese (502), Mandarin (504), English (506) and Arabic (508). The transcribed text is then routed to a translation module which translates it into various target languages: to English (2606), to Mandarin (2608), to Japanese (2602) and to Arabic (2604). Each translated text is then processed through text-to-speech conversion resulting in audio files: Japanese .wav (302), Arabic .wav (304), Mandarin .wav (306) and English .wav (308). These outputs are delivered to the corresponding receiver's English receiver (2630), Japanese receiver (2610), Arabic receiver (2620) and Mandarin receiver (2640) ensuring that each participant receives communications in their native or selected language. This configuration demonstrates a highly integrated AI-powered network capable of facilitating seamless, real-time multilingual dialogue across global participants.

FIG. 6 illustrates a schematic block diagram (600) of an example AI-agent runtime adapter system, highlighting how AI agents perceive, process and act within a dynamic environment. At the core is the AI agent runtime environment (630) implemented within a wavefront array (SISD Single Instruction, Single Data) architecture which facilitates efficient sequential decision-making. The system begins with agent sensors (610) capturing inputs from the environment (608) interpreted as percepts (606) signals that inform the agent of “what the world is like now” (602). These inputs are processed using condition-action rules (606) to decide “what action I should do now” (604). The system maintains and updates internal states such as current state (612a) how the world evolves (612b) and what the agent's actions do (612c). The outcomes are carried out via actuators completing the perception-decision-action loop. This runtime framework enables adaptive, context-aware responses from AI agents operating in real-time telecommunications or language processing environments.

FIG. 7 compares two architectural models of operating systems: a monolithic kernel-based system (710) and a microkernel-based system (720). In the monolithic kernel architecture components such as application system calls, virtual file system (VFS), interprocess communication (IPC), file system, scheduler, virtual memory, device drivers and dispatcher all operate within the kernel mode providing direct and high-performance access to hardware. Both user mode and kernel mode interact closely, but this tightly coupled design can be less stable or secure if one component fails. In contrast, the microkernel architecture (720) separates key functionalities into isolated modules. Here applications, IPC, UNIX server, device drivers and file servers operate primarily in user mode while only essential services such as basic IPC, virtual memory management and scheduling remain in kernel mode. This separation enhances system stability, modularity and security by minimizing kernel responsibilities and isolating failures.

FIG. 8 presents a schematic of a heterogeneous AI-agent runtime adapter (610) which may be implemented, either fully or partially within a uniprocessor architecture such as SISD (Single Instruction, Single Data). The system models the core perception-decision-action loop of an AI agent. Input is received from the environment (608) through sensors generating precepts that represent “what the world is like now” (602). The agent processes these precepts using condition-action rules (606) to determine “what action I should do now” (604). The chosen response is executed through actuators allowing the agent to interact with the environment. This runtime adapter supports adaptive, context-aware behavior, even within resource-constrained processing environments, by efficiently managing sensing, reasoning, and action cycles in a modular and unified system.

FIG. 9 illustrates a model-reflexive AI-agent runtime adapter (620) which may be implemented either fully or partially within a wavefront array architecture such as SISD, MISD or similar computational structures. This advanced AI-agent framework expands on traditional perception-action models by incorporating self-awareness and predictive modeling. The agent receives input from the environment (608) as precepts (606) representing “what the world is like now” (602). Using condition-action rules (606) and internal state representations (612a) the agent determines “what action I should do now” (604). Additionally, the agent maintains models of how the world evolves (612b) and what my actions do (612c) enabling forward-looking, reflexive decision-making. Actuators then carry out the selected actions in the environment. This configuration allows the agent not only to react to current stimuli but also to adapt based on predicted outcomes, leading to more intelligent and context-aware behavior in real-time or near real-time operations.

FIG. 10 illustrates a goal-type AI-agent runtime adapter (1000) which may be implemented, wholly or partially, within a wavefront-array architecture (e.g., SISD). This AI-agent framework is designed to support goal-driven decision-making. The agent interacts with the environment (608) by receiving precepts forming an understanding of “what the world is like now” (602). It maintains an internal state (612a) and uses models to predict how the world evolves (612b) and what its actions do (612c). Before acting, the agent evaluates potential outcomes, such as “what it will be like if I do action A” (614) and compares them against its defined goals (616). Based on this analysis, the agent decides “what action I should do now” (604) and executes the selected action via actuators. This architecture enables the AI agent to plan purposefully, anticipate consequences and act intelligently toward achieving specific objectives in dynamic environments.

FIG. 11 illustrates the architecture of a cybersecurity AI-agent system (2700) that integrates intelligent mobile agents, game theory, and distributed detection to defend against network attacks. A network security officer (2702) oversees operations, supported by an intrusion detection server (2704) and a mobile agent platform factory (2714). These platforms deploy mobile agents through migration mechanisms (2706) across a network mode (2712) that includes multiple nodes such as PC1, PC2, and PC3. The system uses an intrusion detection processor trained on the KDD dataset classifying network traffic into categories like normal, smurf, Neptune, back and multihop with detection volumes reaching over 143,000 events. The agents monitor the network using sniffer tools and detection engines and interact with attackers through a multi-step process: (1) detecting the attack (2) engaging in a non-cooperative game to analyze adversarial behavior (3) computing a risk value using Nash equilibrium (4) entering a cooperative game to coordinate defense (5) activating Working Group Agents (WGAs) (6) computing Shapley values to evaluate contribution, (7) generating and sending an attack report and (8) deploying Local Agents (LAs) to threatened nodes for direct intervention. This system enables real-time, intelligent and collaborative cyber defense across dynamic and distributed network environments.

FIG. 12 illustrates a utility-type AI-agent runtime adapter (1200) which may be implemented, in whole or in part, within a wavefront array architecture such as SISD, MISD or MIMD. This agent model is designed to make intelligent, goal-aligned decisions based on utility optimization. The agent receives precepts from the environment (608) to assess “what the world is like now” (602) and maintains an internal state (612a). It uses models to understand how the world evolves (612b) and what its actions do (612c). The agent predicts “what it will be like if I do action A” (614) for various possible actions and evaluates each future state using a utility function (618) which determines “how happy I will be in such a state” (619). The action that yields the highest utility is selected and executed through actuators. This architecture enables AI agents to reason not only about outcomes but also about the desirability of those outcomes, making decisions that maximize satisfaction or benefit within complex, dynamic environments.

FIG. 13 depicts an unsupervised or supervised learning AI-agent runtime adapter (1300) which may be implemented, in whole or in part, within a wavefront-array architecture (e.g., SISD, MISD, MIMD). This learning-oriented agent continuously improves its performance through interaction with the environment (608). The agent receives percepts from the environment via Critic Sensors (1302) which compare the agent's behavior to a predefined performance standard and provide feedback. The Learning Element (1304) uses this feedback and defined learning goals to update the agent's internal models and decision-making strategies. To support learning, a Problem Generator (1306) introduces new experiments or challenges, encouraging exploration and adaptation. The Performance Element (1308) applies learned behavior through effectors, producing actions that impact the environment, which in turn may change as a result. This adaptive feedback loop enables the agent to refine its behavior over time, whether through supervised learning (with feedback based on correct outcomes) or unsupervised learning (pattern discovery without explicit labels), enhancing autonomy and effectiveness.

FIG. 14 illustrates an example multi-agent platform (1400) structured in a layered architecture to support intelligent task execution and communication across distributed components. The platform is divided into three functional layers: The Superior Layer (1402) the Intermediate Layer (1404) and the Reactive Layer (1406). The Superior Layer manages communication by protocol and performs high-level planning according to tasks often handled by superior agents or super users. The intermediate layer focuses on task-based planning through message passing communication facilitating coordination among agents via structured messages, orders, and information exchanges. The reactive layer (1406) handles centralized planning and real-time action/perception where reactive agents operate locally within locality a, b, and c responding to environmental stimuli. Components such as component a, b, and c and connectors allow the platform to dynamically create new components or connectors enabling scalability and adaptability. Both normal users and super users interact with the platform by sending user messages managing new connections or deploying new agents. This hierarchical, modular design allows the system to perform complex, coordinated tasks in a flexible and scalable multi-agent environment.

FIG. 15 illustrates a system (1500) comprising an aggregator AI-agent architecture designed to process uncertain sensor data, generate predictions and support decision-making. Within the system, machine A (1510) operates in environment A (1520) and is monitored by a sensor agent (1502) which collects sensor data with uncertainty. This raw data is passed to the aggregator agent (1506) which combines and processes it into aggregated data subsequently stored in a historical database (1514). A predictor agent (1504) utilizes this historical and current aggregated data to generate predictive models, which are refined through a model trainer agent (1512). The trained models are then presented through a display model and visualized to users via the user interface agent (1516). Finally, insights and model outputs inform the decision maker agent (1508) enabling intelligent, data-driven decisions. This integrated agent-based system allows for robust handling of uncertain data, continuous learning and real-time interaction between human users and AI-driven processes.

FIG. 16 depicts various aspects of a trusted platform module (TPM)-based AI-agent system (1600) designed to enhance cybersecurity in embedded or networked environments. The system is built to detect and respond to threats such as hacking (1602), spoofing (1604) and data falsification (1606). Central to the architecture is the TRN chip (1620) which works in conjunction with crypto software (1622) and secure boot software (1624) to establish a secure execution environment. Critical cryptographic operations like sealing, signing and sealed-signing (1610) protect data and ensure integrity. The system monitors real CAN packets (1632) and uses feature extraction (1634) to identify patterns. These features are fed into a classifier (1636) that performs a normal vs. attack decision (1638). For accurate detection, the system is trained using labeled CAN packets (1640) processed through a DNN (Deep Neural Network) structure (1644) comprising input layers, hidden layers, and output layers (1642). This AI-agent architecture combines trusted hardware and deep learning to enable secure, intelligent and adaptive cyber threat detection in real time.

FIG. 17 (1700) illustrates a comparative overview of traditional PBX systems versus hosted VoIP PBX architectures, highlighting the evolution of enterprise telecommunication from hardware-bound to cloud-native models. On the left, the legacy setup features the CICAI multilingual media gateway switch (1710) connected to the Public Switched Telephone Network (PSTN, 1720) via the Monmouth voice switch, which communicates with long-distance carriers (e.g., LD Carrier 1 and 5). Voice traffic is managed through a PBX switch (1725) with endpoints like IP phones (IP 331, IP 650) routed via a firewall (1716) and router (1718). On the right, labeled “How it's done after 2030,” the configuration shifts to a hosted VoIP PBX solution (1760), where devices connect to a cloud-based SaaS telephony service (CICAI class-4, 1715a-c) over the Internet with Quality of Service (QOS) guarantees. This cloud model removes the dependency on on-premises PBX hardware while maintaining PSTN connectivity via the Monmouth switch (1735). The updated system enhances operational agility, reduces costs, and supports scalable communications infrastructure for modern enterprises.

FIG. 18 (1800) illustrates a call center use case in which CICAI (Cognitive Intelligent Communication AI) is deployed at the entry point to customer premises, enabling intelligent routing, recording and integration with cloud services. The call flow begins from the Public Switched Telephone Network (PSTN) (1804) or Plain Old Telephone Service (POTS) lines, reaching the customer (1802) via T1/T3 or E1/E3 trunks (1806). These lines terminate at the brick-and-mortar demarcation point (1808) where the call audio (1810) enters the system. The audio may be converted to VoIP call audio (1812) and processed by the CICAI route-switch processor (1816) which dynamically routes calls based on AI logic. Calls are further managed by a CTI/ACD server (1814) for intelligent call distribution and integrated with CRM systems hosted in the cloud (1824). Audio is also captured by an audio record server (1818) for compliance or analytics. Within the corporate LAN/WAN (1822) running TCP/IP over 802.1 the system connects to contact center employees (1820) using workstations supported by software applications (1826) and linked to a media gateway or PBX system (1828). This architecture blends traditional telephony with modern AI, cloud services, and IP networking to deliver efficient, scalable and intelligent call center operations.

FIG. 19 depicts a CICAI-powered call flow architecture deployed at the entry point of customer premises, integrating traditional telephony, cloud AI and real-time communication protocols to streamline and personalize call center interactions. The process begins when a customer (1802) accesses a web portal (1904), which coordinates with the Public Switched Telephone Network (PSTN) (1902). The portal generates a unique SIP URI (1951) and auth token (1952), returning these along with IP and port details (1904). A signaling gateway (1906) initializes low-latency communication protocols (e.g., RTP/SRTP, WebRTC, JREAP C, websockets) via client initialization (1907). The system retrieves the customer's estimated wait time (1905) and returns this information to the customer device (1906). Once ready, the IVR/CTI/ACD system with a built-in co-browser (1910) instructs the customer's device to initiate a call to the assigned SIP URI of a contact center employee (1920). The CICAI core (1912) facilitates intelligent routing, integrates with the CRM system (1916) and draws on Personalized, Regional and Generalized LLMs (1918) for AI-enhanced interaction. Call audio (1914) is recorded for compliance, and secure signaling and media transport is enforced through SRTP/DTLS (1916). Sessions are terminated securely with URI and RTP session cleanup (1921, 1922). The entire system complies with RFC 3986 for SIP URI authorization (1902), creating a seamless, secure and intelligent communication path between customers and call center agents.

FIG. 20 presents a schematic block diagram (200) of an example Internet of Things (IoT)-type device illustrating its core components and functional architecture. At the center is the Processor (210) responsible for executing instructions and coordinating operations. The processor interfaces with memory (230) which stores data and program logic, including software/firmware code (232). The device interacts with its environment through various sensors (250) that collect data and counters/timers (260) that support time-based operations and event tracking. A display (240) provides user-facing feedback or system status. Communication with other devices or networks is enabled via a communications interface (220) allowing the IoT device to send or receive data wirelessly or through wired connections. This architecture enables intelligent, connected operations suitable for various IoT applications such as monitoring, automation or remote control.

FIG. 21 presents a schematic block diagram (200) of an example Internet of Things (IoT)-type device illustrating its core components and functional architecture. At the center is the Processor (210) responsible for executing instructions and coordinating operations. The processor interfaces with memory (230) which stores data and program logic, including software/firmware code (232). The device interacts with its environment through various sensors (250) that collect data and counters/timers (260) that support time-based operations and event tracking. A display (240) provides user-facing feedback or system status. Communication with other devices or networks is enabled via a communications interface (220) allowing the IoT device to send or receive data wirelessly or through wired connections. This architecture enables intelligent, connected operations suitable for various IoT applications such as monitoring, automation or remote control.

FIG. 22 illustrates a schematic diagram (1100) of an example computing environment implementation showcasing how multiple devices interact over a network and share resources for processing and data management. The system includes interconnected devices First Device (1102), Second Device (1104) and Third Device (1106) communicating via a network (1108). Each device comprises core computing components including a processor (1120) responsible for executing instructions and a memory hierarchy consisting of primary memory (1124) for fast-access data storage, secondary memory (1126) for long-term storage and general memory (1122). Data input and output operations are managed through an input/output interface (1132) while communication across devices and systems is handled by a communications interface (1130). Additionally, the system utilizes a computer-readable medium (1140) which can store instructions or data used by the processor. This modular architecture supports distributed computing, remote resource access and scalable processing across networked systems.

Reference is made in the following detailed description to accompanying drawings, which form a part hereof, wherein like numerals may designate like parts throughout that are corresponding or analogous. It will be appreciated that the figures have not necessarily been drawn to scale, such as for simplicity or clarity of illustration. For example, dimensions of some aspects may be exaggerated relative to others. Further, it is to be understood that other embodiments may be utilized. Furthermore, structural or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims), or to a particular claim. It should also be noted that directions or references, for example, such as up, down, top, bottom, and so on, may be used to facilitate discussion of drawings and are not intended to restrict application of claimed subject matter. Therefore, the following detailed description is not to be taken to limit claimed subject matter or equivalents.

### DETAILED DESCRIPTION

References throughout this specification to one implementation, an implementation, one embodiment, an embodiment, or the like means that a particular feature, structure, characteristic, or the like described in relation to a particular implementation or embodiment is included in at least one implementation or embodiment of claimed subject matter. Thus, appearances of such phrases, for example, in various places throughout this specification are not necessarily intended to refer to the same implementation or embodiment or to any one particular implementation or embodiment. Furthermore, it is to be understood that particular features, structures, characteristics, or the like described are capable of being combined in various ways in one or more implementations or embodiments and, therefore, are within intended claim scope. In general, of course, as has always been the case for the specification of a patent application, these and other issues have a potential to vary in a particular context of usage. In other words, throughout the patent application, particular context of description or usage provides helpful guidance regarding reasonable inferences to be drawn; however, likewise, “in this context” in general without further qualification refers to the context of the present patent application.

As alluded to previously, in order to meet the ever-increasing demands for telecommunication or related services, efforts continue to be made to improve telecommunications or related technologies, such as, for example, to improve capacity, increase data transfer speeds, reduce costs, implement additional features or capabilities, or the like. Furthermore, as AI-type applications become increasingly sophisticated, utilization of suitable (e.g., specifically trained, tailored) AI agents, such as to assume a growing number of responsibilities, including helping to bring improvements to telecommunications or related technologies, for example, continues to be an area of development.

Embodiments described herein may involve telecommunications networks, such as digital or analog networks, for example, with one or more data processing units that may be communicatively connected or coupled to one or more computing devices or platforms so as to provide computational source-to-target language conversion services in real time or near-real time. As will be described in greater detail below, these services may include, for example, interpretation, translation, transcription, transliteration, aspects or processes, such as implemented, at least in part, in connection with one, or a plurality of, sender(s) and one, or a plurality of, receiver(s) engaged in unilateral, bilateral, directional, or omnidirectional network-type communication, for example. Thus, example embodiments may, for example, be utilized, in whole or in part, to facilitate or support one or more technological solutions to one or more global technological problems that may otherwise be unsolvable, including, for example, organizing or collapsing discrete operational equipment (e.g., legacy of prior years of phone-service provisioning) into more effective or more efficient (e.g., smaller, greener, with lower power demands) footprints. As a way of illustration, according to World Trade Organization (WTO), high costs (e.g., US$1.5 Trillion Dollars, currently) in non-tariff barriers to trade and cross-border commercial transaction inefficiencies may be due to ethnic, cultural, or language barriers. As will also be seen, one or more embodiments described herein may address these inefficiencies, among other aspects.

Thus, “Computational Interpretation of Communication using Artificial Intelligence Algorithms” (CICAI) may comprise, for example, a communications network, such as a multi-agent network, as one particular example, of one or more processing units executing computer-readable instructions to facilitate or support one or more Artificial Intelligence-type processes, operations, or algorithms. In some instances, these processes, operations, or algorithms may include neural-network algorithms, for example, or other suitable computer-readable instructions that may be directed to computational linguistics, in one or more embodiments. More specifically, in certain simulations or experiments, it has been observed that, in some instances, a CICAI applied to a particular area of computational linguistics, such as relating to, for example, interpretation (e.g., semiological, hermeneutical interpretation of a sender's capabilities), transcription, translation, transliteration, or the like may prove beneficial.

As also described below, one or more embodiments may include, for example, multilingual aspects, operations, processes Due at least in part to multilingual capabilities described herein, in an implantation, a CICAI network may perform one-to-one, one-to-many, many-to-one, and many-to-many interpretations, translations, transcriptions, or transliterations to facilitate conversations or presentations, for example, so that one could have the entire United Nations speaking with each other via headset, with each individual speaking their own language and hearing their own language in return in real-time or near real-time, for example. Continuing with the U.N. example, the General Assembly could all be listening to the same speaker. The speaker would speak the speaker's own language and everybody in the audience would hear the speech in their respective languages in real-time or near real-time (e.g., in some embodiments a minor delay of perhaps 200 ms or so may be experienced). That sort of stream of consciousness-type interaction involving interpretation, translation, transcription or transliteration is meaningful, and it's quite an advance of the state of the art.

In one or more embodiments, particular elements (e.g., interpretation, translation, transcription, or transliteration) may be implemented concurrently, such as part of a process. For example, to more fully understand various aspects of different grammars, it may be useful or advantageous to account for applicable information about a user. In one or more simulations or experiments, it has also been observed, that for transcription, for example, diacritics may be incorporated, in whole or in part, so a tone or tension of a conversation or presentation may be considered or recreated, as discussed more fully below. Also, in one or more embodiments, original transcription of an original conversation or presentation in an original language, for example, may be converted into a computer-readable form and may be stored in memory, such as to help ensure, via one or more computer processes, that no or little language conversion errors have been made.

Further, in embodiments, once a communication or presentation has been translated into a different language (e.g., via an electronic source-to-target language conversion process), it may then be explained how to actually pronounce that new language using the alphabet of that new language. Thus, as a way of illustration, if one is using Arabic (e.g., a source language), and a communication or presentation is being concerted (e.g., translated) into Mandarin (a target language), for example, a source-to-target language conversion infrastructure or system may display (e.g., via a suitable screen, display, GUI) the Mandarin text of that transcription, and not merely produce a voice transcription.

The interpretation, translation of one language to another has heretofore been the rubric of a human being, and in the UN today there generally is a highly skilled language specialist that accompanies a particular diplomat for a particular language. The expenditures of having these specialists at the UN can be great. Further, skilled translations of real-time or near-real-time communications or presentations that rely on a skilled specialist as part of the process may generally result in a less than desirable delay (e.g. six, seven, eight seconds) during such communications or presentations. Thus, in some instances, it may be greatly advantageous to eliminate or reduce such delay to more efficiently or more effectively facilitate or support a stream of consciousness dialogue within the UN or any other suitable environment, and to overcome or streamline a generally stuttering conversation of diplomacy that may be further aggravated by the incessant lack of comprehension of inherent cultural sensitivities that may often be overlooked by language specialist, such as those at the UN or other suitable environment, for example. As a result, in some instances, diplomats may not be able to accomplish what they hope to accomplish because they may be precluded from interacting well with each other.

The “interpretation” aspect or other aspects of embodiments described herein, for example, may be especially helpful in diplomatic settings or other suitable settings or the like. For example, for translations (e.g., literal translations) or the like there may be some phrasing or terminology in one language or culture that may be offensive in another language or culture. At times, offense may be taken, in some circumstances, where offense was not intended, for example. To address this or other issues, at least in part, embodiments may include interpretation aspects, for example, that may consider information about individuals involved or may consider cultural sensitivities, for example. Although “interpretation” is specifically mentioned, depending on context, “interpretation,” “translation,” “transcription,” or “transliteration” may be used interchangeably, even though, at times, just one aspect may be mentioned for efficiency purposes.

The “translation” aspect or other aspects of embodiments described herein may be connected, at least in part, to interpretation aspects or to other aspects. Again, although “interpretation” is specifically mentioned, depending on context, “interpretation,” “translation,” “transcription,” or “transliteration” may be used interchangeably, even though, at times, just one aspect may be mentioned for efficiency purposes. In an example, a communication or presentation may involve Arabic, for example, that may be spoken in the Gulf versus Arabic, for example, spoken in Morocco. They're both Arabic, but may be spoken, written, differently, at least in part. Further, different languages may have different loan words, and sometimes loan words may not pass well between languages, for example. It may sometimes occur with such loanwords, for example, such as out of the United States where there may exist a larger number of technical names or acronyms, for example, that may be disseminated or otherwise communicated around in the world, at least in part, wherein such terminology may be adopted (e.g., suddenly) by other languages. Such circumstances may make it relatively very difficult to interpret, translate due at least in part to the human interpreters, translators themselves having some sort of domain experience, subject matter expertise to have an ability to translate potentially highly technical subjects, for example, to individuals, groups who may not have similar experience, expertise.

To address these challenges, at least in part, it may be advantageous to gather content about individuals, groups, organizations, with their permission, of course. In an embodiment, content may be collected, such as from LinkedIn, for example, or from other sources. Such example profile content may provide a sense of an individual's education level, literacy level, languages spoken, and so forth. With such profile content (e.g., data, information), dialogue may be structured to an elevated academic level or a modest academic level, for example, depending at least in part on the individual. Note that may not be an attempt to train the individual, but rather a CICAI may respond to individual(s) involved in terms and abstractions that may be more readily comprehended, for example.

One or more embodiments may include one or more processing units executing computer-readable instructions to facilitate or support one or more Artificial Intelligence-type processes, operations, or algorithms to, for example, detect that speech is being uttered. Responsive, at least in part, to a detection of speech, analog electrical signals representative of incoming audio (e.g., speech) may be received from a microphone or other transducer or audio source, for example, or may be converted to digital signals or signal packets via an analog-to-digital converter (ADC), for example. In embodiments, digital signals or signal packets may be collected as one or more “.wav” files. Also, in one or more embodiments, digital content stored in a .wav file may be converted to a “.txt” text file using phenome extraction or analysis techniques or other algorithms to step through a .wav file to isolate individual quanta of utterances (e.g., words, phrases), for example. From a .txt file, for example, original speech, having been through phenome extraction or analysis operations, for example, may be translated (or transcribed, interpreted, or transliterated, for example) from speech of an original speaker into text or language of a target listener, for example. In doing so, pronunciation of vowels or consonants of target language(s) may be correctly replicated, for example. For example, in one or more embodiments, a Unicode conversion, for example, may be made from language A to language B, or a more refined pronunciation of vowels or consonants may be produced, for example.

In one or more embodiments, with respect to the “transliteration” aspect, for example, transliteration may advantageously generate phenomes to test whether a way a particular portion of speech was heard (e.g., detected, interpreted or transcribed) in a manner intended by a speaker (e.g., human individual). Again, although “transliteration” is specifically mentioned, depending on context, “interpretation,” “translation,” “transcription,” or “transliteration” may be used interchangeably, even though, at times, just one aspect may be mentioned for efficiency purposes. In one or more embodiments, an AI-agent may monitor text, streaming text, streaming analog, which may comprise content being captured by a microphone or other sensors or that may be delivered to CICAI. Also, as mentioned, unique profiles may be captured or generated for individuals, in one or more embodiments. For example, content regarding which movies an individual may like, where an individual may shop, where an individual may live, and so forth. With such content, for example, text that may have been generated, such as from captured audio, for example, may be altered to better correspond with a target listener's culture, community, education level, socio-economic status, likes, dislikes. For example, an individual “T” may be from Texas and an individual “N” may be from New York. To help these two individuals perhaps create a better connection when they converse or otherwise communicate with each other, such as over the telephone, for example, a “y'all” expression by individual T may be transliterated, for example, to “you all” for individual N in New York. Similarly, in one or more embodiments, a “you all” expressed by individual N may be transliterated into “y'all” for individual T, for example. Of course, this is merely an example. Other, perhaps more serious or more important, communications, conversations, or presentations, for example, may be adjusted in this manner, such as through example transliteration approaches, in one or more embodiments, to help individuals better communicate one with another or within groups, communities, organization, for example. Also, although this particular example is English-to-English, similar transliteration operations may be applied to communications where communication between users of different languages may be involved, in one or more embodiments.

In one or more embodiments, responsive at least in part to uttered speech being detected, such as may be received at a microphone (e.g., incoming digital audio stream received via telecommunications network from a cell phone), processing threads may be initiated to facilitate operations pertaining to interpretation, transcription, translation, or transliteration, for example. In one or more embodiments, processes pertaining to one or more of interpretation, transcription, translation, or transliteration aspects may depend at least in part on values generated by other processes pertaining to one or more others of interpretation, transcription, translation, or transliteration, for example, so some delay (e.g., not perceivable to human individuals) may occur as one process waits for values to be available from another process, for example. In one or more embodiments, however, processes pertaining to interpretation, transcription, translation, or transliteration aspects may be performed concurrently.

As alluded to previously, cultural considerations may affect one or more of the interpretations, transcription, translation, or transliteration aspects of CICAI, in one or more embodiments. For example, consider a situation where culturally it may be advantageous or desirable to receive speech with a particular tone, or seemingly from a particular gender, or seemingly from a particular individual For example, in a given culture it may be desirable to receive speech in a manner that may be calming, soft, gentle In one or more embodiments, as part of transcription operations, for example, diacritics may be added to individual letters as they are transferred from a source language to a target language, for example. Therefore, in one or more embodiments, as a word is uttered, the letters may be created and diacritics may be added, for example. Such diacritics may reflect tone, timber of uttered speech, for example. In this manner, emotional content of a moment of speech may be captured via the diacritics. One or more example embodiments comprising diacritics are discussed more fully, below.

One or more embodiments may also find advantageous utility in teleconference settings, for example. In such a setting, individual participants may speak a preferred language (or other specified language) or individual participants may hear their preferred or other specified language regardless of the languages being spoken by other individuals participating in the teleconference, in one or more embodiments. Often, in a teleconference setting, participants may speak over one another either intentionally or unintentionally. If more than one participant is speaking, it may be difficult for participants to discern what is being said. Also, of course, in such settings it may be generally assumed that a particular language will be spoken. One or more embodiments described herein, including the use of AI-agents, for example, may address these types of challenges. In one or more embodiments, the use of AI-agents may comprise one or more processing units executing computer-readable instructions to facilitate or support one or more Artificial Intelligence-type processes, operations, or algorithms, for example.

For example, although a participant of a teleconference may have difficulty understanding what is being said when multiple participants are speaking at the same time, one or more embodiments may, via AI-based approaches such as example approaches described herein, have little difficulty tracking who said what and when it was said. In one or more embodiments, such as in connection with one or more interpretation, translation, transcription, or transliteration aspects, a transcript may be generated showing what was said by whom and at what time, for example. In one or more embodiments, multiple transcripts may be generated (e.g., a first transcript for a first participant, a second transcript for a second participant). Further, in one or more embodiments, generated transcripts may show what was said in originally spoken languages. Additionally, in one or more other embodiments, transcripts may be generated to show what was said in a target language. Further, for example, separate transcripts may be generated for individual participants, in one or more languages (e.g., source or target languages), in one or more embodiments. In one or more embodiments, interpretation, transcription, translation, or transliteration operations may be involved in such processes, for example.

Further, for teleconference-type circumstances, one or more embodiments described herein, including the use of AI-agents, for example, may affect how a teleconference may be presented at various computing devices of various participants. For example, in one or more embodiments, individual profile information, including, for example, historical content related to previous communications, previous teleconferences, may inform AI-agents involved in shaping a teleconference presentation (as alluded to previously, AI-agents may comprise, for example, one or more processing units executing computer-readable instructions to facilitate or support one or more Artificial Intelligence-type processes, operations, or algorithms, for example). As a result, for example, a teleconference application (e.g., computer-readable instructions executable by one or more processors of one or more computing devices) may focus more (e.g., by altering size of display window, audibility/microphone volume) on one or more particular individuals that may be more likely to be more important to a teleconference session. Also, a teleconference application, including AI-agents such as one or more embodiments described herein, for example, may monitor (e.g., continuously or near continuously) or may adjust presentation of a teleconference. For example, a teleconference application may mute microphones, may adjust audio levels, may adjust configuration of display windows (e.g., altering the number of display windows used, adjusting the size of one or more display windows, adjusting which participants are featured in different display windows), in one or more embodiments. Additionally, in one or more example embodiments, at least in part via an AI-agent bolstered teleconference application, participants may replay portions of a teleconference stream. For example, in one or more embodiments, a participant may back up (e.g., rewind) stream for a few seconds, for example, to focus on what another participant said. A participant may indicate which another participant should be featured during replay, for example. In this manner, if a participant didn't hear what a particular individual may have said (e.g., multiple participants speaking at the same time), a participant may rewind a teleconference stream an indicated number of second, for example, or may focus on that particular individual. Also, in one or more embodiments, video or audio storage or playback may be provided, such as by one or more processing units configured to facilitate or support video or audio content storage or playback. Of course, such example teleconference features may incorporate any or all of CICAI system interpretation, transcription, translation, or transliteration aspects, in one or more embodiments.

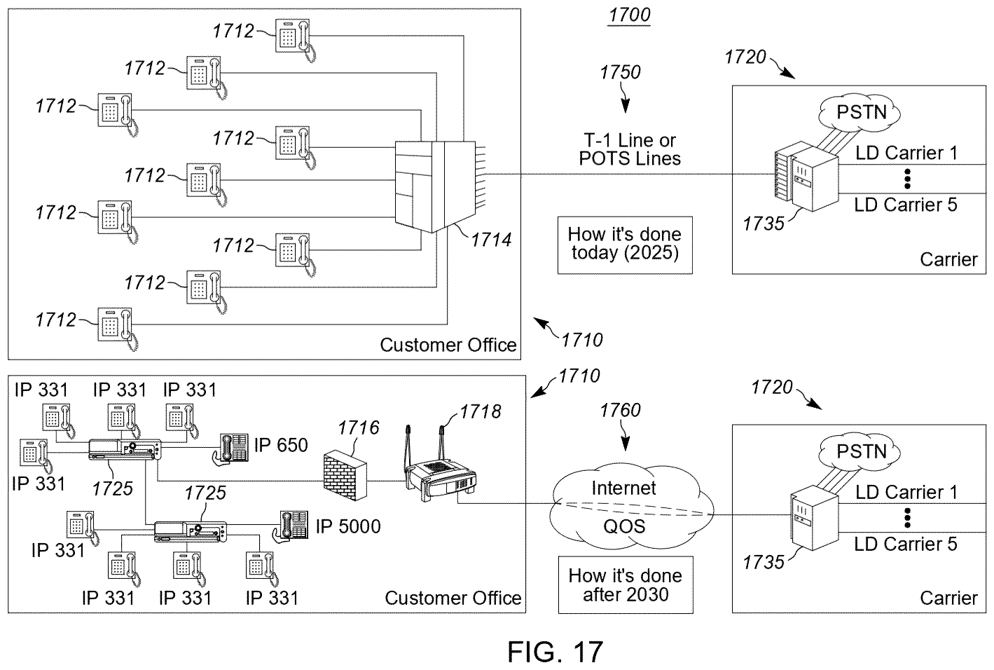

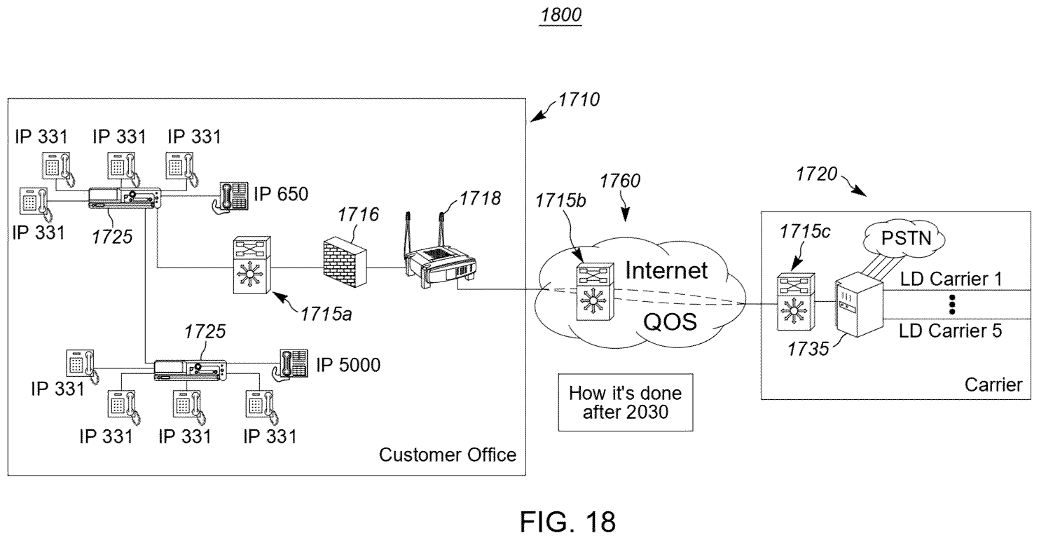

Further, in one or more embodiments, ubiquity of service in a telecommunication network may be another aspect that may be quite advantageous or that may provide a significant improvement to the state of the art. In one or more example embodiments, such as may be discussed below, CICAI functionality, including the interpretation, translation, transcription, or transliteration aspects, may be implemented, in whole or in part, in telecommunications switches (e.g., class-4 Telco switches). In one or more embodiments, an already-existing infrastructure may be utilized, in whole or in part, to provide real-time or near real-time services to allow people from around the globe to much more readily or effectively, for example, communicate with other people from around the globe. One or more such embodiments are discussed more fully below, for example in connection with FIGS. 17-18.

“Artificial Intelligence” (AI) or the like refers to a software or hardware system configured to interact with its environment at least in part by processing input or generating output, attributing meaning, making decisions or eliciting actions to resolve a problem or to achieve a desired state shift. “Agent,” “AI-agent,” or the like refers to an AI entity capable of acting autonomously or independently or configured to act autonomously or independently.

In one or more embodiments, CICAI may comprise, for example, a communications network, such as a multi-agent network, as one particular example, of one or more processing units executing computer-readable instructions to facilitate or support one or more Artificial Intelligence-type processes, operations, or algorithms. In one or more embodiments, CICAI may also comprise one or more neural-network algorithms or other approaches using, for example, Systolic Arrays or Wavefront-Arrays of parallel processing units, for example, using synchronous or asynchronous nodal communication, in some circumstances, for example. In one or more embodiments, CICAI may be implemented, in whole or in part, in a mesh-type network configuration, for example, in a TRILL or Shortest Path Bridging network topology, for example, which may be one or many of the following Layer 2 Link-state switching architectures such as, but not limited to, cell-switched, frame-switched or packet-switched/routed network architecture comprising one, or a plurality of, computers, networking equipment, Telco Equipment comprising one or more multi-core microprocessors, FPGAs, SOCs and ASICs, for example. In one or more embodiments, an advantage of a parallel-processing-type multi-agent-type network implemented, in whole or in part, in a Layer 2 network mesh-network topology, such as TRILL, may be plug-n-play nature. For example, a network administrator may be relieved of heavy configuration, unlike in a Layer 3 network, in some circumstances. In one or more embodiments, TRILL may achieve this with a Dynamic Resource Allocation Protocol (DRAP), for example, where every node derives its own nickname and a protocol may help ensure no duplicity. In one or more embodiments, the configuration requirement of TRILL is minimal, for example.

One or more embodiments may comprise a plug-n-play CICAI TRILL-type network of AI-agents executing computer instructions via a plurality of processing units, such as, for example, interconnected via a (e.g., OSI Layer 2) TRILL network switch, such as configured as asynchronous wavefront-arrays to provide Runtime Adapter for one or more AI-agents acting on behalf of sender or receiver to perform, for example, real-time in-stream-type interpretation, translation, transcription, or transliteration operations (e.g., sub-titles in language of receivers or voice-over synthesis in language of receivers), such as to handle a plurality of language requests concurrently from many geographies, for example. In one or more embodiments, due at least in part to an asynchronous nature of time delays over distance, for example, a wavefront-array may be an effective means of implementing, in whole or in part, CICAI globally. In one or more embodiments, a wavefront-array may be replaced by a systolic-array of AI-agents executing instructions on processing units due at least in part to Metropolitan Area Network (MAN) networks provisioned with higher cell, frame or packet switching speeds, for example, such as over relatively trivial distances and trivial time delays, for example.

“Real-time,” or the like in this context refers to performing processing, such as interpretation, translation, transcription, or transliteration, in a timely enough fashion so that a human individual would not perceive latency or delay. “Near real-time” or the like in this context refers to performing processing, such as interpretation, translation, transcription, or transliteration, with only a small amount of delay capable of being perceived by a human individual. More generally, “real-time” or “near real-time” refer to the approximate actual time during which a process takes place or an event or activity occurs. In one or more embodiments, “near real-time” may refer to a delay perceivable by a human individual of less than 250 ms (one quarter of a second).

In one or more embodiments, CICAI may include at least one, or a plurality of, TRILL networks, a non-limiting example, comprising one or more networked computing resources such as computer memory, processor farms, optical interconnect buses including but not limited to, Infiniband, storage in the form of solid-state storage devices (e.g., NVMe), mechanical computer storage devices and computerized subsystems necessary to execute computer instructions representing many varieties of AI-agents, to mention but a few examples. Such computer instructions that may codify autonomous-type AI-agents, for example, with Artificial Intelligence Algorithms (such as described herein for one or more embodiments) as well as public-domain-type neural network algorithms, commonly-used supervised or unsupervised machine-learning algorithms, or computerized-vision or artifact detection algorithms may be included in one or more embodiments, for example.

In one or more embodiments, CICAI may enable, at least in part, an individual to dial any phone number in the world, such as may be available via commonly implemented telephony infrastructure, for example. In one or more embodiments, a network, for example, may provide interpretation, translation, transcription, or transliteration services, for example, to remove non-tariff-type language barriers to commerce, personal communication, group communication, or text communication across geographies or ethnicities, for example.

In one or more embodiments, CICAI may provide language interpretation, translation, transcription, or transliteration services as a foundational service of the network itself, for example. In one or more embodiments, a Transport Layer of a CICAI Network, for example, may utilize one or more of the following examples (non-limiting) protocols operating jointly or severally. Example protocols may include, but are not limited to:
(a) ARP-Address Resolution Protocol; (b) ATM virtual-circuit-based upper-layer control-plane or data-plane transport protocols (e.g., RSVP, VPC (virtual path connections) consisting of one or a plurality of VCCs [(virtual channel connections) bundled together]; (c) BGP-Border Gateway Protocol; (d) Bluetooth-SDP, TCS, AVCTP, OBEX, Link Management Protocol, BNEP, and RFCOMM; (e) DRAP Dynamic Resource Allocation Protocol; (f) DNS-Domain Name System; (g) DHCP-Dynamic Host Configuration Protocol; (h) FTP-File Transfer Protocol (for interpretation and translation of documents); (i) HSRP-Hierarchical Satellite Routing Protocol; (j) HTTP-Hypertext transfer Protocol (for interpretation and translation of web-page content) communication); (k) ICMP-Internet Control Message Protocol; (l) ISL cross-links; (m) LoRaWan-Low Power Wide Area (LPWA) IP-to-RF and RF-to-IP multicast protocols for Link and Application layers; (n) OSPF-Open Shortest Path First; (o) PDH-Plesiochronous Digital Hierarchy; (p) RIP-Routing Information Protocol; (q) SGRP-Satellite grouping and routing protocol; (r) SMTP-Simple Mail Transport Protocol (for interpretation and translation of emails communication); (s) SONET/SDH-‘Synchronous Optical Network’ (‘Synchronous-Only’, OC-2 thru OC-192 data rates)/‘Synchronous Digital Hierarchy’ (both synchronous mode and asynchronous mode; Synchronous Transmission Module level-1 (STM-1) is the fundamental unit of SDH.); (t) STP-Satellite Transport Protocol; (u) TCP/IP-‘Transmission Control Protocol’/‘Internet Protocol’; designed and developed by US Department of Defense (DoD) in the 1960s; (v) Telnet-Telephone Network (often referred to as “POTS”); (w) UDP-User Datagram Protocol; (x) WiFi/WiMax/LTE/4g/5g/6g.

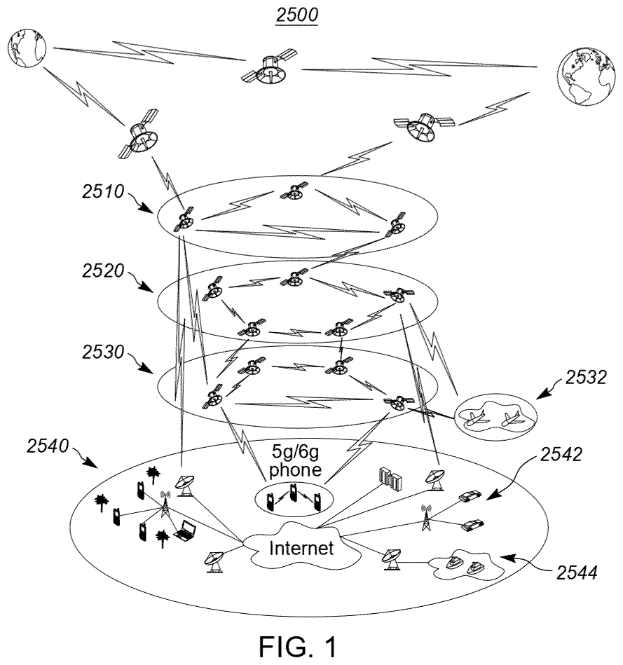

The foregoing may, in-part or whole, describe one or more embodiments comprising artificial intelligence-based Network Services implemented, in whole or in part, within Space-Air-Ground Integrated Networks (SAGINs) for use by any or all devices, terrestrial or otherwise, connected thereto; including, for example, deep-space relay satellites for communication to future colonies, for example. In one or more embodiments, with CICAI implemented, in whole or in part, in a systolic-array or a wavefront-array to provision autonomous-type AI-agents, for example, with Runtime Adapters, CICAI infrastructure, due at least in part to its smaller footprint in at least some circumstances or its modest power or cooling requirements, for example, may be lifted into orbit (e.g., cloud-server inside LEO/MEO/GEO/DSR satellites) to provide telecom-type services to SAGINs layers, for example, within a LEO, MEO or GEO configuration, for example. See, for example, FIG. 1. For example, such a configuration among LEO Cubesats may accelerate removal of non-tariff inefficiencies globally because “Computational Interpretation of Communication using Artificial Intelligence Algorithms” may be performed in handheld 4g & 5g cell-phones, for example, without a need for terrestrial cell-towers requiring optical, copper cables to connect them to large regional land masses, for example.

In one or more embodiments, a CICAI Network implemented, in whole or in part, within SAGINs may comprise, but is not limit to, example permutations of network architectures that may be used in state-of-the-art SAGINs, for example:
(a) Optical Channel Layer of OTN Model (Layer 1); (b) Hybrid RF/Optical Link Layer Model (10+Gbps laser-uplink to MEO/GEO Satellite with high-rate Ka-band or Ku-band downlinks; (c) Data Link and Network Layers of ATM Model; (d) Data Link and Network Layers of OSI Model (Open Systems Interconnection Model); (e) Network Interface Layer of TCP/IP model and; (f) Link and Application Layers of Low Power Wide Area (LPWA Models) of networking; (g) OSBN/SBN-Optical-switched Broadband/Satellite Broadband Network which may possess inter-satellite multi-Gbps optical crosslinks with up to 6,000 km range each; (h) TRILL Data Link Layer of OSI Model (Open Systems Interconnection Model).

An example infrastructure, such as depicted in FIG. 1, for example, may also be considered in connection with FIG. 20, discussed below. In one or more embodiments, example infrastructures of FIG. 1 and FIG. 20 may share at least some characteristics. Of course, subject matter is not limited in scope in these respects.

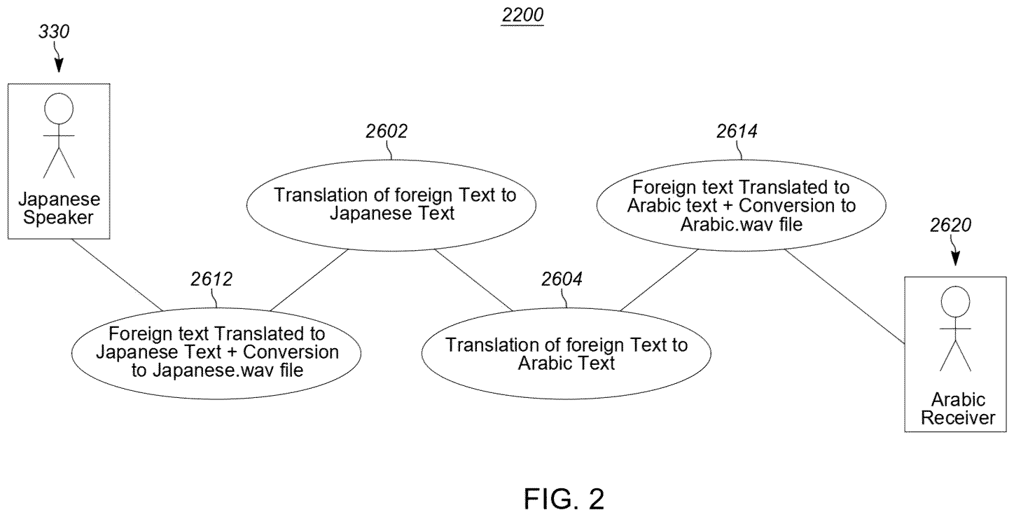

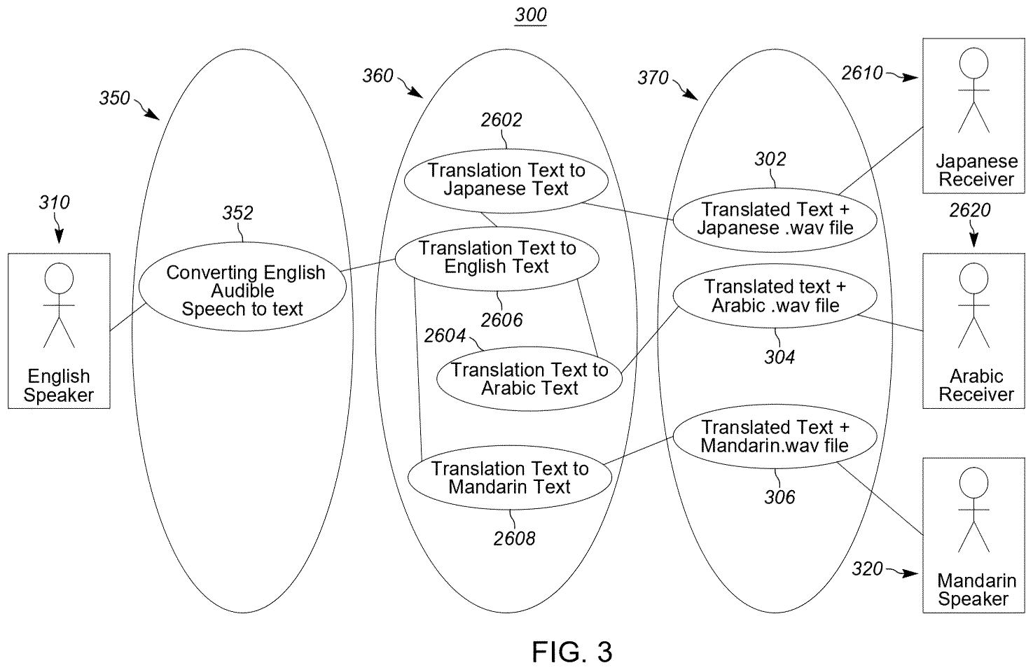

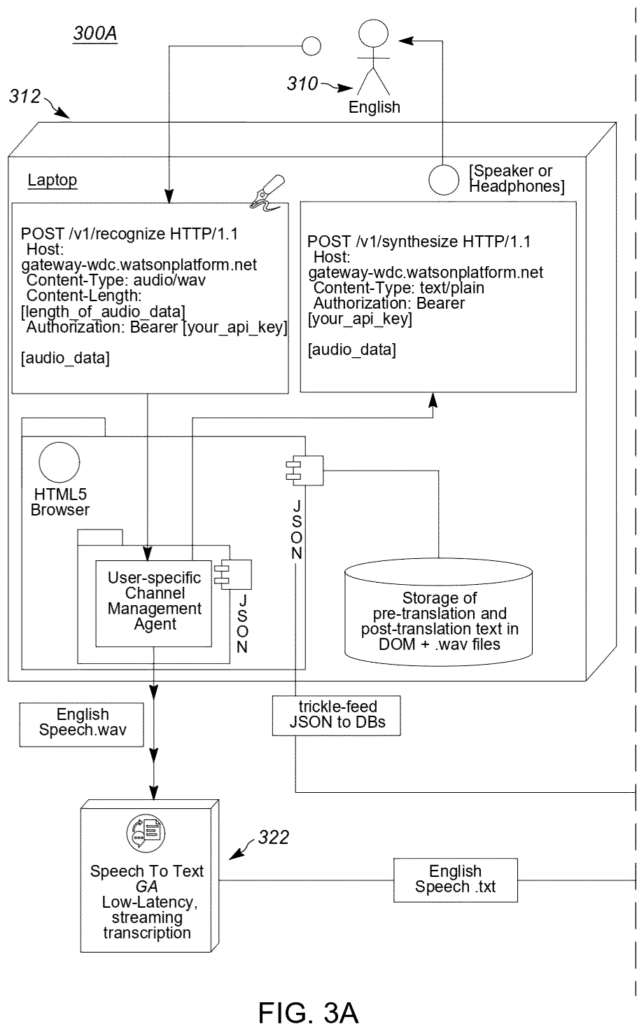

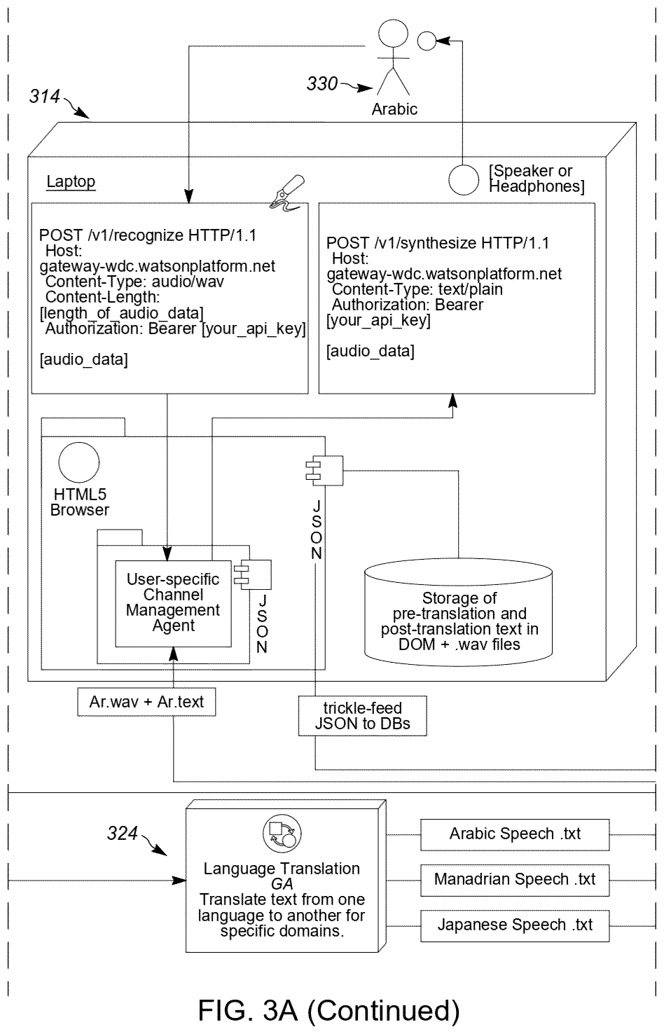

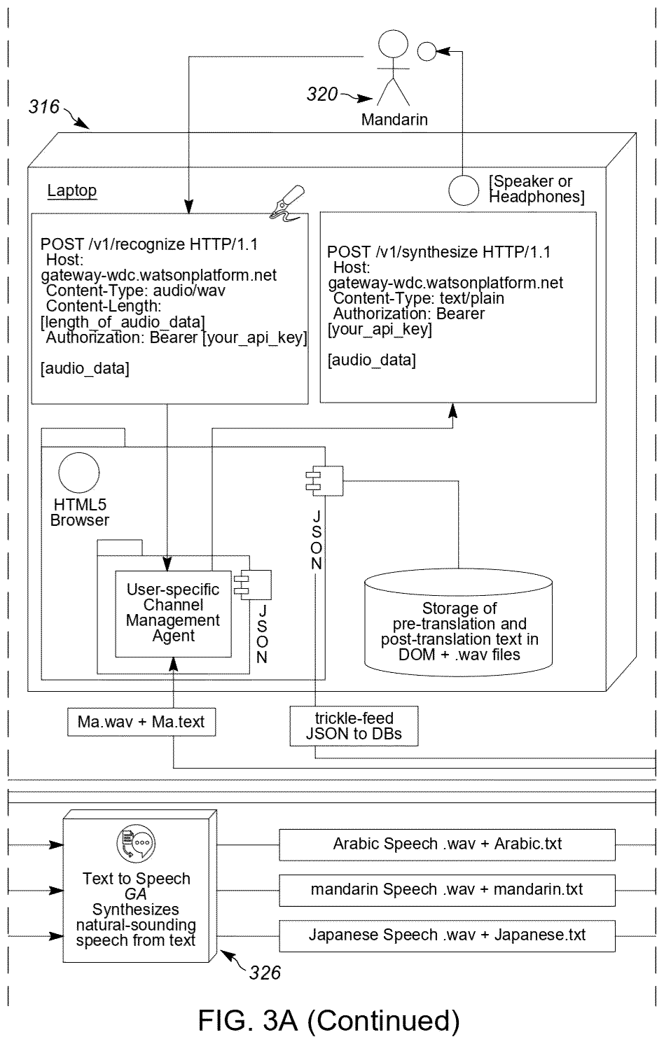

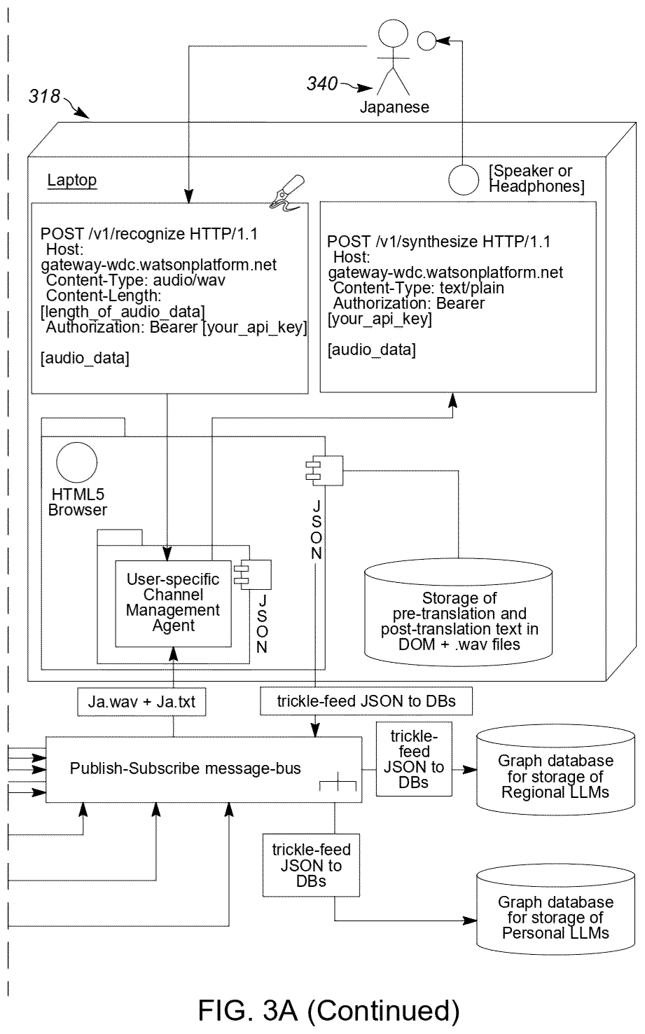

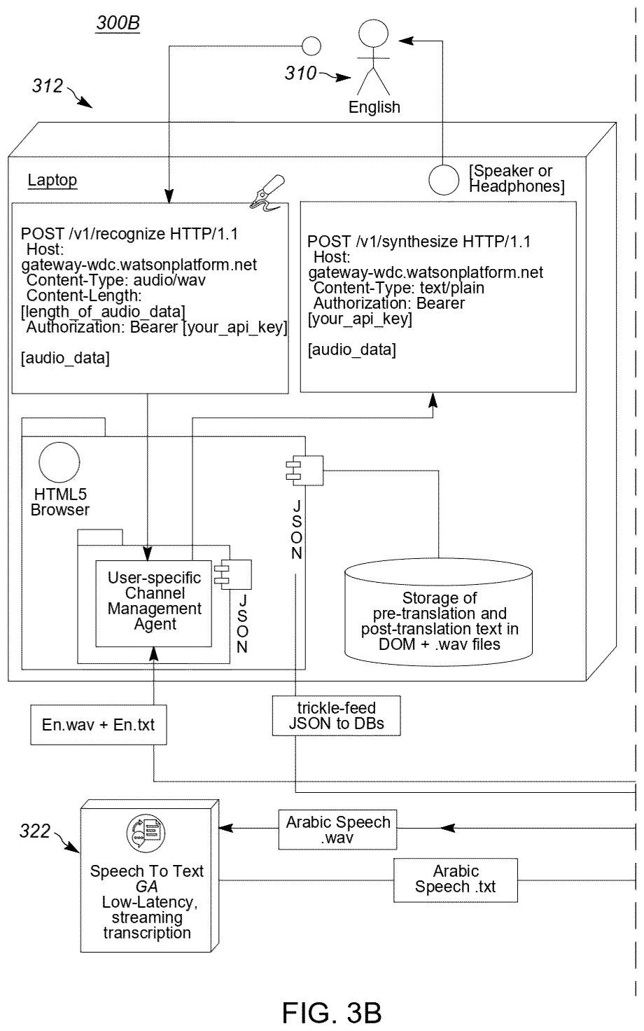

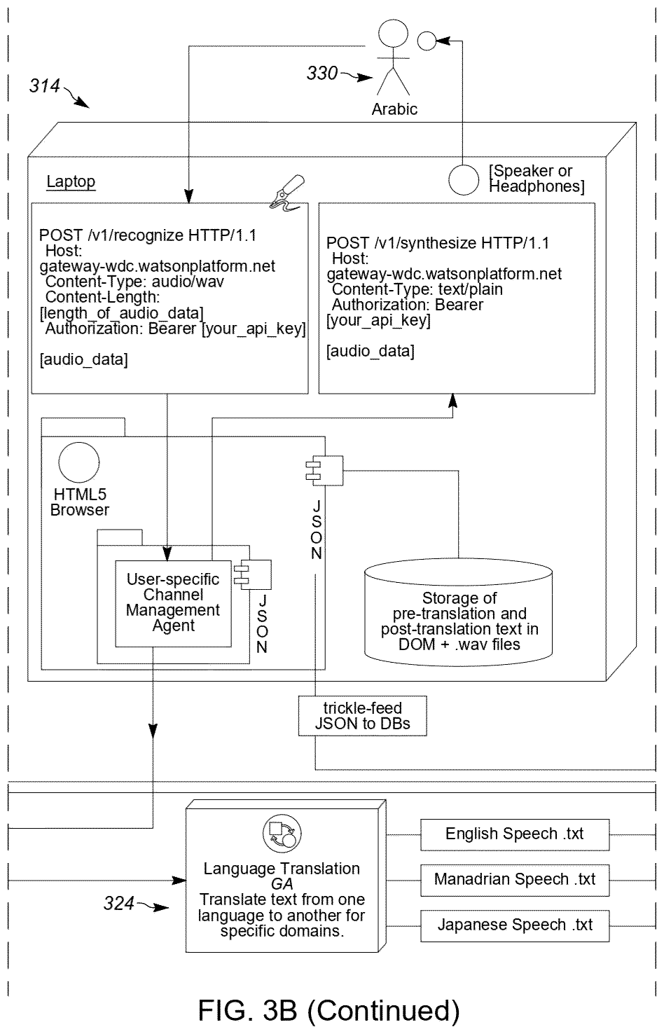

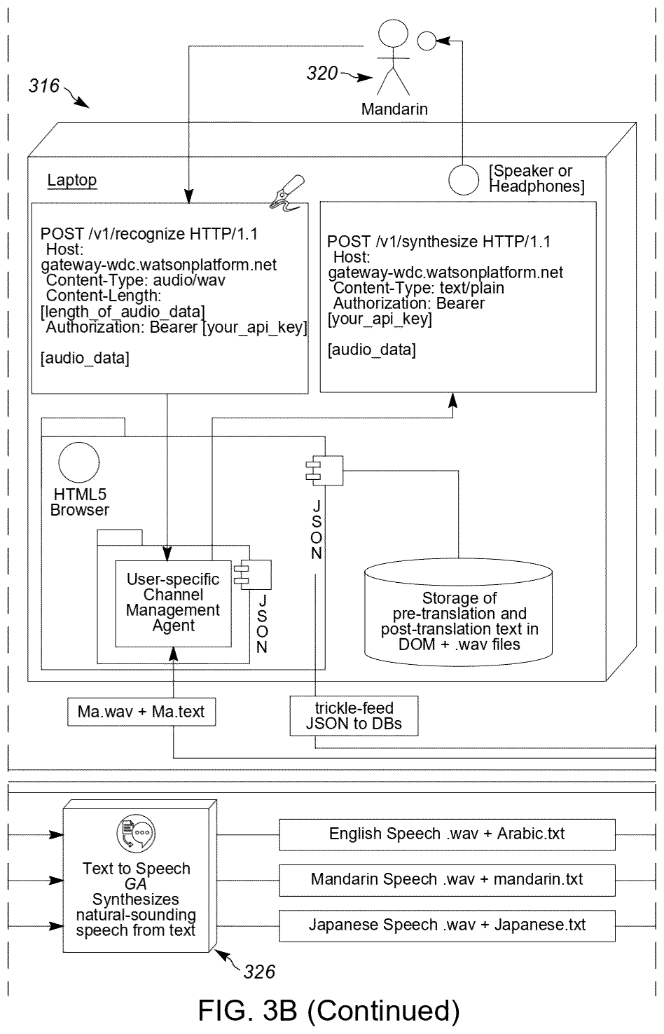

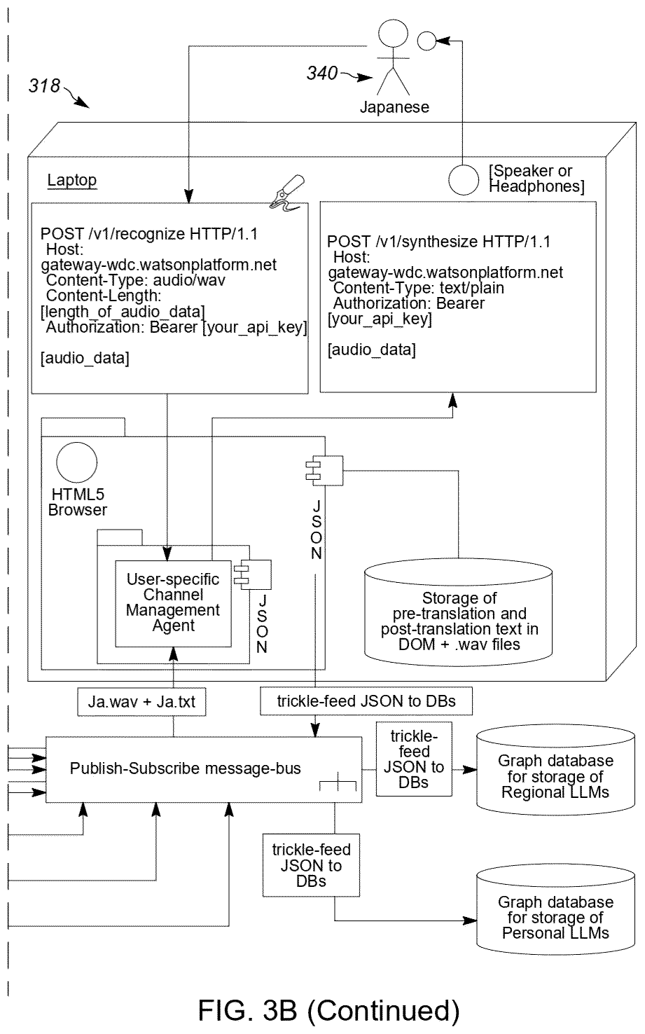

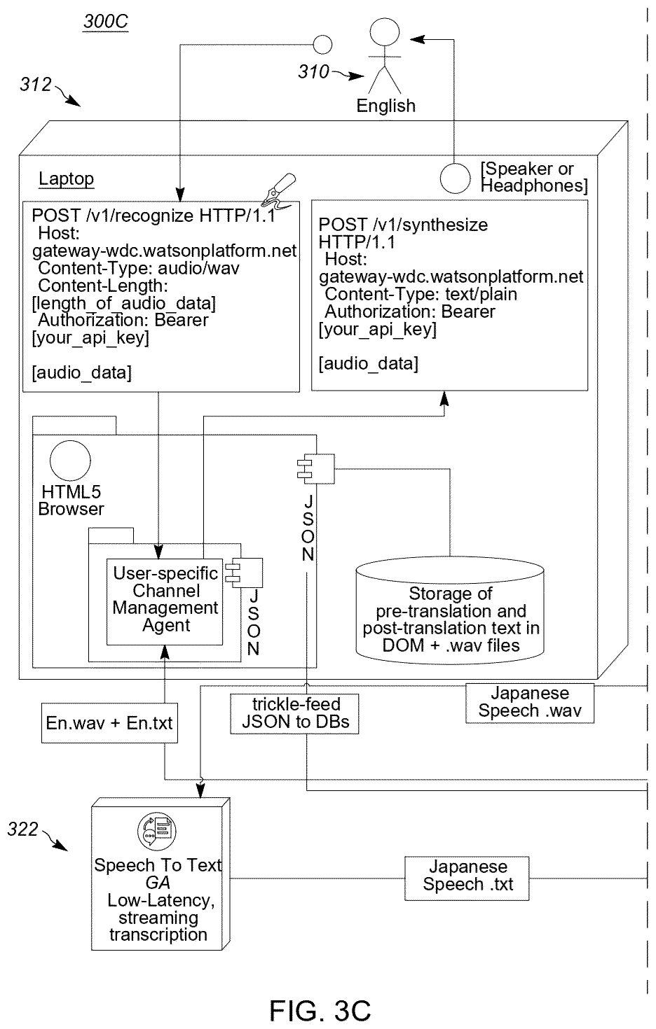

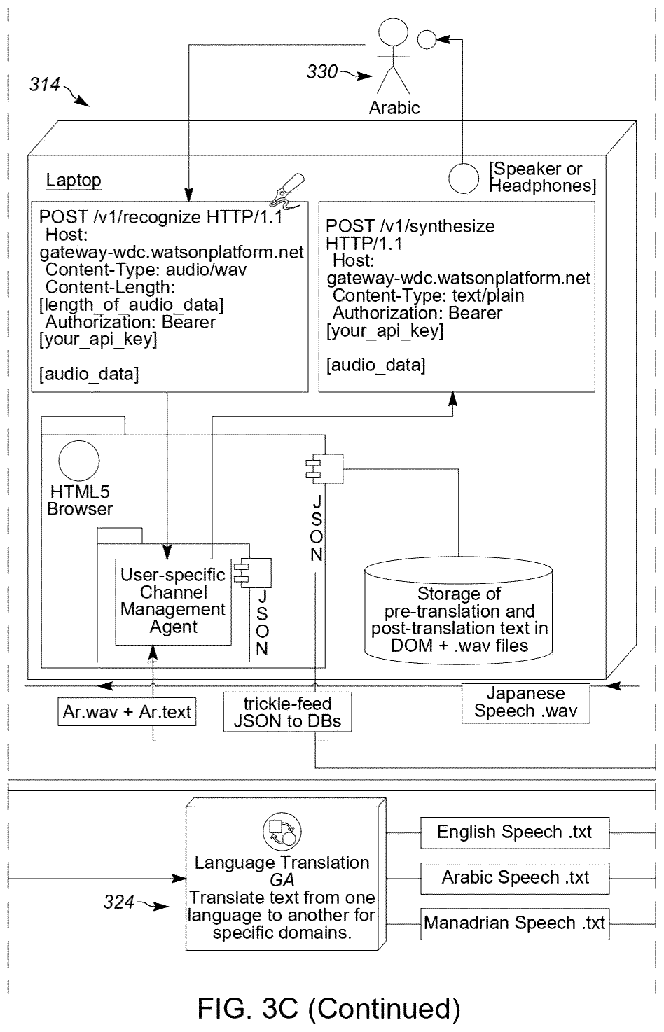

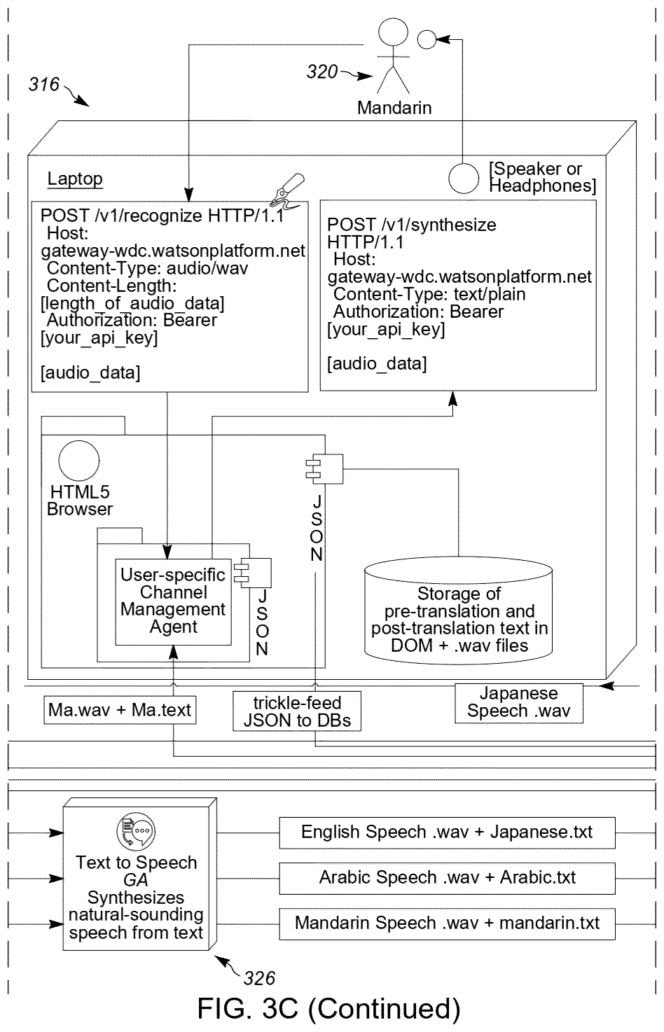

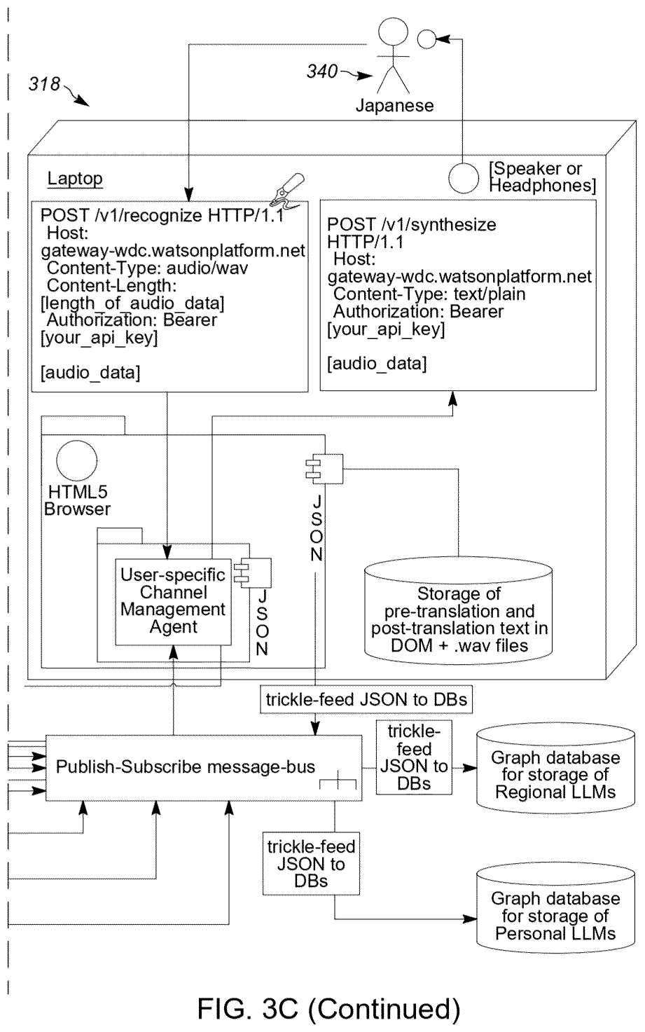

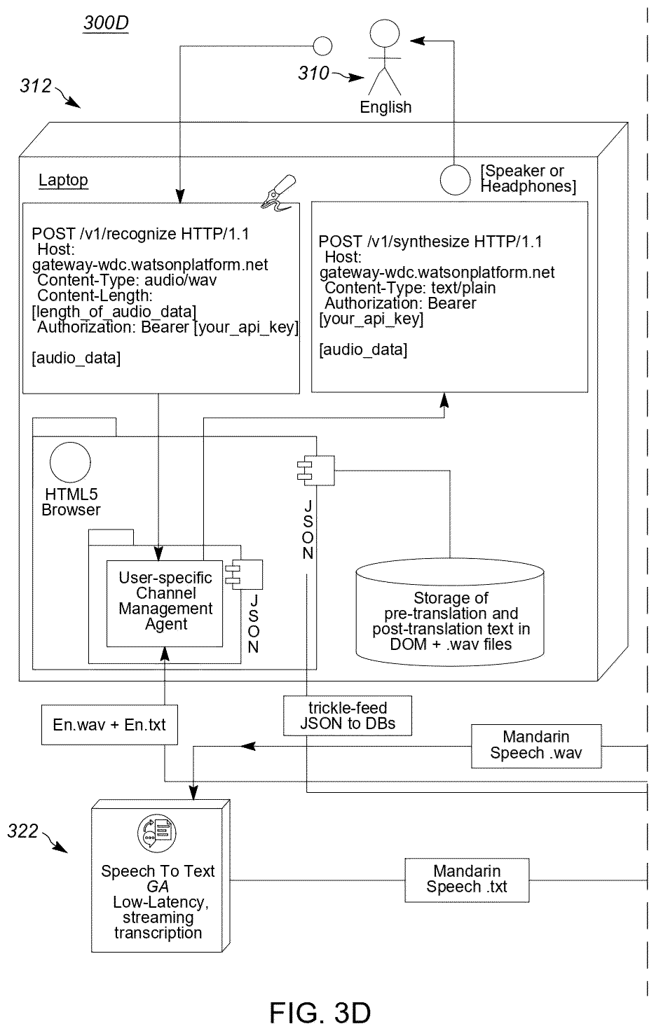

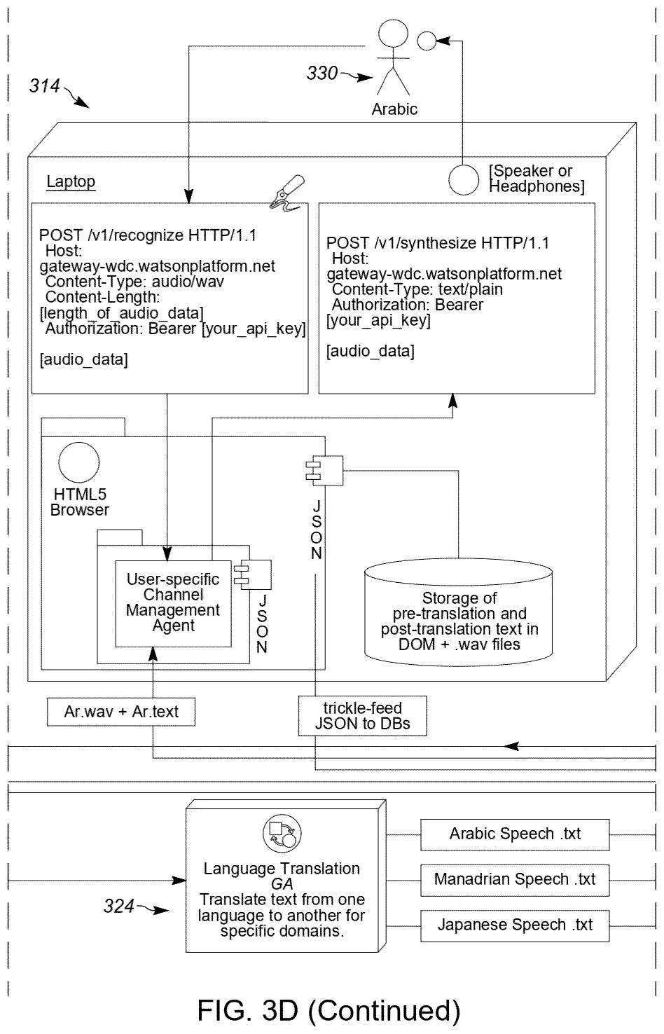

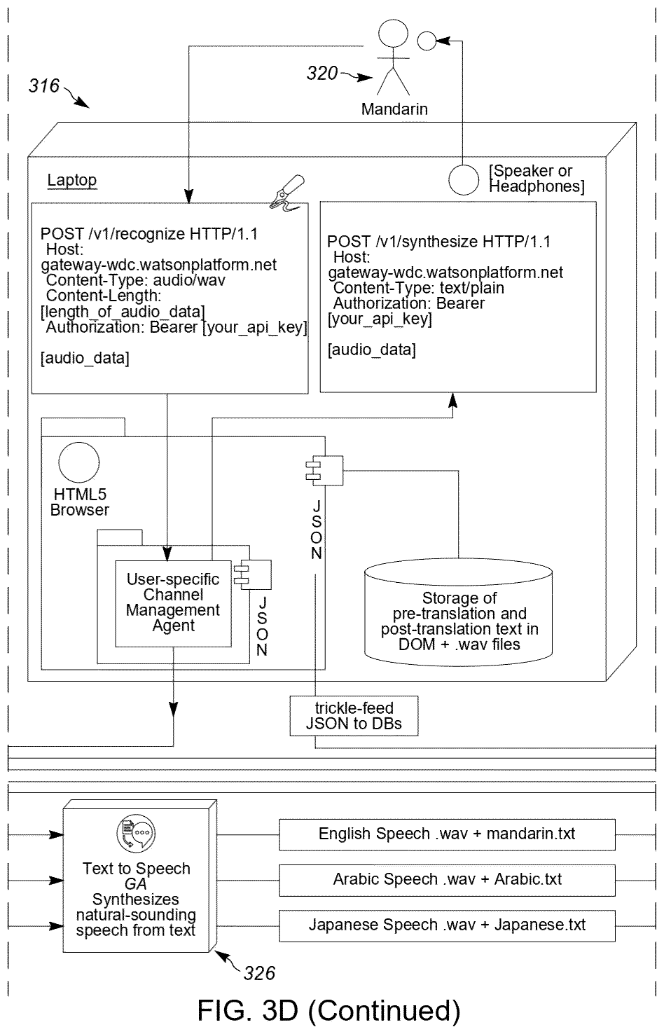

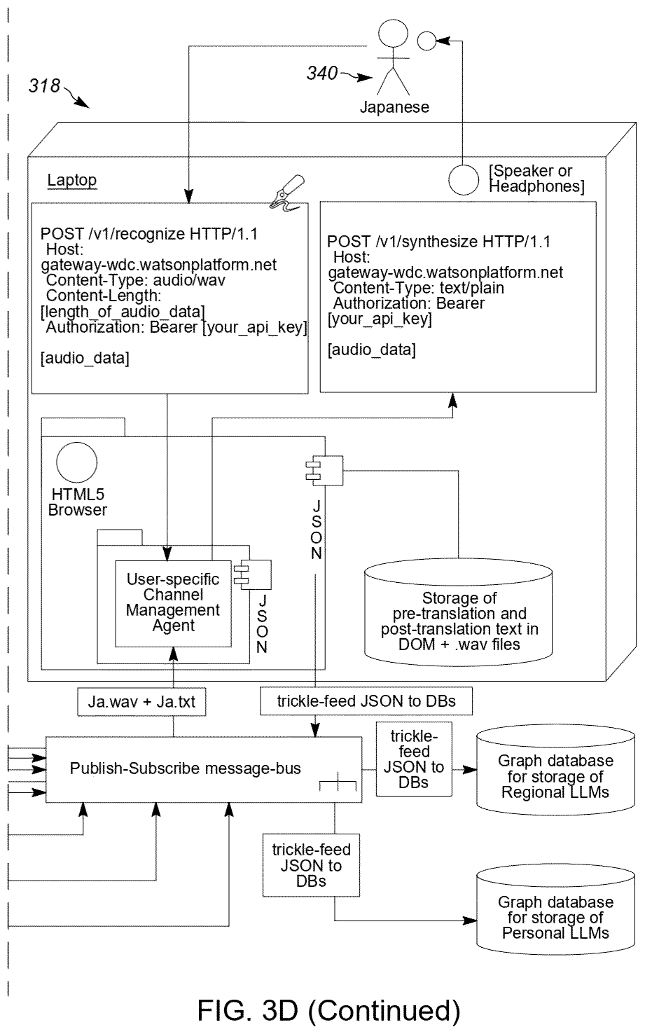

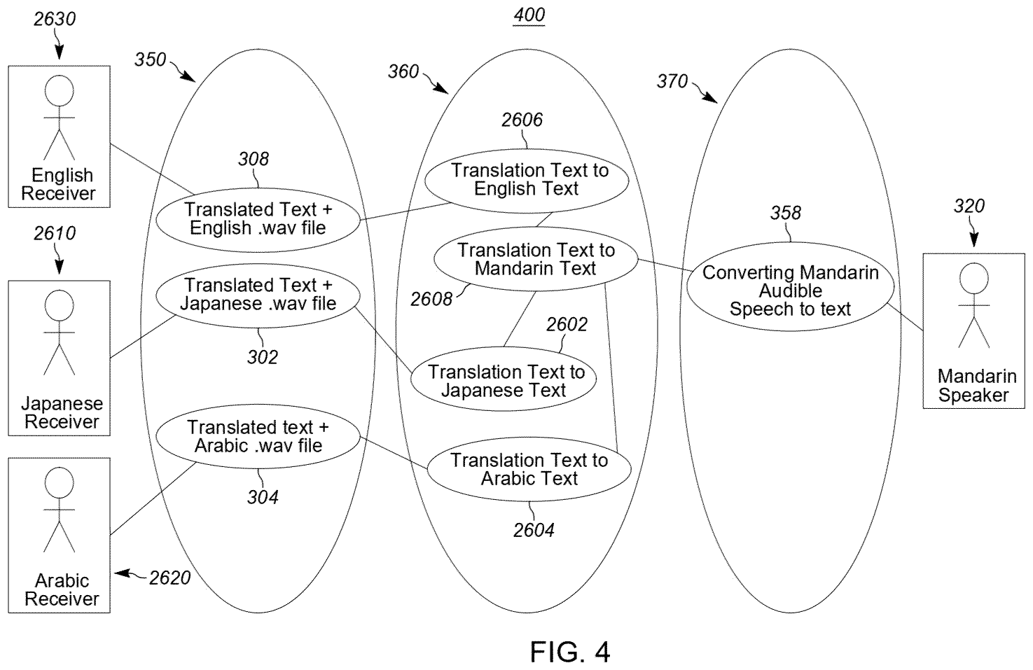

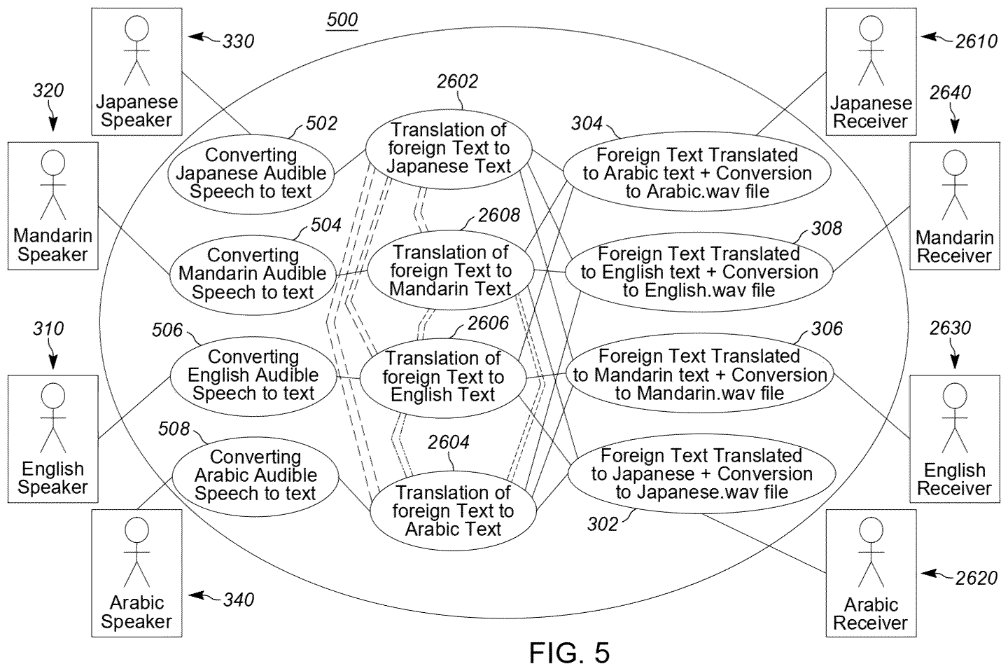

In one or more embodiments, a CICAI network may operate in any of one or more permutations of peer-to-peer, one-to-many, many-to-one or many-to-many configurations, for example. See FIGS. 2-5. FIGS. 3A-3D, for example, depicting an example network operating in a one-to-many configuration wherein individuals speaking Arabic, English, Japanese, or Mandarin, for example, may be able to communicate one with another in their respective languages with little or no perceivable delay, and while maintaining the appropriate context, sentiment, intention, emotion.

One or more embodiments may describe one, or a plurality of, unique networked computing model(s) in the art of ‘Computational Linguistics’, or, for example, “Computational Interpretive Communication using Artificial Intelligence Algorithms” (CICAI). In one or more embodiments, CICAI may comprise a parallel-computing-type architecture that may be implemented, in whole or in part, in hardware and software, such as, for example:
(a) Single instruction stream, single data stream (SISD) in a uni-core, uni-cell or uni-node processing unit. Software microkernel-based agents or heterogeneous multi-agent-type architectures may be utilized advantageously in SISD architecture, for example; (b) Multiple instruction, single data (MISD) may comprise a parallel computing-type architecture wherein multi-core, multi-cell or multi-node unit may perform different operations on same data. Pipeline architectures for voice interpretation, text translation, or text signal processing may comprise an example. In another example, MISD architectures may be used, at least in part, in re-usable space-vehicles (Space Shuttle flight control computers), for example, as well as drone or hypersonic missile systems receiving telemetry from a plurality of on-board, terrestrial or space-based telemetry-senders, for example. In one or more embodiments, AI-agents, multi-agent systems or heterogenous-type agents using, at least in part, IPC for intra-process or inter-process communication may be utilized advantageously, at least in part, in a CICAI-based implementation, for example; (c) Multiple instruction, multiple data (MIMD) may comprise a type of parallel-type computing architecture wherein a plurality of processing units may function asynchronously or independently, for example. In one or more embodiments, different processing units may execute different operations on multiple data points simultaneously, for example. In one or more embodiments, MIMD architectures may be used, in whole or in part, in computer-aided design/computer-aided manufacturing, simulation, modeling, or as higher-speed Telco communication switches, for example. In one or more embodiments, MIMD parallel-type computing architectures may comprise, for example, shared memory or distributed memory categories, depending, at least in part, on how MIMD processing units access memory. In one or more embodiments, shared memory-type machines may be of a bus-based, extended, or hierarchical type, for example. In one or more embodiments, with respect to wavefront-arrays, MIMD architectures may be more beneficial for speed or durability, for example. In one or more embodiments, distributed memory MIMD parallel-type computing architecture may comprise hypercube or mesh interconnection schemes, for example, thereby rendering them perhaps ideal, at least in part, for use in mesh-networks (systolic-arrays or wavefront-arrays), for example. In one or more embodiments, AI-agents, multi-agent systems, microkernel-based agents or heterogenous agents using internal hardware or external software-based IPC for intra-process, or inter-process, communication may be advantageously utilized in a CICAI implementation, for example; (d) Single instruction, multiple data (SIMD) is a type of parallel computing architecture where a one or more computers, with multiple processing elements, perform identical operations on multiple data points simultaneously. SIMD may be favored where systolic arrays are used for parallelism. AI-agents, multi-agent systems, microkernel-based agents and heterogenous agents using internal hardware or external software-based IPC for intra-process, and inter-process, communication are ideal for CICAI implementation. Of course, embodiments are not limited in scope to the particular details described above.

In one or more embodiments, CICAI may be implemented, in whole or in part, within a system architecture affording mixed permutations of MISD, or SISD, or MIMD or SIMD-conforming architecture, for example, depending at least in part on a particular use case or application. In one or more embodiments, CICAI may comprise a MIMD-type approach, for example. However, similar functionality may be derived through other methods, such as, for example, any combination of MISD, SISD, SIMD or MIMD, for example. In one or more embodiments wherein CICAI may lack hardware capable of MISD, SISD, SIMD, or MIMD, for example, CICAI may be implemented, in whole or in part, as a SWAR (SIMD within a register)-type architecture involving general-purpose-type processors comprising one or more processing units including one or more cores, cells or nodes which may lack SIMD micro-instructions in hardware to perform SIMD operations, for example. In one or more embodiments, an example difference between SIMD and SWAR is that SIMD-compliant processing units may comprise some special functions micro-code-triggered functionality accessible, for example, via lower-level programming languages (e.g., assembler, c/c++) to perform parallel-computing-type functions within computer processing units themselves, for example. In contrast, a SWAR architecture may be implemented, in whole or in part, within common off-the-shelf Harvard or Princeton Models of Computing, for example, where computer processors of at least a single processing core execute computer instructions within a heterogeneous computing environment, for example. SWAR may be challenging in some circumstances to implement due at least in part to complexity of performing parallel-type computing operations across data stored in independent sub-words, for example, in multiple registers concurrently or fields of a register within a processing unit, for example. A SWAR-capable architecture may comprise a set of instructions that may be sufficient to allow data stored in sub-words or fields to be treated independently even though the architecture may not include instructions explicitly intended for such a purpose. In one or more embodiments, SWAR may be utilized advantageously in a processing unit for multi-agent AI-agent or heterogenous agent-type architectures, for example, due at least in part to an asynchronous nature of multiple processing units performing similar/same programmable instructions but at different instruction execution clock-speeds, for example.

In one or more embodiments, CICAI may comprise parallel-processing multi-agent-type architecture affording mixed permutations of Runtime Adapters implemented, in whole or in part, in processing unit instructions within parameters of MISD, or SISD, or MIMD or SIMD-conforming architecture, whatever may be suitable for a particular use case or application. In one or more embodiments, MISD, SISD, MIMD or SIMD-type architectures may not allow for Runtime Adapters to be implemented on processing cores, cells or nodes of parallel computing-type processors, for example. Therefore, implementing, in whole or in part, a hierarchical AI-agent-type architecture in a monolithic operating system, such as CentOS Linux, for example, or embedded operating system platforms, for example, may be advantageous in some circumstances.

In one or more embodiments, CICAI hardware may implement, in whole or in part, a “Secure Boot” mechanism to counter boot-time malware threats, for example, at least in part by cryptographically verifying firmware, kernels, or drivers. In one or more embodiments, each executable boot binary, including firmware and software, for example may check against a blacklist database or multiple trusted databases, for example. In one or more embodiments, “Secure Boot” may prevent use of unapproved OS images, component controllers, boot methods, boot-time malware (e.g., LoJax), rootkits, outdated kernels, obsolete or evil drivers, to name a few examples. In one or more embodiments, OS kernels, upon which, or within which, CICAI may depend at least in part, may extend secure boot validation into a Runtime Adapter at least in part by checking signed drivers or executables with root privileges, thus blocking off-the-shelf exploit tools (e.g., Mimikatz or Metasploit), for example.

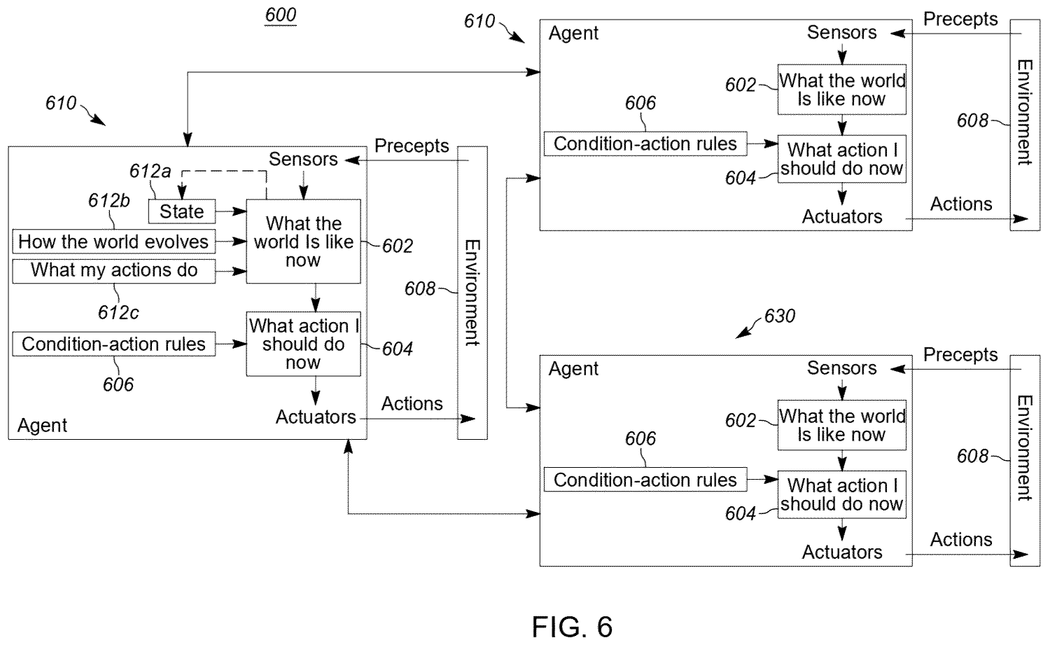

In one or more embodiments, one, or a plurality of, a) hardware-based or software-based AI-agents operating autonomously while communicating asynchronously as a ‘wavefront-array, or b) hardware or software-based AI-agents operating autonomously while communicating synchronously as a ‘systolic-array, or c) a heterogeneous or multi-agent architecture wherein the agent may, or may not, be AI-agents, operating asynchronously, empowered with a myriad of stochastic methods and neural network computational techniques commonly used in the construction of Large Language Models (LLMs), performing machine-learning, deep-learning or managing operational work-flows pertaining to the forgoing. See, for example, FIG. 6.

In one or more other example embodiments, CICAI may be implemented, in whole or in part, in one, or a plurality of, microkernel(s) which may be defined as a reduced (e.g., minimal, minimum) amount of programmable, executable, computer-readable software instructions to implement, in whole or in part, a suitable operating system (OS). See FIG. 7, for example. In one or more embodiments, such example mechanisms may include, for example, lower-level address space management partitioned into kernel-space memory, for example, in juxtaposition to user-space memory, POSIX thread, ‘Green thread’ and processing unit Hyper-threads, process thread management, or inter-process communication (IPC), for example. In one or more embodiments, microkernels, executing computer instructions in both SIMD and SWAR modes within CICAI systems, for example, may be designed for higher-security applications (e.g., KeyKOS, EROS) or military-grade cyber-secure systems, for example. In one or more embodiments, some international standards may secure or protect data within-in the CICAI, for example. Such example standards may include, but are not limited to, “Common Criteria for Information Technology Security Evaluation” (“Common Criteria” or “CC”) or standard ISO/IEC 15408 for computer security certification, for example. In one or more embodiments, CICAI may include Common Criteria at higher/highest assurance levels (e.g., Evaluation Assurance Level (EAL) four (4) through seven (7)) or may suggest processing unit or software be “simple,” for example.” Simple” in this context refers to ‘” Department of Defense Trusted Computer System Evaluation Criteria in B3/A1,” which provides “The TCB [Trusted Computing Base] shall use complete, conceptually simple protection mechanisms with precisely defined semantics. System engineering may be directed toward minimizing the complexity of the TCB, as well as excluding from the TCB those modules that are not protection-critical.” Of course, subject matter is not limited in scope in this respect. In one or more embodiments, CICAI may implement, in whole or in part, one or a plurality of microkernel-based AI-agents operating within a systolic-array or wavefront-array architecture, for example, whereby IPC may be synchronous or asynchronous using, as but one non-limiting example, a cyber-secure publish-and-subscribe message bus perfected to implement, in whole or in part, FIFO or LIFO buffers in some circumstances, for example.

In one or more embodiments, wherein Microkernels may be utilized, at least in part, in conjunction with one or more AI-agents, for example, an example Microkernel configuration may comprise a Kernel-space operation, for example, to keep an inventory of software components (e.g., all software components) which may be in operation and those which should be in operation, in embodiments. In one or more embodiments, for example, for circumstances in which there may be a deviation between the two lists (e.g., software components in operation vs should be in operation), for example, a microkernel boot-loader-type AI Agent (e.g., referred to herein as “HuroBOSS”) may schedule kernel or process threads to start-up, restart or terminate, for example, or to maintain inventory of AI-agent provisioning for performance of action, for example, or some management information base (MIB) content, for example. In one or more embodiments, a microkernel boot-loader may be responsible for initializing system hardware or loading a microkernel into memory, for example. In one or more embodiments, a boot-loader-type AI-agent may further have a capability to detect failures or attempt to restart a microkernel, for example.

In one or more embodiments, during Microkernel boot-up, for example, an init-type process may comprise a special process that may be launched by a microkernel during boot-up, for example. In one or more embodiments, init may be responsible, at least in part, for initializing a system by starting user-space services (e.g., essential user-space services) or operating system kernel daemons (e.g., processes), for example. In one or more embodiments, responsive at least in part to an init process detecting an issue with a microkernel, an init process may not be able to perform its tasks or the system may halt, for example.

In one or more embodiments, microkernel architectures may rely, at least in part, on redundancy mechanisms for system components (e.g., critical system components), for example. In one or more embodiments, some systems may include multiple boot-loaders or redundant init processes to improve fault tolerance, for example. Additionally, in one or more embodiments, external monitoring tools may be used to observe health of a system, including a microkernel, for example. In one or more embodiments, a HuroBOSS Agent, for example, may provide monitoring, restart or thread supervisory control, for example.

One or more embodiments may comprise one or more of the following example AI-agent types. Of course, subject matter is not limited in scope in these respects.

Homogeneous Reflexive AI-agents. In one or more embodiments, Homogeneous Reflexive AI-agents, for example, may respond autonomously to changes in state within its own Runtime Adapter or a Runtime Adapter of other Homogeneous Reflexive AI-agents, for example. See FIG. 8, for example. In one or more embodiments, Homogeneous Reflexive AI-agents may be implemented, in whole or in part, as one or a plurality of mixed permutations of SISD or MISD architecture processing units, for example, in Runtime Adapter where an AI-agent's next programmatically defined action may be driven by reflection software techniques to compare software instructions, for example, and their concomitant states, with telemetry about an environment in question, for example. In one or more embodiments, SISD or MISD asynchronous wavefront-arrays executing software instructions for Homogeneous Reflexive AI-agents may comprise one of many possible implementations. In one or more embodiments, Homogeneous Reflexive AI-agents may be written in assembler or c/c++ due at least in part to the complexity of manipulating data in registers of processing units, for example.

Heterogeneous reflexive AI-agents. In one or more embodiments, Heterogeneous reflexive AI-agents may respond autonomously, for example, to changes in state within a collection of Runtime Adapters operating within heterogeneous hardware or software agent architectures, for example. In one or more embodiments, Heterogeneous Reflexive AI-agents may be implemented, in whole or in part, as one or a plurality of mixed permutations of asynchronous wavefront-arrays, for example, using SISD or MISD architecture processing units, for example, for Runtime Adapters where an AI-agent's next programmatically defined action may be driven, at least in part, by reflective software techniques to compare software instructions, or their concomitant states predetermined by an AI-agent, for example, with telemetry about an environment in question, for example. In one or more embodiments, AI-agents may be written in assembler or c/c++, for example, due at least in part to relative complexities of managing asynchronous FIFO buffers, for example.

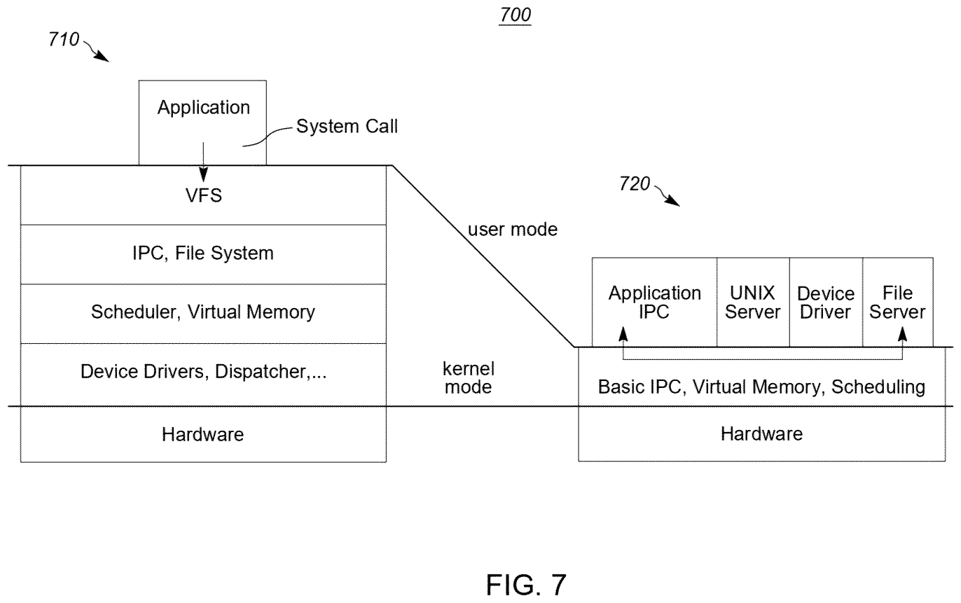

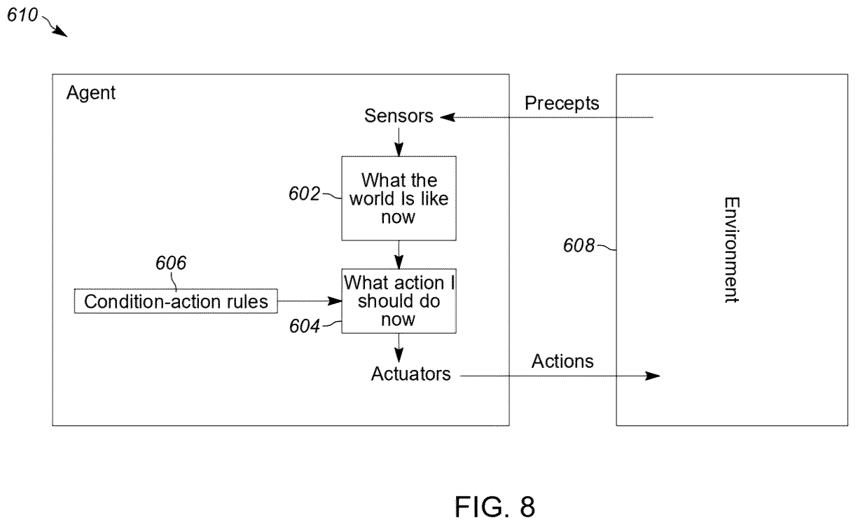

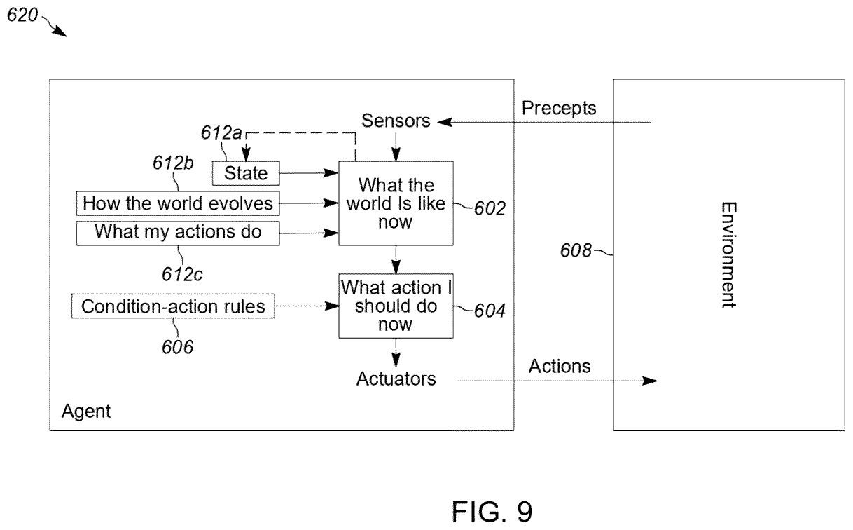

Model-based reflexive AI-agents. In one or more embodiments, Model-based reflexive AI-agents may monitor one or a plurality of Runtime Adapters that may not be immediately perceptible, for example, from unsupervised learning algorithms. In one or more embodiments, a Model-based reflexive AI-agent may autonomously or programmatically analyze or modify configuration of a Runtime Adapter (e.g., its own), or one or more Runtime Adapters of nearest neighbors or network configurations or operating system parameters, for example, at least in part by algorithmically inferring, or programmatically inserting, missing content to complete an algorithmic determination of next-steps, for example. In one or more embodiments, model-based reflexive-type AI-agents may be implemented, in whole or in part, in one or more “memory-safe languages,” such as alluded to previously. In one or more embodiments, a model-based reflexive-type AI-agent may operate in an AI-agent Runtime Adapter without perfect telemetry to accurately measure necessary parameters in its runtime environment. In one or more embodiments, a current state may be stored inside an agent maintaining an encrypted-hash structure, for example, that may describe a part of the world which cannot be seen, for example. See FIG. 9.

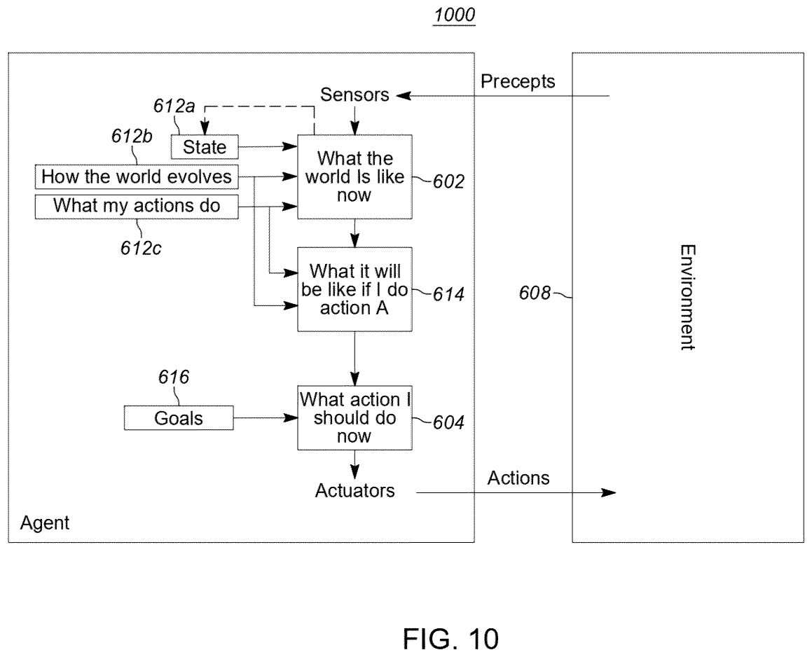

Goal-based AI-agents. In one or more embodiments, Goal-based AI-agents may be implemented, in whole or in part, in one or more “memory-safe languages,” such as alluded to previously. In one or more embodiments, Goal-based-type AI-agents may execute software instructions to test possible (e.g., all possible) permutations of decision-tree navigation to autonomously execute processing unit instructions based at least in part on stochastic evaluation of possible paths (e.g., all possible paths) or may to programmatically perform actions based at least in part on a probability (e.g., greatest probability) to achieve specified goals (e.g., optimal goals), for example. In one or more embodiments, goal-based-type AI-agents may programmatically lay plans or may prescribe programmatic instruction that autonomously lead to specified goals or, in other cases, goals that may be dynamically or programmatically arrived at, for example. See FIG. 10, for example.

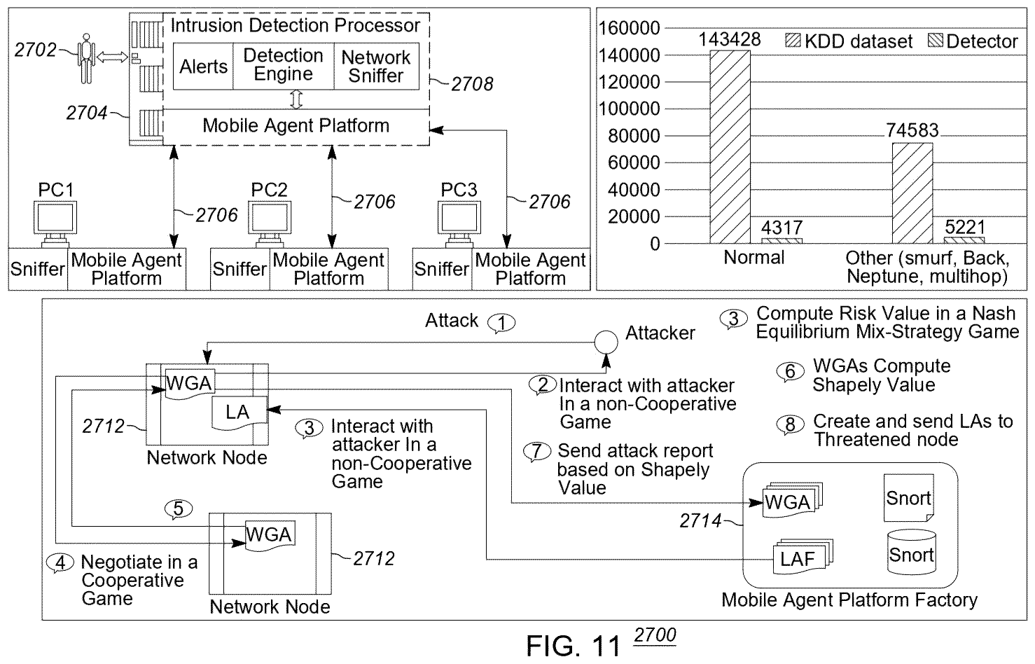

Mobile Cybersecurity AI-agents. In one or more embodiments, Mobile Cybersecurity AI-agents may comprise software-based autonomous-type AI-agents implemented, in whole or in part, in “memory-safe languages (e.g., Python®, Java®, C#, Go, Delphi/Object Pascal, Swift®, Ruby™, Rust®, Ada) to perform continuous vulnerability scanning, vulnerability assessments, port-scanning, memory scans, dark web monitoring for emergent risks, or goal-based penetration-testing of their own Runtime Adapter or the Runtime Adapters within their AI-agent Control Unit to guarantee SOC2, HIPAA, HITRUST, NIST, CIS cybersecurity compliance, to list a few non-limiting examples. In one or more embodiments, such “inside the jar” penetration testing may be orthogonal to prevailing pen-testing techniques because Mobile Cybersecurity AI-agents may algorithmically execute processing unit instructions to programmatically determine if a “zero-trust” environment [e.g., determined by static or dynamic application security testing (SAST and DAST)] has been achieved, for example, in contradistinction to “outside the jar” test “everything all at once and hope for the best” techniques, for example. In one or more embodiments, significant AI-agent Runtime Adapter or virtualized microkernel-based security threats may include VM side channel, VM escape, or rootkit attacks, for example. In one or more embodiments, hardware-only approaches to solving such attacks have been attempted in 1) firewalls, which may be expensive, 2) schedulers to control side channels along with noise injection, which may impose higher overhead, or 3) use of agents to collect content and send the content to a central intrusion detection system, for example, which itself may become a target of an attacker, for example. In one or more embodiments, a group of mobile cybersecurity-type AI-agents may act as the sensors of invalid actions, for example, such as in telco network or cloud environments, for example. In one or more embodiments, Mobile Cybersecurity AI-agents may execute a series of software instructions to begin a noncooperative “game” with a suspected attacker or may calculate a Nash equilibrium value or utility so as to differentiate an attack from legitimate requests, for example, or to determine severity of attack or point of origin. In certain simulations or experiments, it has been observed that, in some instances, such techniques detect attacks with 86% accuracy. See FIG. 11, for example.

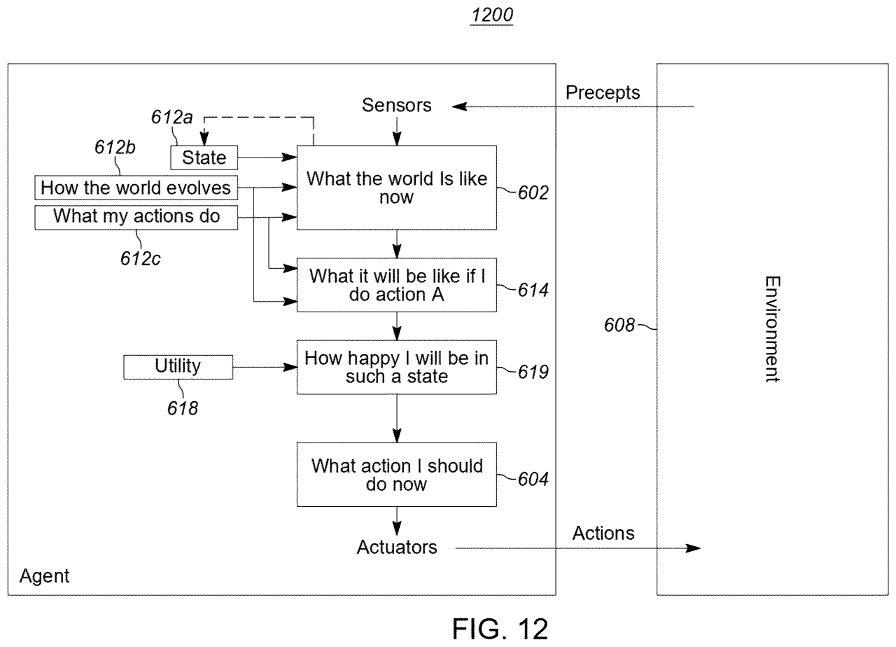

Utility-based AI-agents. In one or more embodiments, Utility-based AI-agents may execute computer readable processing unit instructions to achieve a goal based at least in part on a given utility measure which may comprise one or more combinations of thread utilization, memory usage, processing-unit-clock-cycle consumption, or myriad network metrics, for example. In one or more embodiments, utility-based-type AI-agents may execute processing unit instructions to stochastically predict future outcomes of multiple possible actions with divergent goals, or may algorithmically select a set of processing unit instructions (e.g., advantageous or optimal set) to achieve a goal, for example. In one or more embodiments, Utility-based AI-agents may be implemented in “memory-safe languages,” such as alluded to previously. In one or more embodiments, CICAI platform features, however, may comprise assembler or c/c++ software, for example, written to access processing unit resources without interfering with clock-cycle timings, for example. See FIG. 12, for example.

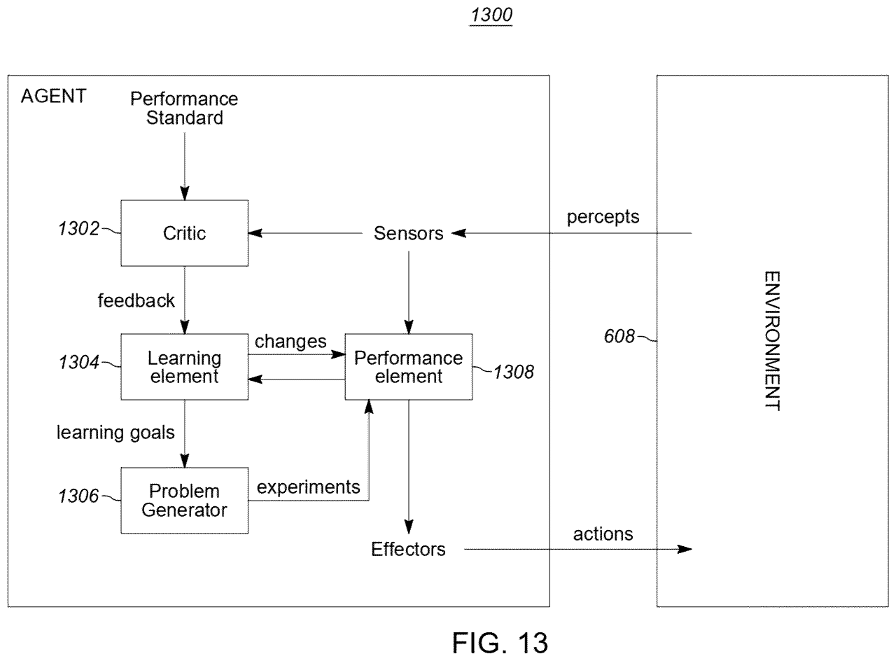

Unsupervised or Supervised Learning AI-agents. In one or more embodiments, Unsupervised or Supervised Learning AI-agents may adapt or evolve algorithmically defined strategies to maximize “rewards,” for example. In one or more embodiments, Unsupervised or Supervised Learning AI-agents may refine (e.g., continuously or near-continuously) user-profiles responsive at least in part to changes in user characteristics, attributes, or skills, or may alternatively invoke a different form of AI-agent to perform a specific purpose which may deviate from a scope of an Unsupervised or Supervised Learning AI-agent, for example. In one or more embodiments, AI-agents may be implemented in “memory-safe languages,” such as alluded to previously. In one or more embodiments, at least some Unsupervised or Supervised Learning AI-agents may comprise assembler or c/c++ software, for example, written to access processing unit resources without interfering with clock-cycle timings, for example. In one or more embodiments, learning, in the context of AI-agents, may allow agents to initially operate in unknown environments to build a knowledge-base about its AI-agent Runtime Adapter autonomously, for example. In one or more embodiments, a processing unit (e.g., core, cell, node) may act as a “learning element” responsible for making improvements or may act as a “performance element” responsible for selecting external actions, for example. In one or more embodiments, a “learning element” uses feedback from a “critic” on how am agent is doing or determines how a performance element (“actor”) may be modified to do better in the future, for example. In one or more embodiments, a performance element may comprise what may have at times been considered to be an entire agent, for example. In one or more embodiments, it may take in telemetry to build ad-hoc perceptions based at least in part on reflexive techniques and decides on actions. See FIG. 13, for example.

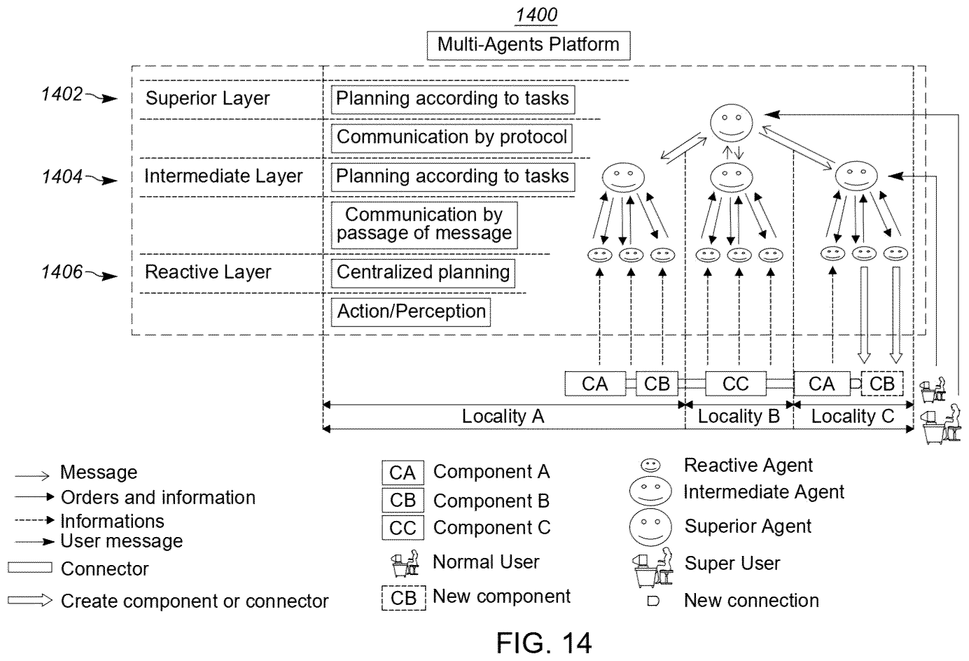

Multi-agent AI-agent Systems (MAAIS). In one or more embodiments, Multi-agent AI-agent Systems (MAAIS) may comprise a system to execute computer readable processing unit instructions for a spectrum of agent architectures which may autonomously orchestrate, substantially or completely without human intervention, recruitment of resources or agents to achieve goals via systolic-arrays or wavefront-array architectures, for example, to achieve self-determined goals expressed as programmatic instructions, for example. In one or more embodiments, MAAIS may be advantageously used for complex or long-duration computing tasks involving multiple different types of agents working in parallel or in sequence as the case may be, where scheduling of processing tasks may be orchestrated to complete among a myriad of agents simultaneously, for example. MAAIS may be implemented in “memory-safe languages,” such as alluded to previously. In one or more embodiments, Unsupervised or Supervised Learning AI-agents may comprise assembler or c/c++ software, for example, written to access processing unit resources without interfering with clock-cycle timings, for example. See FIG. 14, for example.

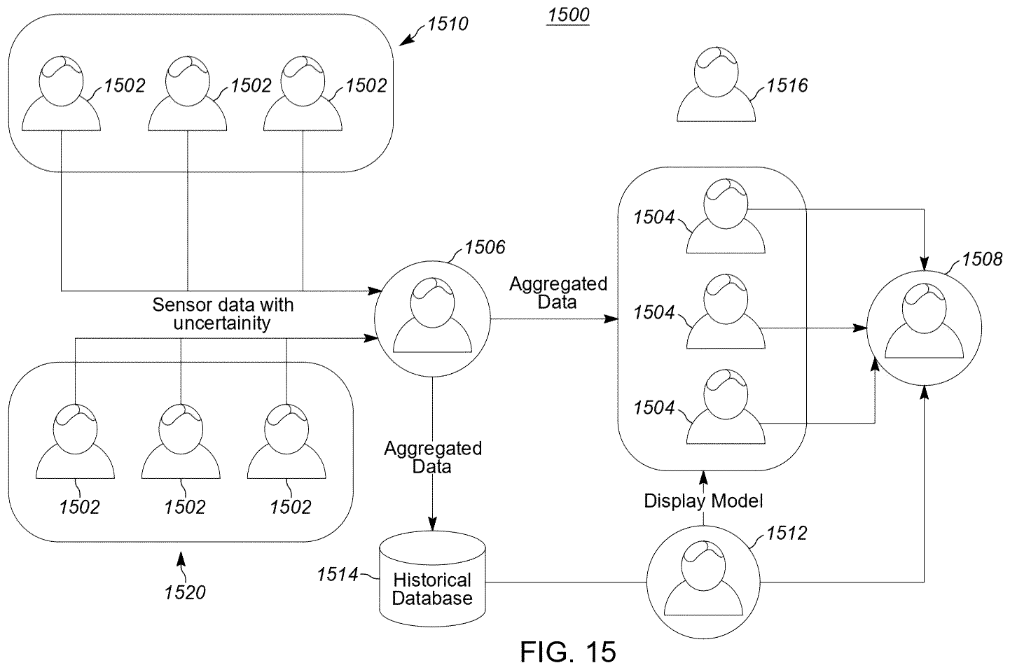

Personal AI-agents (pAI-agents). In one or more embodiments, Personal AI-agents (pAI-agents) may comprise AI-agents devoted to integration with Generative AI Language Models stored in vector-databases, email smtp servers, SMS message servers, web-crawlers, spiders, newsfeeds, or other sources of content that may be unique to characteristics of users, for example. In one or more embodiments, pAI-agents may interact with personalized language models (pLLM) to interrogate pLLM on behalf of its user. In one or more embodiments, access to a pAI-agent or pLLMs may be controlled, at least in part, by Mobile Cybersecurity AI-agents which may act as a three-authentication-factor (3AF) authentication or authorization mechanism, for example, to prevent theft or examination by unauthorized members of a Hierarchical Blockchain wallet, for example. In one or more embodiments, pAI-agents may be implemented in “memory-safe languages,” such as alluded to previously. In one or more embodiments, pAI-agents may comprise assembler or c/c++ software, for example, written to access processing unit resources without interfering with clock-cycle timings, for example. In one or more embodiments, pAI-agents may perform Generative AI textual synthesis (GATS) using Language Models stored in Vector-databases, as well as deep-learning algorithms, for example. In one or more embodiments, aforementioned features may act as a filter for Natural Language Understanding (NLU) to comprehend or interpret user queries and commands in natural language of each individual rather than a generalized Language Model, for example, facilitating more intuitive interactions, for example. In one or more embodiments, a pAI-agent may provide human-like responses to verbal interrogation allowing a pAI-agent to provide contextually relevant or personalized information. In one or more embodiments, pAI-agents possess context awareness over multiple interactions across a time series. In one or more embodiments, these frequent interactions between pAI-agent and human facilitates continuous learning from human interactions to improve, adapt, or to evolve according to ever-fluctuating user needs, for example. In one or more embodiments, pAI-agents may be designed or optimized in at least some respects to execute processing unit instructions to perform any of a variety of tasks based on audible, or typed, user requests, such as from relatively simple commands to more complex or context-specific actions, for example. In one or more embodiments, stream-of-consciousness-type conversational flow or presentational flow may be an advantageous aspect of a pAI-agent. For example, conversation flow may emerge by context-awareness, maintaining coherence, and avoiding repetitive, disjointed, or illogical responses, for example. See FIG. 15, for example.

Hierarchical AI-agents. In one or more embodiments, Hierarchical AI-agents may be structured in a multi-level hierarchical framework of top-down control, for example, wherein an AI-agent may be programmatically assigned a kernel-level interrupt-thread of control over to algorithmically manage multiplexed threads sharing a single POSIX or ‘Green’ thread, for example, to programmatically direct lower-level agents with new goals, axioms or policies, for example. In one or more embodiments, individual levels in a hierarchy may have specific roles or responsibilities, thereby contributing to an overall goal, for example. Hierarchical AI-agents may benefit larger-scale systems where tasks may be broken down or managed at different levels, for example. In one or more embodiments, individual levels in such a hierarchy of AI-agents may be equivalent, in at least some aspects, to multi-layer mesh-networks, for example, in which systolic-arrays and wavefront-arrays may be represented. In one or more embodiments, Hierarchical AI-agents may be implemented, in whole or in part, in one or more “memory-safe languages,” such as alluded to previously. In one or more embodiments, Hierarchical AI-agents may comprise assembler or c/c++ software, for example, written to access processing unit resources without interfering with clock-cycle timings. See again FIG. 15.

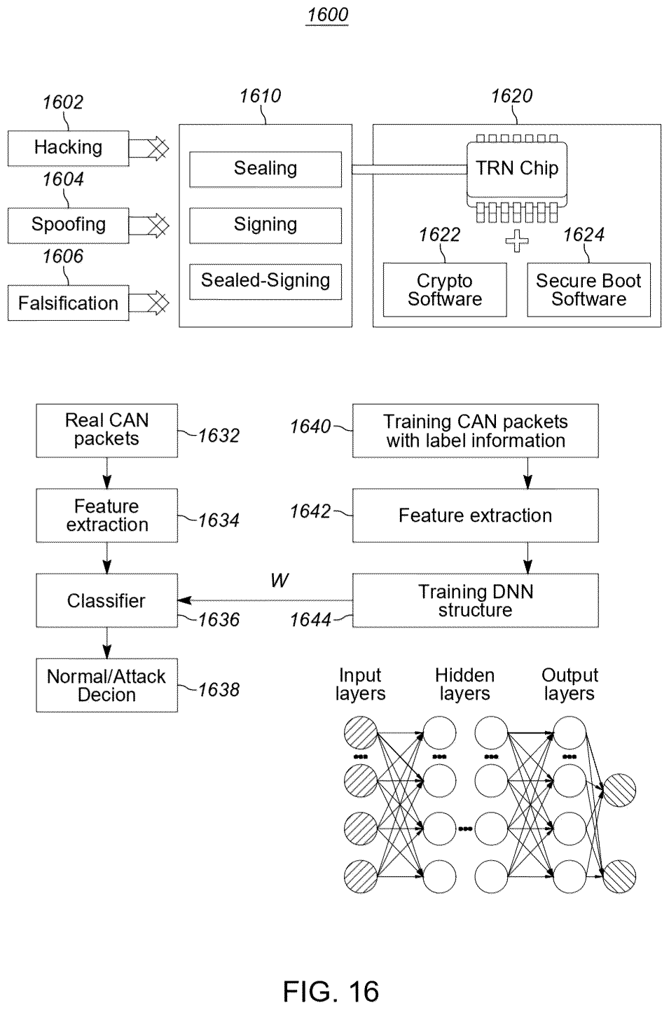

Trusted Platform Module (TPM) AI-agents. In one or more embodiments, Trusted Platform Module (TPM) AI-agents may perform credential storage or system integrity features in an encrypted hierarchical blockchain-wallet stored in a distributed fashion within the boot image, for example. In one or more embodiments, TPM AI-agents may store boot-time integrity measurements in a TPM-accessible encrypted hierarchical blockchain wallet, for safety or storage, for example. In one or more embodiments, TPM AI-agents may possess algorithmic programmable instructions with random number generators, secure memory, or cryptographic key generation algorithms that may be compliant with FIPS 140-2 or later, for example. In one or more embodiments, TPM AI-agents may be implemented in two variants, such as a discrete CICAI TPM AI-agent chipset affixed to motherboards with processing units possessing encryption algorithms or processing unit instructions, or such as firmware-based TPM AI-agents (fTPM AI-agents) implementations provided by processor manufacturers such as Intel® PTT and AMD® fTPM, for example. CICAI-specified Monolithic Operating Systems, for example, may include variants of Linux, Unix, or other POSIX-compliant operating systems which may support SIMD, MIMD, SISD, or MISD architectures within a TRILL network (i.e. Red Hat Enterprise Linux® (RHEL), and CentOS Linux configured for TPM AI-agent kernel monitoring via Integrity Measurement Architecture (IMA) and data-at-rest drive encryption through Linux Unified Key Setup (LUKS)), for example. TPM AI-agents may be implemented, in whole or in part, in one or more “memory-safe languages,” such as alluded to previously. In one or more embodiments, TPM AI-agents may comprise assembler or c/c++ software, for example, written to access processing unit resources without interfering with clock-cycle timings, for example. In one or more embodiments, microcode embedded in the CICAI TPM AI-agent chipset may be implemented in an FPGA, SOC or ASIC in assembler or c/c++ in lieu of another form factor, for example. See FIG. 16.

The following discussion provides additional definitions or descriptions of various aspects of various embodiments.

AI-agent. In one or more embodiments, an AI-agent may describe processing unit instructions triggered by software or hardware to perform tasks in SISD, MISD, SIMD and MIMD architectures, for example, to execute processing unit instructions in a CICAI context. AI-agents may alternatively operate in non-deterministic environments where mathematical models, rewards or values are pursued, as well as in reinforced learning frameworks, for example. In one or more embodiments, AI-agents may autonomously navigate the web as part of a work-flow, may interact with applications via exposed application programming interfaces (APIs), may process vast amounts of data in regard to Small and Large Language Models, may engage in financial transactions without human intervention, or may simulate the behavior and voice of a human-being to act as a proxy for a human being, for example. In one or more embodiments, an AI-agent may comprise a hardware or software-based computing entity capable of executing programmable, or embedded in hardware, instructions within its own memory space wherein those instructions may include varying permutations of supervised (e.g., labeled data for regression or classification), unsupervised (e.g., unlabeled data for sorting into pre-defined clusters) or reinforcement (e.g., agent-based positive reward, or a negative reward reinforcement) learning.

In one or more embodiments, reinforcement learning may mean different things over a time sequence depending upon the types of agents and pursuit of learning paradigms. For example, in a “Policy approach” an AI-agent may comprise a self-determinant processing unit which may determine a next action taken by the agent with ‘a priori’ provisioned policies or axioms, without external instructions (e.g., autonomy).

In another example, AI-agents may operate within a definition of a framework wherein telemetry from within its execution environment, or dynamics of change within that environment, may be rapidly changing. Thus, an AI-agent responds to external stimulus determined through stochastic evaluation of telemetry within an environment or receives a virtual “reward”. In yet another example of ‘Reinforcement Learning’, an AI-agent may be employed to perform “value pursuit” which may be different from a “reward”-based pursuit described above, for example. In value-seeking AI-agents, the “value” is the result of many actions over a long time-series, for example.

In one or more embodiments, AI-agents may algorithmically perceive changes in a Runtime Adapter through the use of reflective/reflexive software techniques which may analyze telemetry received from a Runtime Adapter. For example, fluctuations in stock-market pricing of equities, user-behavior on e-commerce websites, or astronauts in space may be continuously monitored or analyzed, for example. In one or more embodiments, AI-agents autonomously respond to rapid changes in Runtime Adapter states, or conditions, to act according to algorithmic policies expressed as computer instructions, or axioms expressed as scripts interpreted by a script interpreter or a collection of processing unit instruction to stabilize the Runtime Adapter for efficient operation, for example. In one or more embodiments, AI-agents perform work-flows by interrogating or interpreting complex datasets (e.g., vector-databases, Graph databases, NOSQL databases, or other such means of digital storage) to extract meaningful information or insights otherwise difficult or impossible to detect by humans performing similar actions on similar data without AI-agent assistance, for example. In one or more embodiments, AI-agents, for an example, may comprise autonomous decision-makers in the context of work-flows, executing software instructions to return the work-flow to sequential or parallel operations without human interdiction, for example. In one or more embodiments, AI-agents, using stochastic or neural networks algorithms with which they may be provisioned, for example, may perform complex problem solving work-flows, such as, by way of non-limiting example, optimizing a supply chain process based upon revenue to cost ratios or diagnosing a technical faults in electronic systems, such as by analyzing data metrics in logs, beyond human capacity in terms of speed of execution or resource-efficiency, for example. In one or more embodiments, AI-agents when empowered with algorithmic or programmatic autonomy may provide stochastically-derived predictions of future outcomes, for example, or may undertake supervised/unsupervised learning to improve performance, for example. In one or more embodiments, continuous supervised or unsupervised learning processes performed by AI-agents may, for example, determine (e.g., algorithmically) goals in complex business plans, multi-year engineering programs, staffing, for example.

In one or more embodiments, an AI-agent may be alternatively classified into different types based at least in part on behavioral characteristics rather than their operational characteristics, for example. In one or more embodiments, AI-agents may be classified based at least in part on behavioral characteristics such as whether they are reactive, proactive or passive, whether they have a fixed or dynamically configured environment, or whether they are single, plural or multi-agent systems, for example.

Reactive AI-agents. In one or more embodiments, reactive AI-agents may respond to immediate telemetry stimuli received from sensors, a sensor managed by other AI-agents, or external systems multiplexing such telemetry, for example, or take actions based on those telemetry stimuli, for example. In one or more embodiments, reactive AI-agents may be implemented, in whole or in part, in “memory-safe languages” as alluded to previously. In implementations, Reactive AI-agents may comprise assembler or c/c++ software, for example, written to access processing unit resources without interfering with clock-cycle timings, for example.

Proactive AI-agents. In one or more embodiments, proactive AI-agents may be empowered with algorithms, memory or software instructions, for example, to create plans to achieve goals as defined in their axioms, for example. A computing, network, or communications environment in which an AI-agent may operate may be fixed (e.g., as in “FPGA/ASIC/SoC, single core, multi-core) or may be dynamic, for example, such as in a case of reflexive software algorithms which may allow the AI-agent to interrogate itself for operational parameters which may or may not call for adjustment for advantageous (e.g., most optimal) operations, for example. Fixed environments, as described above, may have axioms or interfaces that may not change, while dynamic environments (e.g., spread-spectrum intra-Agent communication, randomized one-time pads) may frequently or constantly change or may prompt AI-agents to adapt to new situations, for example. In one or more embodiments, proactive AI-agents may be implemented, in whole or in part, in “memory-safe languages” as alluded to previously. In implementations, Proactive AI-agents may comprise assembler or c/c++ software, for example, written to access processing unit resources without interfering with clock-cycle timings.

Multi-agent systems may involve multiple agents (e.g., hardware-based, software-based, or a hybrid of hardware-software) operating according to plans to achieve a common goal, for example. In one or more embodiments, such AI-agents may coordinate actions or may communicate with each other to achieve objectives. In one or more embodiments, AI-agents may be used in a variety of applications, including, by way of non-limiting example, robotics, gaming, or intelligent systems, for example. Such systems may be implemented, in whole or in part, using different programming languages or techniques, including machine learning or natural language processing, for example, yet they may have their own grammars, syntax or dictionaries, such as for terse, if compressed, communication streams.

To further elucidate, in one or more embodiments, an AI-agent may comprise: a hardware or software entity having private or shared memory-address locations; a device fabricated as a processing core/unit acting as the agent; or a software entity with one or more threads of control of a processing unit, for example. In one or more embodiments, an AI-agent may comprise a hardware or software interface for external communication to other AI-agents or control systems, for example. Also, in one or more embodiments, an AI-agent may have its own code library for reprogramming itself according to a plurality of dynamic planning algorithms to accomplish a myriad of goals which may or may not align with the goals of its nearest neighbors, for example.

According to other embodiments, an AI-agent Control Unit may modify an axiom repository by signaling to an associated AI-agent Runtime Adapter a demand for new axioms. In one or more embodiments, a derivation of new axioms, which may be referred to as knowledge abstraction, may comprise a Small Language Model (SLM), Large Language Model (LLM), or an encrypted vectorized hash-table resident in the control unit of the AI-agent, for example. In one or more embodiments, a former alternative describes a knowledge base of an AI-agent as an active, blackboard-like system, for example, whereas a latter alternative corresponds to a view of a classic Artificial Intelligence (AI) planning system (e.g., negotiation or voting using tokens). In one or more embodiments, a performed alternative may depend at least in part on a power of inference services provided by the LLM in repository, in one or more embodiments.

AI-agent Control Unit. In one or more embodiments, an AI-agent Control Unit may comprise a Godel-set of AI-agent Runtime Adapters fit for a specific purpose (e.g., LLM ingestion, unstructured data ingestion, machine learning, deep learning, NLP, translation, text-to-speech synthesis), for example. In one or more embodiments, an AI-agent Control Unit may comprise a computer software program, firmware, or semiconductor-based system that may be designed to perceive its Runtime Adapter according to a collection of pre-provisioned axioms or a continuous telemetry-measurement system to craft its own axioms using a grammar of its own. In one or more embodiments, AI-agent Control Units may make autonomous decisions or may take self-directed actions to achieve a specific goal or set of goals by orchestrating the actions of one or a many (e.g., a swarm) of AI-agents, for example. In one or more embodiments, within a context of an AI-agent Control Unit, AI-agents may operate autonomously, meaning AI-agents are not directly controlled by a human operator or external system, for example.

AI-agent Axiom Repository. In one or more embodiments, an AI-agent Axiom Repository may be encrypted in a Hierarchical Blockchain wallet in a storage location wherein axioms expressed as instructions for processing units to execute control, function, work-flow or verification, for example, may be stored for rapid retrieval by AI-agents, for example. In one or more embodiments, an Axiom repository may rely at least in part on the TMP AI-agent for verification. In one or more embodiments, an AI-agent Axiom Repository may at once contain software instructions to algorithmically perform all relevant algorithms necessary to perform functions fit for a specific purpose, for example, not the least of which may comprise autonomic execution of software instructions formulated by the AI-agent itself, for example.

AI-agent Runtime Adapter. In one or more embodiments, an AI-agent Runtime Adapter may include, but is not limited to, a software-based processor emulator, a virtual-machine emulating an operating system, a processor core, cell or node which may, or may not, include a microkernel operating-system controlling access, a multi-core processor providing threads of control to a software or semiconductor-based AI-agent, for example. In one or more embodiments, an AI-agent Runtime Adapter may reside in an FPGA/ASIC/SOC, a software Virtual Machine, a software virtual machine running on any one of a Processor cores, FPGA, ASIC, SOC or a memory-based processor emulator, for example. In one or more embodiments, an AI-agent Runtime Adapter may operate in any permutations of MISD, SISD, MIMD or SIMD-conforming architecture (e.g., whatever may be suggested by a particular use case), for example. In one or more embodiments, CICAI AI-agent Runtime Adapters may operate advantageously in MIMD, for example. However, similar functionality may be derived through more complex methods (e.g., any combination of MISD, SISD, SIMD or MIMD). In one or more embodiments wherein CICAI AI-agent Runtime Adapters may lack hardware capable of MISD, SISD, SIMD, or MIMD, CICAI may be implemented as a SWAR (SIMD within a register) architecture involving general-purpose computer processors comprising one or more cores, cells, nodes, for example, which may lack SIMD micro-instructions in a hardware to perform SIMD operations.

Generalized Large Language Models. In one or more embodiments, generalized Large Language Models (gLLM) may comprise artificial neural networks formulated for interrogation to achieve general-purpose language generation or other natural language processing tasks such as classification, for example. In one or more embodiments, LLMs may acquire such abilities at least in part by learning statistical relationships from text documents, such as during a computationally intensive self-supervised or semi-supervised training process, for example. In one or more embodiments, LLMs may be used for text generation, a form of generative AI, at least in part by taking an input text or repeatedly predicting a next token or word, for example.

Personalized Large Language Models. In one or more embodiments, personalized Large Language Models (pLLM) may comprise knowledge stores of artificial neural networks crafted for unique characteristics of each individual or other natural language processing (NLP) tasks such as classification, for example. In one or more embodiments, pLLMs may acquire such example abilities at least in part by learning statistical relationships from text documents (e.g., formatted, semi-formatted or unformatted textual documents such as, for example, PDFs, Electronic Spreadsheets created in software, Comma-separated-Value data-exchange formats, JSON & Restful API interrogation, voice transcripts), for example. In one or more embodiments, pLLMs may differ from gLLMs due at least in part to, for example, education, childhood origins, language, dialect or vowel pronunciations, for example, perhaps along with, for example, tone, timber, logical constructions or idioms are unique to an individual. In one or more embodiments, such unique characteristics may be encoded in a pLLM to help ensure context or content of communication (e.g., voice recording), as it evolves over time, are captured during a computationally intensive self-supervised or semi-supervised training process, for example. In one or more embodiments, gLLMs may be used for text generation, a form of Generative Artificial Intelligence-algorithm, for example, taking an input text (e.g., AIPrompt) or repeatedly predicting a next token or word based upon ‘a priori’ processing using one or more of the following vector-based computational methods: matrix-mathematical techniques used in vector quantization algorithms pioneered by Dr Tuevo Kohonen, Tensor Flow algorithms, or Kronecker Dynamical System methods, to name but a few non-limiting examples.

In one or more embodiments, using a Personalized Language Model, interrogated by a personal AI-agent (pAI-agent) crafted for individual pLLMs, the pLLM may be virtually overlayed on generalized Language Models, for example, as a language interpreter or for translation, for example, by a pAI-agent to return Language Model interrogatories in a manner consistent with, but not limited to, example characteristics of an individual utilizing, at least in part, a pLLM: religious hermeneutics; semiotics of an individual's specific language dialect; profession or occupation of individual; first-language of individual; or educational facility attended, for example. One or more embodiments may thus engage in interpreting or translating prompts for Language Models which may not be constructed in language of a Language Model creators who may possess a personalized Language Model, for example, with word-order adjustment, for example, using a CICAI ‘Language Model Abstraction Layer’ (LAL), for example, as interpreter or arbitrator of one language to another, for example, or translating a response from a Language Model into a language of the individual, IoT device, for example, or AI-empowered Avatar interrogating the Language Model, for example. This also means that a CICAI LAL may simultaneously or concurrently, for example, interrogate a plurality of Language Models in a plurality of different languages, for example, returning one or more responses in a language of an interrogator, for example. One or more embodiments may include a CICAI deployed in a SAGINs configuration, for example, to perform language interpretation, transcription, or transliteration services, for example, such as to empower sender or receiver to communicate transparently or efficiently in their respective synthesized voices or to have, as may be appreciated by practitioners of the art of “Computerized Linguistics,” their analog voice speech translated into an original language writing script of a sender inclusive of special diacritics which may embed tone, timber, intent, emotions (e.g., happy with upward intonation of vowels, stoic pronunciation of vowels with flat emotional delivery, or downward intonation of vowels reflecting a disappointed tone consistent with the ethnic or societal “norms” of both sender or receiver), for example.

Diacritics may be utilized to advantageous effect, in one or more embodiments. More specifically, in certain simulations or experiments, it has been observed that, in some instances, diacritics applied to a particular area of computational linguistics, such as relating to, for example, interpretation (e.g., semiological, hermeneutical interpretation of a sender's capabilities), transcription, translation, transliteration, or the like may prove beneficial. For example, diacritics may be utilized, in whole or in part, to capture aspects of human speech which may be generally only practiced among human languages using, for example, abjad-alphabets in societies such as North African Amazigh Tifinagh, Gulf Arabic, Farsi or Hebrew, for example. Such diacritics, when embedded in the transcriptions of conversations or presentations, for example, may facilitate recreation of emotion in an individual's analog voice speech translated into an original or native language writing script inclusive of special diacritics which may embed tone, timber, intent, emotions, as explained above. Moreover, due at least in part to a transcript having been generated in real-time or near real-time, textual exegesis may occur to determine if dialog patterns of communication are consistent with history or society. In circumstances, foregoing may be a consideration because, from a military or law-enforcement standpoint, people who speak in codes may not be readily found using standard analog-to-digital voice analysis. By capturing languages (e.g., all languages) with diacritics embedded therein, encoded messages may be detected, thereby triggering autonomous recruitment of additional AI-agents to perform algorithms to more dutifully analyze bilateral or voice conversations or presentations, for example.

Personal profile. In one or more embodiments, a personal profile may comprise content representative of personal characteristics of an individual. Such characteristics may include, for example, regional or social variety of a language distinguished, for example, by pronunciation, grammar, or vocabulary, for example, especially, in one or more embodiments, a variety of speech differing from a standard literary language or speech pattern of a culture in which it exists, considering uniqueness of particular individuals, ethnicity, languages or cultures, for example.

One or more embodiments herein may describe networking hardware or networked software implemented within or adjacent to a telecom network or network device to provide real-time, or near real-time, interpretation or translation of communications to normalize or equivocate communications according to both sender(s) or receiver(s), for example. One or more embodiments described herein may be directed to “leveling the playing field” for the largest or smallest economies on the Earth by removing significant economic or educational barriers, real or unreal, to commerce. Developing economies, or governments with lower national literacy rates or higher unemployment rates, for example, may be benefactors, perhaps more so than developed countries because one or more embodiments described herein provide approaches whereby capital may independently find labor of merit, globally, simply by picking up the phone or dialing anyone in the world to discuss exchange of products or services in exchange for value, for example.

As previously alluded to, embodiments described herein may involve telecommunications networks, such as digital or analog networks, for example, with one or more data processing units that may be communicatively connected or coupled to one or more computing devices or platforms so as to provide computational source-to-target language conversion services in real time or near-real time. As described in greater detail herein (e.g., above and also below), these services may include, for example, interpretation, translation, transcription, transliteration, aspects or processes, such as implemented, at least in part, in connection with one, or a plurality of, sender(s) and one, or a plurality of, receiver(s) engaged in unilateral, bilateral, directional, or omnidirectional network-type communication, for example.

### General Characteristics of Agents.

As will be appreciated, various embodiments or implementations of AI-agents are possible. One or more embodiments may, however, comprise AI-agents that may share at least some of the following characteristics:
(a) In one or more embodiments, AI-agents may assume a cyber-secure environment already exists wherever they run or by an existing AI-agent Runtime Adapter serializing a cyber-secure AI-agent Runtime Adapter to a new destination, for example;
(b) In one or more embodiments, individual AI-agents, being self-reflexive software-clones of one another, may utilize some common services (e.g., logging, security manager, device adaptor, class loader) which may be used by an AI-agent Runtime Adapter, for example;
(c) In one or more embodiments, AI-agents may operate within a (limited) stochastically defined relationship hierarchy between other agents at runtime which may be defined at least in part by a totality of AI algorithms, axioms of control, messaging service, policies, or topology mapping service to participate in problem-solving, for example;
(d) In one or more embodiments, AI-agents may assume that all resources are freely available or if a technology resource is available to an AI-agent (including but not limited to a printer, processor, memory, storage), an AI-agent has axioms stored in an encrypted hierarchical blockchain wallet defining permission to use the resource unless otherwise restricted by the AI-agent cyber-security manager, for example;
(e) In one or more embodiments, individual AI-agents may have a unique ID within an AI-agent Runtime Adapter in which it operates or which, when coupled with an AI-agent's unique ID, defines a unique AI-agent name. Also, in one or more embodiments, a Universally Unique ID (UUID) generator may generate an AI-agent's unique ID, for example;
(f) In one or more embodiments, individual AI-agents maintain information regarding its management status or the management domain under which it is being administered. In this way the AI-agent may serialize to a new location by setting a check-point or serializing to a new location where operations may continue unhindered by resource exhaustion, for example;
(g) In one or more embodiments, an AI-agent's management domain state may be defined in one or more of multiple ways, such as Controlling, Subordinate, or Not Applicable (NA), for example. In one or more embodiments, with Controlling, an AI-agent may act as an Axiom Decision Point (ADP), e.g., a logical entity that may make axiomatic decisions according to axioms of control or for other network elements that request such decisions, for example. In one or more embodiments, with Subordinate, an AI-agent refers an axiom decision point to another AI-agent, for example. Further, in one or more embodiments, with Not Applicable, an AI-agent may ignore axiom decision requests made to it by the system, for example;
(h) In one or more embodiments, individual AI-agents may be assigned a named-thread group (POSIX or otherwise) which may, or may not, be operating in the Kernel memory space or User memory Space with concomitant Kernel process controls upon creation, for example;
(i) In one or more embodiments, individual AI-agents may be passed shared variables used to facilitate Remote-process-communication (RPC), Inter-Process Communications (IPC) or AI-agent voting mechanisms, for example, performing messaging transfer between a master message queue or each agent's message queue or associated blackboards, for example;
(j) In one or more embodiments, individual AI-agents, upon instantiation, are assigned a thread priority level by an AI-agent Runtime Adapter, which may be determined by axioms or AI-agent class type being instantiated, for example;
(k) In one or more embodiments, AI-agents may register their UUID within a local AI-agent Runtime Adapter when instantiated; or.
(l) In one or more embodiments, AI-agents may have an ability to be passivated or re-activated by the kernel threads associated with an AI-agent or its AI-agent Runtime Adapter.

As discussed above, individual AI-agent Runtime Adapters may have an ability to provide telemetry on the per-thread utilization of individual threads running within it. Such content may be used by an AI-agent control unit to, for example, help determine load balancing on AI-agent Runtime Adapters.

One or more embodiments may include systolic-arrays or wavefront-arrays of AI-gents performing parallel or sequential execution of algorithmic computer instructions (e.g., instructions which are either embedded in hardware-based AI-agents or intrinsic to software instructions embedded in AI-agents). In one or more embodiments, parallelized AI-agents may be configured (e.g., optimized) for, by way of non-limiting examples, image or video processing, speech recognition, data compression, Convolutional Neural Networks, Recurrent Neural Networks, Deep Belief Networks, Symmetric Key Encryption, Hash Functions, computerized-vision Object detection or recognition, Facial Recognition, or Video analytics. Of course, subject matter is not limited in scope in these respects.

In one or more embodiments, training data sets, such as for Large Language Models (LLM), may be gathered from any of a wide range of sources. In some embodiments, LLMs may be developed by a vendor (e.g., CICAI vendor) for subscribers to their platform. For example, a cluster of construction companies may subscribe to a CICAI cloud platform. Permission may be sought from these companies to utilize their public or non-proprietary information to help train an LLM for this example cluster of companies. Clustering entities in this manner may make sense in some circumstances because their lexicon may reuse the same nouns or verbs from other disciplines but may have very different meanings in their particular context (e.g., construction).

In one or more embodiments, Language Models, for example, may be built based on data gleaned from other sources. For example, it may be desirable or advantageous to interrogate other AI platforms such as Google® Gemini®, Microsoft® Copilot® A Language Model abstraction layer may be constructed to translate content requests from the other sources into a format that would be proper for the particular target platform. In one or more embodiments, content obtained from one or more sources may be transformed into the phrasing, terminology, vernacular that is appropriate for a specified purpose. Generally stated, training data may be procured from other vendors, in one or more embodiments.

In one or more embodiments, a CICAI network may provide a myriad of Artificial Intelligence algorithm-enabled network-based services, such as at Link Layers of Telco (i.e., telecommunication) networks, for example, to perform real-time or near real-time interpretation, translation, transcription, or transliteration operations of one or a plurality of a wide range of use cases in concurrent peer-to-peer, one-to-many, many-to-one or many-to-many configurations, for example. The discussion that follows is directed to one or more embodiments comprising a Telco switch (e.g., softswitch).

As alluded to previously, embodiments described herein may involve telecommunications networks, such as digital or analog networks, for example, with one or more data processing units that may be communicatively connected or coupled to one or more computing devices or platforms so as to provide computational source-to-target language conversion services in real time or near-real time. As is described in greater detail herein (e.g., above or below), these services may include, for example, interpretation, translation, transcription, transliteration, aspects or processes, such as may be implemented, in whole or in part, in connection with one, or a plurality of, sender(s) and one, or a plurality of, receiver(s) engaged in unilateral, bilateral, directional, or omnidirectional network-type communication, for example. Thus, as previously alluded to, example embodiments may, for example, facilitate or support one or more technological solutions to one or more global technological problems that may otherwise be unsolvable, including, for example, organizing or collapsing discrete operational equipment (e.g., legacy of prior years of phone-service provisioning) into more effective or more efficient (e.g., smaller, greener, with lower power demands) footprints.

“Softswitch” or the like in this context refers to a call-switching node in a telecommunications network implemented, at least in part, in software executed by a computing platform. Softswitches may be contrasted with switching nodes implemented, in whole or in part, utilizing the specialized switching hardware of traditional telephone exchanges. In one or more embodiments, a softswitch may connect telephone calls between callers, subscribers, customers, or other individuals or entities across a telecommunication network. In one or more embodiments, softswitches may be configured to switch calls utilizing, at least in part, voice over IP (VOIP) technologies or approaches, although subject matter is not limited in scope in this respect. Further, as described in one or more example embodiments herein, a softswitch may be implemented, in whole or in part, in a telecommunications switch (e.g., class-4 telecommunication switch) or, in one or more embodiments, may be implemented, in whole or in part, in computing platforms adjacent to or otherwise connected to a telecommunication switch.

Use Case: Class-4 Software Defined Networking Softswitch (equivalent) with CICAI located between CTI/ACD and Audio Record Server.

In embodiments, including but not limited to Class-4 software defined networking softswitch (equivalent) with a Class-1 International Gateway as the call load-balancer and/r quality-assurance platform (also known as a ‘Tandem Switch’ providing services to telco network callers), a CICAI may be configured as a Class-4 switch with inter/intra-switch signaling protocols, for example. Uses or applications of one or more such embodiments may prove impactful or greatly beneficial. In embodiments, a Class-4 software defined networking softswitch (equivalent) may not connect directly to telephones. Rather, it may connect to other Class-4 switches or to Class-5 telephone switches that may provide services to voice-calls on a particular network. In general, telephones of service subscribers may be wired to class-5 switches. In some circumstances, 2g or 3g wireless technologies, for example, may still available because of their utility, such as in rural areas where the revenue may not justify 5g/6g/fiber or satellite-coverage, for example. When a call is placed to a telephone that is not on a same Class-5 switch as an originating subscriber, a call may be routed through one or more Class-4 switches to reach its destination.

A CICAI softswitch configured with Autonomous AI Agents (‘software-based switch’), in embodiments, may make use of digital signals to route calls digitally or over internet TCP/IP networks, for example. Traditional switches can be expensive to maintain or upgrade, for example, whereas softswitches, in one or more embodiments, may run on standard, perhaps off-the-shelf, infrastructure, although subject matter is not limited in scope in this respect.

One or more embodiments described herein may be directed to incorporating AI-based technology into existing or future teleconference infrastructures. For example, as mentioned, AI capabilities, such as CICAI, may be implemented, in whole or in part, within telecommunication switches (e.g., class-4 switch) to bring CICAI functions to anybody making a phone call, for example. In one or more embodiments, CICAI may comprise, for example, a communications network, such as a multi-agent network, as one particular example, of one or more processing units executing computer-readable instructions to facilitate or support one or more Artificial Intelligence-type processes, operations, or algorithms.

Although one or more embodiments may be described as comprising class-4 switches, subject matter is not limited in scope in these respects. For example, CICAI-type technologies may be implemented, in whole or in part, in connection with other classes of switches. More generally, for example, one or more embodiments may comprise a soft switch coupled to or otherwise connected to a network, such as a fiber optic network, in one or more embodiments, although, again, subject matter is not limited in scope in these respects.

In many circumstances, AI may be viewed by many as a computing problem, where the focus is on martialing massive amounts of computing resources. However, AI may be more advantageously viewed, in at least some circumstances, as a networking problem. When viewed as a networking issue, many advantages become apparent. For example, one or more embodiments may achieve estimated access times in the sub-millisecond range by implementing, in whole or in part, CICAI functionality in a class-4 switch. More specifically, in certain simulations or experiments, it has been observed that, in some instances, CICAI functionality implemented in connection with a telecommunication switch, such as a class-4 switch, for example, applied to a particular area of computational linguistics, such as relating to, for example, interpretation (e.g., semiological, hermeneutical interpretation of a sender's capabilities), transcription, translation, transliteration, may prove beneficial. For example, in one or more embodiments, a class-4 switch implemented, in whole or in part, in this fashion may perform operations within the switch or adjacent to the switch in the nanosecond range for a concurrent 50,000 people at a time. With such a configuration, in accordance with one or more embodiments, real-time or near real-time interpretation, transcription, translation, or transliteration operations may be performed concurrently for many users. This is a very different approach than an SQL server fetching customer records for a CRM (customer resource management) system somewhere, for example.

Generally, class-4 switches tend to be the workhorses of an entire (e.g., regional, national, or global) telephone network. Because these switches are so ubiquitous, integrating CICAI-type embodiments into such switches may bring very advantageous CICAI technologies to the general public. In one or more embodiments, CICAI class-4 switches may connect a large collection of class-4 switches (e.g., sitting on a 200 Gigabyte backbone that connects an entire collection of class-4 switches) to a smaller network of larger Telco switches that may provide communication between major metropolitan areas or globally. In one or more embodiments, CICAI class-4 switches may make connections from one switch to another, or in so doing may perform real-time or near real-time interpretation, transcription, translation, or transliteration operations as part of a telecommunication network communication protocol interaction, for example.

For this example, use case, one or more embodiments may involve people communicating in language A on one side of a fiber optic network or language B for people participating in the communication on the other side of the fiber optic network (or vice-versa). Of course, subject matter is not limited to fiber optic networks, and subject matter is also not limited to one-to-one communications. For example, as alluded to previously, embodiments may involve one-to-one, one-to-many, many-to-one, or many-to-many communications (e.g., telephone calls, teleconference, presentations, conversations).

In one or more embodiments, CICAI class-4 switches, for example, may form an integral part of a telephone network. In one or more embodiments, once a phone call is placed by a particular individual or that individual has selected particular services, that particular individual may call friends in a foreign country, for example, or real-time or near real-time interpretation, transcription, translation, or transliteration operations may be performed for each phone call, for example. That is, for example, when that particular individual makes a call, a system may remember (e.g., via stored user profile content) that this particular individual has specified special handling.

In one or more embodiments, a “Service-Based Architecture” (SBA) of CICAI may be centered around services that may register themselves or subscribe to other services within a network (e.g., when a user requests text translation or spoken translation assistance). This may enable a more flexible development of new services, to connect to other components without introducing specific new interfaces, for example.

CICAI, in this example use case, may function, at least in part, as a Class-4 phone softswitch on a VoIP network to connect IP-to-IP calls or to control connections at the junction point between packet-switched or circuit-switched networks. In one or more embodiments, a Class 4 CICAI soft-switch may route large volumes of long-distance VOIP calls. For businesses that want to interconnect their VOIP servers, a Class 4 softswitch may secure the delivery of VOIP traffic or services over multiple IP networks, for example. In this manner, a network (itself) may comprise a provider of advanced services otherwise undeliverable in such a fashion. In one or more embodiments, a Class 4 CICAI softswitch may include, but is not limited to, intelligent call routing, language interpretation, language translation, language transcription or language transliteration, for example. Such functionally may reduce congestion in a network, reduce latency, or reduce cost while improving quality of VoIP calls or addressing a myriad of cybersecurity issues. In one or more embodiments, Class-4 softswitches may also include a ‘billing interface’ that may provide call data records via an application programming interface (API), for example, that may accommodate RESTFUL or JSON API calls, to name but a couple of examples. In one or more embodiments, CICAI may provide call records in a RESTFUL or JSON API, although, again, subject matter is not limited in scope in these respects.

PSTN-PBX solutions have been available to businesses for over 50 years. A need for redundant packet-switched networks, borne from the Cold War, is prompting, at least in part, the retirement of copper-wire infrastructure for a more economical TCP/IP based infrastructure deployed via 5g/6g, 5g/6g cell-towers, fiber-optic cables, or satellites (LEO or MEO Cubesats), for example. As an example of the capabilities of wireless technologies, even low-IR laser umbilicals connecting satellites at distances of 3,600+ miles may deliver TCP/IP operating at 800+Gbps interconnections. Much of the discussion herein may relate to embodiments that may, for example, be utilized, in whole or in part, to facilitate or support one or more technological solutions to one or more global technological problems that may otherwise be unsolvable, including, for example, organizing or collapsing discrete operational equipment (e.g., legacy of prior years of phone-service provisioning) into more effective or more efficient (e.g., smaller, greener, with lower power demands) footprints.

In one or more embodiments, or as depicted in FIG. 17, the CICAI may be installed as a Class 4 “Tandem Switch” in any of at least three different locations of a telecommunication network: (1) Just inside customer-premises demarcation point as a “Multilingual Media Gateway”; (2) In core of Internet itself as a TCP/IP-based SaaS Cloud application which integrates a Class 4 “Tandem Switch”; or (3) inside a Time Division Multiplexer (TDM) PSTN as a Class-4 Tandem Softswitch. CICAI functionality may also be implemented, in whole or in part, in connection with, adjacent to, or within subscriber loop carriers (SLC), such as may serve individual neighborhoods, for example.

In one or more embodiments, CICAI may implement, in whole or in part, a computerized linguistic service-provisioning-system to provide low-latency throughput of a sophisticated collection of algorithms implemented, in whole or in part, in FPGA's, ASICS, SoCs, or other hybrid silicon, for example, dedicated (e.g., optimized) for such purposes as including, but not limited to, semiological or hermeneutical interpretation of human language using a Small Language Model (SLM) as a filter for publicly available language models (e.g., Large Language Models (LLMs)), thereby hyper-personalizing results for each individual's vernacular, for example. Concurrent with capturing a transcript of translations along with the audio, a written script may include diacritics such as discuss above. Such diacritics may enable the transcription to be reproduced by AI tools to mimic intonation, pauses, or vowel enunciation in reproducible fashion (e.g., precisely reproducible). This may become more advantageous when a sample of a voice, or a transcript, allows for the AI simulation of a real human in a nearly indistinguishable synthetic fashion. As alluded to previously, depending on context, any of the interpretation, translation, transcription, or transliteration aspects may be used interchangeably, even though just one, or perhaps more than one, aspect may be mentioned for efficiency purposes or ease of explanation or understanding.

In the present example use-case depicted in FIG. 17, a call center employee may use a PSTN access point to access a SaaS cloud-based call-center to perform their job, for example, using a VPN over internet cloud to perform live audio or live text AI-agent fulfillment, for example. Further, a “Work from Home” call-center employee, for example, may access a SaaS cloud-based call-center/Contact-Center software application using a Virtual Private Network (VPN), for example. In this example use case, a call-center employee may log into a call-center “Cloud Application” to perform their occupational functions at home, for example, over a VPN (e.g., voice or text), for example. For the present example, we will use an example of an Arabic-speaking call-center facility where some employees telecommute (e.g., work from home) or others work at a higher-density call-enter office, for example. For this example, the languages supported by this call center may be assumed to be as follows, although subject matter is not limited in scope in these respects:

Chinese, Korean, Dutch, Turkish, Swedish, Indonesian, Filipino, Japanese, Ukrainian, Greek, Czech, Finnish, Romanian, Russian, Danish, Bulgarian, Malay, Slovak, Croatian, Classic Arabic, Tamil, English, Polish, German, Spanish, French, Italian, Hindi and Portuguese.

As depicted in FIG. 17, a call may come into a Private Branch Exchange/Interactive Voice Response (IVR) sub-system (PBX/IVR) from a Public Switched Telephone Network (PSTN). As soon as a call arrives at PBX, it is routed to an Interactive Voice Response (IVR) sub-system. An IVR may alternatively be referred to as a ‘Voice Response Unit’ (VRU). Caller identification, such as account number, may be gathered in IVR/VRU. Caller proceeds with automated IVR inquiries, such as ‘account balance’, or ‘pre-approve purchase’, for example. Such information is typically obtained from various back-end systems or databases, for example. When caller chooses to speak with a call-center employee, the IVR/VRU passes information about call in progress to an Automated Call Distribution (ACD) sub-system.

After caller has interacted with IVR/VRU (e.g., via interaction with number button on handset) to select from a menu of options instructing caller to pick a menu selection, for example, an ACD may route inbound call to a correct agent or department based on caller's menu selection. The ACD may be connected to PBX from PSTN. Depending at least in part on how PSTN-PBX is configured, a plurality of criteria may be checked for a desired destination including, but not limited to, status or current queue waiting times. In one or more embodiments, an ACD may include, but is not limited to, example methods of call distribution:

Simultaneous call distribution—this may comprise an advantageous approach to reduce customer waiting time, for example. With this routing strategy, ACD may alert agents to an incoming call at same time. A first agent that picks up will handle the customer, for example.

Advanced skills-based routing-ACD may prioritize an agent based on a given score. Some of the common skills that may be scored in this routing strategy include, but are not limited to, language proficiency, efficiency, expertise, comprehension, or response time, for example.

Business hours-based routing-ACD may alert agents that are available or may send call directly to voicemail if none are open to handling it.

Hunting in groups of three-Setting up ACD with this option may involve creating a list of extensions that PBX may use, in whole or in part, to poll. Starting at top of list, three extensions at a time may be called for a set period of time. If no agent answers call, a next three agents on list will be polled, and so on.

Prioritized ringing on specific extensions-Rings agents in order specified in Agents tab of a Call Queue. If preceding agent is not available or doesn't answer, call proceeds down list, for example.

In one or more embodiments, when “outside caller” interacts with a call-center employee, an IVR/VRU may pass content (e.g., information) about call in progress to an ACD. This may be referred to as “attaching data to a call.” In one or more embodiments, content sent by IVR/VRU to a call-center employee may include, by way of non-limiting examples:
(a) Caller identification such as Account Number, for example; (b) Indication of what caller was doing when he “opted out” (for example, a successful Balance Inquiry in case of a bank account); commonly referred to as “last action,” for example; (c) A Verify flag indicating that caller successfully provided requested security information, including but not limited to a PIN number, to IVR/VRU, for example; (d) Any other content that IVR/VRU may use in a call routing decision. For example, if IVR menu includes an alternate language selection, content may include customer's choice of language, for example.

A call then arrives at ACD or is routed to a queue, where it waits for an available Customer Service Representative (call-center employee), for example.

In one or more embodiments, at a desktop (e.g., desktop computing device), a call-center employee may be logged into cloud-based call-center software. When an appropriate message is received, desktop works with a Call-Center Software Platform to generate or display a screen-pop-up with information about call, for example. A screen pop-up is displayed at workstation as a separate window alerting call-center employee to new call, for example. In one or more embodiments, clicking appropriate buttons in screen-pop-up window allows call-center employee to begin servicing call. Call-center Agents may have an ability to access other systems or tools through their employe's internal network, helping to ensure that employees' computers have an ability to connect, for example. A call-center employee may login to call-center application after connecting via a VPN, for example.

In one or more embodiments, a plurality of call-center companies maintains or control work-from-home access to call-center applications using Virtual Desktop Infrastructure (VDI), for example. In one or more embodiments, VDI may comprise a desktop virtualization technology wherein a desktop operating system including, but not limited to, Microsoft Windows®, Linux® or MacOS®, runs or is managed in a plurality of possible configurations including, but not limited to, a SaaS Cloud-hosted or data center environment, for example. A VDI may be delivered over a TCP/IP-based network to residence of call-center employee to an endpoint device (e.g., tablet/iPad, laptop computer, desktop computer) which allows call-center employee to interact with operating system or to installed software applications of VDI as if those applications were running locally on call-center employee's tablet/iPad, laptop, desktop computer, for example.

In one or more embodiments, call-center employees may access VDI desktops in various configurations which may depend on an organization's configuration. Various configurations may include, for example, automatic presentation of virtual desktop at login, or requiring call-center employee to select virtual desktop, then call center employee may use a mouse or other input device to click an icon or avatar to execute software instructions to launch VDI call-center application, for example. In one or more embodiments, once call-center employee accesses VDI desktop, execution of software instructions on local call-center employee's device results in a “look and feel” emulating a local workstation. A call-center employee may select an appropriate software in local workstation applications, for example.

In one or more embodiments, each VDI presented to call-center employees may include, but are not limited to, a 1-to-1 or a 1-to-many SaaS Cloud-based or datacenter configuration, generally referred to as “multi-call-center employee.” A single VDI allocated to a single call-center employee may be considered 1-to-1, but numerous virtual desktops shared under a single operating system may comprise a hosted shared model, or 1-to-many, for example.

In one or more embodiments, a server operating system may service call-center employees as either 1-to-1 or 1-to-many. In circumstances wherein, a server operating system comprises a platform for VDI, software called “Microsoft® Server Desktop Experience” or the like may be utilized, in one or more embodiments. Software may be enabled to mimic a workstation operating system to call-center employee, for example. Microsoft Server Desktop Experience adds features such as Windows® Media Player, “Sound Recorder” or “Character Map,” all of which are not natively included as part of a generic server operating system installation, for example.

In one or more embodiments, each vendor platform may be based on a remote display protocol that may carry session data between client or computing resource, for example. Vendor platforms using a remote display VDI protocol may include, but are not limited to, Citrix®, VMware® or Microsoft, for example.

Citrix-“High-definition user experience (HDX)”.
(a) Independent Computing Architecture (ICA); (b) Enlightened Data Transport (EDT).
VMware.
(a) Blast Extreme; (b) PC over IP (PCOIP).
Microsoft.
(a) Remote Desktop Protocol (RDP).

“High-definition user experience (HDX)” from Citrix is a marketing term that encompasses ICA, EDT protocols among other capabilities, for example. In one or more embodiments, VMware-based call-center employee sessions can be based on Blast Extreme, PCOIP or RDP, for example. Microsoft Remote Desktop® may use RDP, for example. A display protocol, or OSI Layer 5 Session protocol, may control a call-center employee display or multimedia capabilities, or functionality of each protocol may vary, for example. PCOIP is proprietary, as is VMware's ‘Blast Extreme’ in-house protocol. EDT or Blast Extreme are directed to (e.g., optimized for) call-center employee Datagram Protocol (UDP) packet frames, for example.

These example OSI Layer 5 Session protocols including, but not limited to, those noted above, may compress data transmitted to or from call-center employee device. In one or more embodiments, if a call-center employee is working on a spreadsheet within a VDI session, call-center Agent's tablet/iPad, laptop or desktop transmits mouse movements or keystrokes to virtual server or workstation, or bitmaps are transmitted back to call-center employee device, for example. Data itself does not populate a call-center employee display, but instead shows bitmaps representing data, for example. In one or more embodiments, when a call-center employee enters additional data in a cell, only updated bitmaps are transmitted, for example. In other words, VDI desktop may comprise a quilt-work of bitmap images knitted together by VDI software, for example. Anyone skilled in the art of cybersecurity will recognize a need for not storing data in memory at end-points.

In one or more embodiments, VDI administrators may, as the case may be, deploy persistent or non-persistent VDI desktops. Persistent VDI desktops have a 1-to-1 ratio, meaning that each call-center employee has their own desktop image, for example. In one or more embodiments, non-persistent desktops have a many-to-1 ratio, which means that many end call-center employees share a single desktop image. A difference between these two types of VDI desktops is in the way screen changes are saved or how permanently installed apps are added to a VDI desktop, for example, while the CICAI performs its functions without notice of VPN or other VDI-enabling systems.

In one or more embodiments, with persistent VDI, a call-center employee receives a permanently reserved VDI resource at each logon, so each call-center employee's virtual desktop can have personal settings such as stored passwords, shortcuts or screensavers, for example. Call-center employees can also save files to a desktop, for example. In one or more embodiments, persistent desktops may have one or more benefits including but not limited to: 1) Customization-end call-center employees can customize their virtual desktop. 2) Usability-Persistent VDI offers a level of familiarity that non-persistent VDI does not. 3) Simple desktop management-SaaS cloud administrators or datacenter administrators manage persistent desktops in the same way as physical desktops; administrators do not need to re-engineer desktops when using a persistent VDI model, for example.

As previously alluded to, CICAI may comprise, for example, a communications network, such as a multi-agent network, as one particular example, of one or more processing units executing computer-readable instructions to facilitate or support one or more Artificial Intelligence-type processes, operations, or algorithms. More specifically, in certain simulations or experiments, it has been observed that, in some instances, a CICAI applied to a particular area of computational linguistics, such as relating to, for example, interpretation (e.g., semiological, hermeneutical interpretation of a sender's capabilities), transcription, translation, transliteration, or the like may prove beneficial.

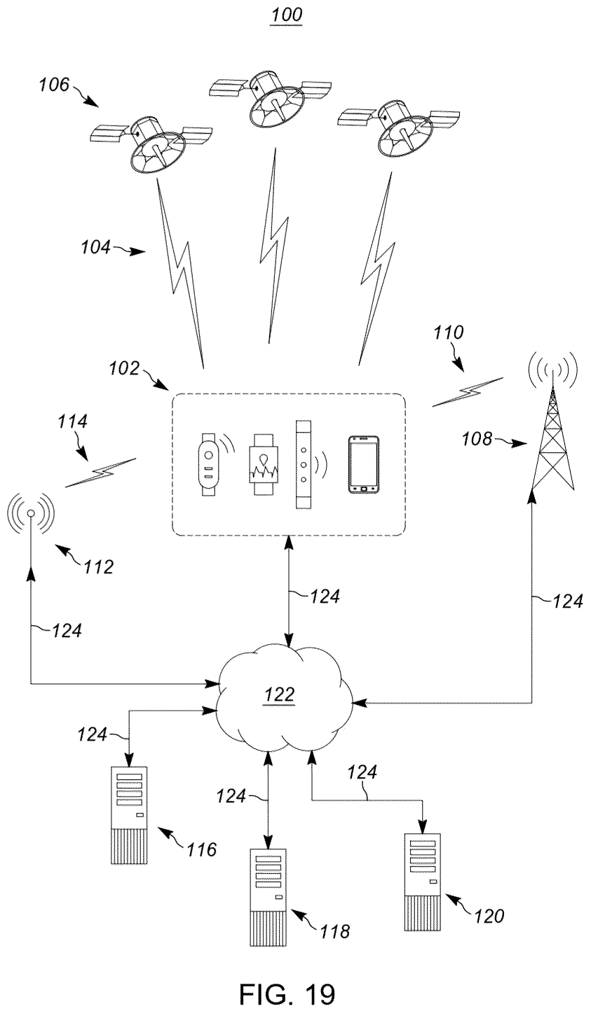

Further, embodiments described herein may involve telecommunications networks, such as digital or analog networks, for example, with one or more data processing units that may be communicatively connected or coupled to one or more computing devices or platforms so as to provide computational source-to-target language conversion services in real time or near-real time. As will be described in greater detail below in connection with FIG. 18 and FIG. 19, for example, these services may include, for example, interpretation, translation, transcription, transliteration, aspects or processes, such as implemented, at least in part, in connection with one, or a plurality of, sender(s) and one, or a plurality of, receiver(s) engaged in unilateral, bilateral, directional, or omnidirectional network-type communication, for example.

FIG. 18 depicts an example call-center use case comprising CICAI on entry point to customer premises. The illustration depicted in FIG. 18 shows self-explanatory aspects that may also be understood in light of embodiments discussed herein. For example, FIG. 18 shows an example CICAI route-switch processor (e.g., Class-4 Software Defined Networking Softswitch (equivalent) with CICAI) located between a Computer Telephony Integration (CTI)/Automatic Call Dispenser (ACD) server and an Audio Record Server. In embodiments, a CTI/ACD server may comprise an Integrated Voice Response (IVR) system.

In general, for one or more embodiments, an incoming call, for example, may enter a customer premises demarcation point via a phone line. In this context, “customer premises,” “customer premises demarcation point,” or the like refers to a point at which a customer becomes responsible for telephone wiring, equipment In one or more embodiments, within a brick and mortar building (I.e., physical building, dwelling), a customer premises demarcation point may be a location where a T1/T3 cable or the like enters an exterior wall of a brick and mortar building, for example. Also, in one or more embodiments, “customer” or the like may refer to a subscriber, purchaser, lessee, of telecommunication equipment or services, such as a subscriber, purchasers, lessees, of CICAI systems, for example. However, in addition to the context explained above, “customer” or the like in another context may refer to an individual making a phone call to a call center or the like. The examples that follow should provide sufficient detail for a reader to discern intended meaning of “customer” as the term occurs.

In one or more embodiments, once an incoming call crosses a customer premises demarcation point, a call may arrive at a PBX/media gateway or the like. In one or more embodiments, a PBX may, in accordance with specified priorities, direct an incoming call to a call center employee by way of a CTI/ACD server, for example. In one or more embodiments, a call may arrive at a call center employee's desktop computer system, for example, where it may be placed in a queue. Further, in one or more embodiments, a call center employee may select a call from a queue, and customer relationship management (CRM) content pertaining to a user may be retrieved from a cloud-CRM-type system or the like. Additionally, in one or more embodiments, an audio call record server or the like may record audio of an interaction between a user and a call center employee. It may be noted that the routing and handling of calls at a call center, for example, may involve a number of separate systems.

In one or more embodiments, such as an example embodiment depicted in FIG. 18, a PBX/media gateway system or the like may, as part of call routing functions, provide an interface between T1/T3 PSTN/POTS phone line or the like that arrives at a customer premises demarcation point and a TCP/IP-based communication within the customer premises, for example. In one or more embodiments, and as further depicted in FIG. 18, a CICAI system (e.g., Class-4 software-defined networking softswitch (equivalent) with CICAI) may be located between a CTI/ACD server and an audio record server, for example. In one or more embodiments, a CICAI route-switch processor may function, at least in part, as a Class-4 software defined networking softswitch (equivalent) or the like or may perform such operations including, but not limited to, intelligent call routing, language interpretation, language translation, language transcription or language transliteration, for example.

In one or more embodiments, a CICAI system (e.g., Class-4 software-defined networking softswitch (equivalent) with CICAI) or the like may be placed separate from a customer's Local Area Network (LAN) or Wide Area network (WAN). In one or more embodiments, a CICAI system may communicate with a PBX/media gateway, a CTI/ACD server, or an audio record server or the like using TCP/IP for example. In other embodiments, a CICAI system may be located on a customer's Local Area Network (LAN) or Wide Area network (WAN), for example.

FIG. 19 is an example message flow diagram depicting example operations that may be understood in connection with one or more embodiments, including an example embodiment depicted in FIG. 18. Embodiments in accordance with claimed subject matter may include all of messages 1901-1922, fewer than messages 1901-1922, or more than messages 1901-1922. Likewise, it should be noted that content acquired or produced, such as, for example, input signals, output signals, operations, results associated with the example message flow of FIG. 19 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features. And, of course, embodiments are not limited in scope to the specific details of the examples depicted herein, including the examples depicted as FIG. 18 or FIG. 19.

Below is a listing of descriptions for messages 1901 through 1922 pertaining to one or more embodiments. Also provided are descriptions for boxes 1951-1955. The boxes represent various example operations pertaining to one or more embodiments.
(a) Message 1901: Request call to call-center employee; (b) Box 1951: Generate unique Session Initial Protocol (SIP) Uniform Resource Identifier (URI) for customer call; (c) Message 1902: Authorize calls for Customer URI per RFC 3966; (d) Box 1952: Generate unique authorization token for session; (e) Messages 1903, 1904: Return authorization token with IP and port assignments; (f) Box 1953: Initialize low-latency protocol client (e.g., Real-Time Protocol (RTP)/Secure Real-Time Transfer Protocol (SRPT), Web Real-Time Communication (WebRTC), Joint Range Extension Application Protocol-Appendix C (JREAP C), Websockets); (g) Message 1905: Retrieve estimated wait-time in queue and insert CustomerID into queue; (h) Message 1906: Return estimated wait time to customer's device; (i) Message 1907: Inform customer of estimated wait time, then call is placed on hold; (j) Message 1908: Customer call is queued (CustomerID+QueueID+URI); (k) Box 1954: Call idles until it reaches top of queue, next available call-center employee is alerted to new call; (l) Message 1909: Transfer call to call-center employee (CustomerID+URI); (m) Message 1910: Instruct customer device to make call to call-center employee SIP URI; (n) Message 1911: Screen pop-up alerts call-center employee of call using language ID (LangID)+Customer ID+Customer URI; (o) Message 1912: Call-center employee desktop software signals call-audio-recorder to begin recording audio; (p) Message 1913: Call-center employee desktop software returns customer profile data from CRM system; (q) Message 1913b: Call-center employee desktop software signals CICAI to begin one or more interpretation, transcription, translation, or transliteration operations, or any combination thereof; (r) Message 1914: Call-center employee desktop software returns customer profile data from CRM system; (s) Message 1915: RTP; (t) Box 1955: TDM or IP PBX/SIP with media session established; (u) Message 1916: SRTP/Datagram Transport Layer Security (DTLS); (v) Message 1917: Customer poses question and call-center employee enlists AI-agent to interrogate LLM for information; (w) Message 1918: AI-agent submits LLM prompt and returns correct response and customer hangs up; (x) Message 1919: Call-center employee desktop application signals CICAI to terminate interpretation, transcription, translation, or transliteration; (y) Message 1920: Call-center employee desktop application signals Audio Recorder to stop recording and to archive; (z) Message 1921: RTP session ends, call-center employee desktop software signals Media Gateway to terminate RTP session; (aa) Message 1922: SRTP/DTLS session terminates, URI released.

In embodiments, messages 1915 or 1916 may utilize RTP or SRTP or the like to communicate UDP packets over the Internet, although subject matter is not limited in scope in these respects.

For the discussion that follows, additional examples are described. For one example, a phone call may be placed over a fiber-optic network. Of course, subject matter is not limited to the specific details of example embodiments or use cases presented herein.

In an embodiment, the moment an individual, referred to in this example as a “user,” begins to initiate a phone call (e.g., by lifting a cell phone, lifting a receiver of a telephone, selecting a particular application on a desktop computer), a user announces to user's PBX or to user's central office that user is ready to make a call. For example, user may select a phone app on a smartphone, or that action may signal to a cell tower that a call may be made. A cell tower may then allocate appropriate resources in anticipation of a call, for example. As user is using a phone, an SS7 (signaling system 7) signal is sent from user's phone to cell tower through a central office to start hookup of call, for example. Responsive to user entering a phone number, for example, a cell tower may establish a path for switching of user's call to a specified destination, for example. For this example, however, user may have just crossed a LATA (local area or transport area) into a different billing zone (e.g., user is going from one country's border to another). There may be an announcement of an extra billing associated with crossing of a LATA, for example. Also, a message may invite a user to engage particular services. For example, a system may detect that a user is from Nigeria or is calling Latvia. A system may interrupt to call set-up with an SS7 signal that says, “would you like a Latvian translator?” Similarly, an SMS message may also be utilized to signal availability of a translator, for example.

In one or more embodiments, responsive to a user indicating that the user would like to use a translator, at that moment a CAT5 switch or a Class 5 switch to which a Class 4 is connected, for example, may perform a handoff to a CICAI class 4 switch with an SS7 call handoff, for example. At this point, a CICAI class-4 switch is hosting a call, for example. At this moment, when CICAI-class 4 switch has been set up with communication from an origin point recognizing there needs to be translation, it sends an SS7 message back to Class 5 switch that says alright, let's continue with call now to this destination point, for example. At that point, when that is connected, CICIA class-4 switch may instantiate another AI-agent that makes that communication back and forth between a user (e.g., call originator) or a destination. In one or more embodiments, software entities (e.g., AI-agents) have been created to represent each user within CICAI class-4 switch or they act as proxies for humans at each end of a call, for example. In this manner, a dialogue is actually happening inside a switch, for example.

In one or more embodiments, AI-agent(s) may comprise a host application residing in a CICIA class-4 switch. In one or more other embodiments, computing devices outside of a switch may host AI-agents. In one or more embodiments, a Linux® operating system may be utilized, with Linux running in a secure session, for example. Of course, subject matter is not limited in scope in these respects. Also, for example, kernel threads may operate in a secure session, but everything else may run in user space on Linux. Again, subject matter is not limited in scope in these respects.

In one or more embodiments, a direct bus connects or an InfiniBand® interface between a Linux box or a switch may allow for a lot of rapid handoffs between a processor assembly in a Linux system or a CICAI class-4 switch. One or more embodiments may employ as many as 128 cores for per processor, for example. Also, for example, processing tasks may be allocated between an outside system (e.g., Linux-based system) or a CICAI class-4 switch.

In one or more embodiments, a Class 5 switch to which a CICAI class-4 is connected may alert a CICAI class-4 switch that a call is inbound. In one or more embodiments, an AI-agent at that point may be spawned or receives a unique UUID (universal user ID) that uniquely identifies a communication between that specific user or an AI-agent that is to represent a receiver (e.g., user at destination to whom call is intended) in a conversation or presentation, or two AI-agents (e.g., representing calling user or receiving user) are handling all logging, journaling, transcription, transliteration, all text to text transformation, and so forth. AI-agents are running in processing cores within a CICAI class-4 switch, for example. Of course, switches may vary in number of processing cores.

In one or more embodiments, an AI-agent may act as a multithreaded multiprocessor. A core having two hyper threads available, for example, may then recruit those hyper threads for two operations that may be performed in parallel, for example. On that core, one agent may share a memory space with another agent, for example. In one or more embodiments, some memory space may be shared, some may be separate, some may be private. In a shared space, AI-agents may conduct communication back and forth with greater speed than they could if they were working out of a private memory space, just sending RPC or IPC between processes, for example.

In one or more embodiments, language models (LM) or knowledge models may be utilized. On one hand there may be a domain specific LM, there may be nonetheless also a personalized language model (pLLM) for an individual, for example. So anytime a person accesses an LLM, an AI-agent may act as arbiter of its interactions with rest of infrastructure, for example. That may largely be a cyber security measure because system may need to validate a blockchain token for access to LLMs or this infrastructure every time a user comes in there may be no time to gain access to anybody else's information, for example. A system may only get access to what a blockchain says it can access, for example.

In one or more embodiments, a blockchain may comprise a lot of user profile information that we would have gathered off LinkedIn or other areas. So, a blockchain itself, a token itself, may be encrypted with a collection of metrics that can only be known to a user so that system can always interact, interrogate user to authenticate, for example.

Also, in an embodiment, another aspect of a token is that it may be set up as a hierarchical wallet, for example. So, it may comprise a hierarchical blockchain wallet that may allow a system to keep track of digital rights management for not only electronic content in the form of newsletters, newspapers, news feeds, but also in in terms of hats, shirts, for example. One objective may be to become a marketplace in response to people complaining about having a heck of a time trying to find somebody in their network to work with, to do something with, and so a back end of this kind of system may help address these challenges, for example. A CICAI switch may be a gateway to that sort of endeavor, for example.

In one or more embodiments, an example process may include setting up a call, including receiving a unique user ID to identify a specific transaction, for example. In one or more embodiments, at that point, an AI-agent takes a fraction of a token so it too can be validated. There may be a 2FA (two factor authentication) between an AI-agent or infrastructure, or there may also be a 2FA between user or AI-agent, for example. In one or more embodiments, a reason for this may be because ciphers that may be used for an infrastructure may vary depending upon which subsystems AI-agent is communicating with, for example.

In one or more embodiments, what is envisioned is to have CICAI class 4 switches scattered around the planet, or all of them may replicate to each other. Ultimately, for example, every machine will know everything about everybody, and so communication may be accomplished very simply or may be done even faster, for example.

In one or more embodiments, an AI token may be predefined or an AI-agent may take it wherein it goes—that is, every time an AI-agent is spawned, for example.

Another way of thinking about these kinds of switches may be as a tandem switch, or this tandem switch may actually comprise one of those devices that is always helping a Class 5 or a Class 3 switches perform their work. A significant factor regarding example CICAI class-4 switches is that they may allow, in a single platform, connection to either a customer facing switching network, a non-customer facing switching network (e.g., TDM network) or an IP network, depending on which configuration the customer wants, for example. Very same hardware, very same software, for example.

In one or more embodiments, a CICAI class-4 switch may be meant to be a non-stop switch. Therefore, one or more embodiments may include any number of mechanisms to perform fault resolution, to deal with a false stop, for example.

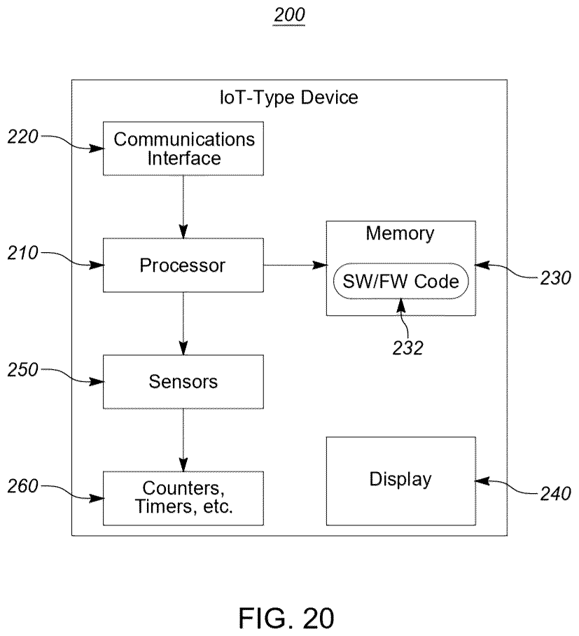

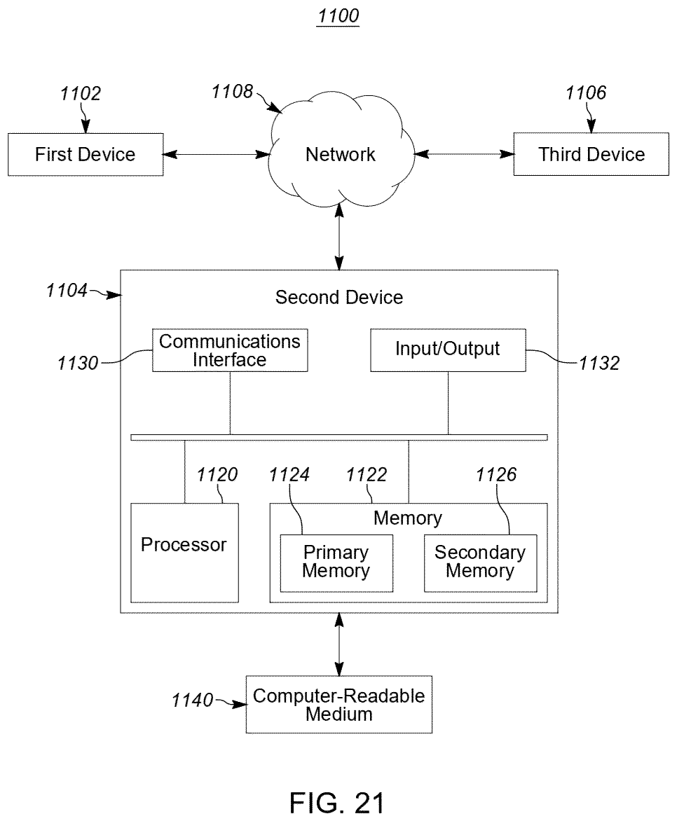

One or more embodiments described above may be implemented, in whole or in part, in various contexts, including, for example, devices, systems or infrastructure described below in connection with FIG. 20, FIG. 21 or FIG. 22. Of course, subject matter is not limited in scope to the example devices, systems or infrastructure described herein.

The World Wide Web or simply the Web, provided by the Internet, is growing rapidly, at least in part, from the large amount of content being added seemingly on a daily basis. A wide variety of content in the form of stored signals, such as, for example, text files, images, audio files, video files, web pages, measurements of physical phenomena, or the like may be continually acquired, identified, located, retrieved, collected, stored, communicated Increasingly, content is being acquired, collected, communicated by a number of electronic devices, such as, for example, embedded computing devices leveraging existing Internet infrastructure as part of a so-called “Internet of Things” (IT), such as via a variety of protocols, domains, or applications. IoT may typically comprise a system of interconnected or internetworked physical computing devices capable of being identified, such as uniquely via an assigned Internet Protocol (IP) address, for example. Devices, such as IoT-type devices, for example, may include computing resources embedded into hardware so as to facilitate or support a device's ability to acquire, collect, process or transmit content over one or more communications networks. In this context, “IoT-type devices” or the like refer to one or more electronic or computing devices capable of leveraging existing Internet infrastructure as part of the IoT, such as via a variety of applicable protocols, domains, applications In particular implementations, IoT-type devices, for example, may comprise a wide variety of embedded devices, such as, for example, automobile sensors, biochip transponders, heart monitoring implants, thermostats, kitchen appliances, locks fastening devices, solar panel arrays, home gateways, controllers, or the like. Although embodiments described herein may refer to IoT-type devices, claimed subject matter is not limited in scope in these respects. For example, although IoT-type devices may be described, claimed subject matter is intended to include use of any of a wide range of electronic device types, including a wide range of computing device types.

In some instances, challenges may be faced in improving performance of communications between or among IoT-type devices or other electronic device types, for example. An aspect of communications related to IoT-type devices or other electronic device types, for example, may involve processing of one or more queries that may be generated at IoT-type devices or other electronic device types.

“Electronic content,” “content” or the like as the terms are used herein should be interpreted broadly and refers to signals, such signal packets, for example, or states, such as physical states on a memory device, for example, but otherwise are employed in a manner irrespective of format, such as any expression, representation, realization, or communication, for example. Content may comprise, for example, any information, knowledge, or experience, such as, again, in the form of signals or states, physical or otherwise. In this context, “electronic” or “on-line” content refers to content in a form that although not necessarily capable of being perceived by a human, (e.g., via human senses) may nonetheless be transformed into a form capable of being so perceived, such as visually, haptically, or audibly, for example. Non-limiting examples may include text, audio, images, video, security parameters, combinations, or the like. Thus, content may be stored or transmitted electronically, such as before or after being perceived by human senses. In general, it may be understood that electronic content may be intended to be referenced in a particular discussion, although in the particular context, the term “content” may be employed for ease of discussion. Specific examples of content may include, for example, computer code, data, metadata, message, text, audio file, video file, data file, web page, or the like. Claimed subject matter is not intended to be limited to these particular examples, of course.

FIG. 20 is a schematic diagram illustrating features associated with an implementation of an example operating environment 100 capable of facilitating or supporting one or more operations or techniques for example implementations or embodiments described herein. As depicted, example operating environment 100 may include IoT-type devices, illustrated generally herein at 102. As was indicated, the IoT is typically a system of interconnected or internetworked physical devices in which computing may be embedded into hardware so as to facilitate or support devices' abilities to acquire, collect or communicate content over one or more communications networks, for example, at times, without human participation or interaction. As mentioned, IoT-type devices may include a wide variety of stationary or mobile devices, such as, for example, automobile sensors, biochip transponders, heart monitoring implants, kitchen appliances, locks fastening devices, solar panel arrays, home gateways, smart gauges, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, or the like.

It should be appreciated that operating environment 100 is described herein as a non-limiting example that may be implemented, in whole or in part, in a context of various wired or wireless communications networks or any suitable portion or combination of such networks. For example, these networks may include one or more public networks (e.g., the Internet, the World Wide Web), private networks (e.g., intranets), wireless wide area networks (WWAN), wireless local area networks (WLAN), wireless personal area networks (WPAN), telephone networks, cable television networks, Internet access networks, fiber-optic communication networks, waveguide communication networks or the like. It should also be noted that claimed subject matter is not limited to a particular network or operating environment. Thus, for a particular implementation, one or more operations or techniques for updating or managing IoT-type devices may be performed, at least in part, in an indoor environment or an outdoor environment, or any combination thereof.

Thus, as illustrated, in a particular implementation, one or more IoT-type devices 102 may, for example, receive or acquire satellite positioning system (SPS) signals 104 from SPS satellites 106. In some instances, SPS satellites 106 may be from a single global navigation satellite system (GNSS), such as the GPS or Galileo satellite systems, for example. In other instances, SPS satellites 106 may be from multiple GNSS such as, but not limited to, GPS, Galileo, Glonass, or Beidou (Compass) satellite systems, for example. In certain implementations, SPS satellites 1006 may be from any one several regional navigation satellite systems (RNSS) such as, for example, WAAS, EGNOS, QZSS, just to name a few examples.

At times, one or more IoT-type devices 102 may, for example, transmit wireless signals to or receive wireless signals from a suitable wireless communication network. In one example, one or more IoT-type devices 102 may communicate with a cellular communication network, such as by transmitting wireless signals to or receiving wireless signals from one or more wireless transmitters capable of transmitting or receiving wireless signals, such as a base station transceiver 108 over a wireless communication link 110, for example. Similarly, one or more IoT-type devices 102 may transmit wireless signals to or receive wireless signals from a local transceiver 112 over a wireless communication link 114, for example. Base station transceiver 108, local transceiver 112 may be of the same or similar type, for example, or may represent different types of devices, such as access points, radio beacons, cellular base stations, femtocells, an access transceiver device, depending on an implementation. Similarly, local transceiver 112 may comprise, for example, a wireless transmitter or receiver capable of transmitting or receiving wireless signals. For example, at times, wireless transceiver 112 may be capable of transmitting or receiving wireless signals from one or more other terrestrial transmitters or receivers.

In a particular implementation, local transceiver 112 may, for example, be capable of communicating with one or more IoT-type devices 102 at a shorter range over wireless communication link 114 than at a range established via base station transceiver 108 over wireless communication link 110. For example, local transceiver 112 may be positioned in an indoor environment or may provide access to a wireless local area network (WLAN, e.g., IEEE Std. 802.11 network) or wireless personal area network (WPAN, e.g., Bluetooth® network). In another example implementation, local transceiver 112 may comprise a femtocell or picocell capable of facilitating communication via link 114 according to an applicable cellular wireless communication protocol. Again, it should be understood that these are merely examples of networks that may communicate with one or more IoT-type devices 102 over a wireless link, and claimed subject matter is not limited in this respect. For example, in some instances, operating environment 100 may include a larger number of base station transceivers 108, local transceivers 112, networks, terrestrial transmitters or receivers.

In an implementation, one or more IoT-type devices 102, base station transceiver 108, local transceiver 112 may, for example, communicate with one or more servers, referenced herein at 116, 118, and 120, over a network 122, such as via one or more communication links 124. Network 122 may comprise, for example, any combination of wired or wireless communication links. In a particular implementation, network 122 may comprise, for example, Internet Protocol (IP)-type infrastructure capable of facilitating or supporting communication between one or more IoT-type devices 102 and one or more servers 116, 118, 120 via local transceiver 112, base station transceiver 108, directly In another implementation, network 122 may comprise, for example cellular communication network infrastructure, such as a base station controller or master switching center to facilitate or support mobile cellular communication with one or more IoT-type devices 102. Servers 116, 118 or 120 may comprise any suitable servers or combination thereof capable of facilitating or supporting one or more operations or techniques discussed herein. For example, servers 116, 118 or 120 may comprise one or more update servers, back-end servers, management servers, archive servers, location servers, positioning assistance servers, navigation servers, map servers, crowdsourcing servers, network-related servers, or the like.

Even though a certain number of computing platforms or devices are illustrated herein, any number of suitable computing platforms or devices may be implemented to facilitate or support one or more techniques or processes associated with operating environment 100. For example, at times, network 122 may be coupled to one or more wired or wireless communication networks (e.g., WLAN) so as to enhance a coverage area for communications with one or more IoT-type devices 102, one or more base station transceivers 108, local transceiver 112, servers 116, 118, 120, or the like. In some instances, network 122 may facilitate or support femtocell-based operative regions of coverage, for example. Again, these are merely example implementations, and claimed subject matter is not limited in this regard.

In this context, “IoT-type devices” refer to one or more electronic or computing devices capable of leveraging existing Internet infrastructure as part of the so-called “Internet of Things” or IoT, such as via a variety of applicable protocols, domains, applications As was indicated, the IT is typically a system of interconnected or internetworked physical devices in which computing may be embedded into hardware so as to facilitate or support devices' ability to acquire, collect, or communicate content over one or more communications networks, for example, at times, without human participation or interaction. IoT-type devices 102, for example, may include a wide variety of stationary or mobile devices, such as, for example, automobile sensors, biochip transponders, heart monitoring implants, kitchen appliances, locks fastening devices, solar panel arrays, home gateways, smart gauges, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, to name a few non-limiting examples. Typically, in this context, a “mobile device” refers to an electronic or computing device that may from time to time have a position or location that changes, or a stationary device refers to a device that may have a position or location that generally does not change. In some instances, IoT-type devices, such as IoT-type devices 102, may be capable of being identified, such as uniquely, via an assigned Internet Protocol (IP) address, as one particular example, or having an ability to communicate, such as receive or transmit electronic content, for example, over one or more wired or wireless communications networks.

FIG. 21 is an illustration of an embodiment 200 of an example particular IoT device. Of course, claimed subject matter is not limited in scope to the particular configurations or arrangements of components depicted or described for example devices mentioned herein. In an embodiment, an IoT-type device, such as 200, may comprise one or more processors, such as processor 210, or may comprise one or more communications interfaces, such as communications interface 220. In an embodiment, one or more communications interfaces, such as communications interface 220, may enable wireless communications between an electronic device, such as an IoT-type device 200, and one or more other computing devices. In an embodiment, wireless communications may occur substantially in accordance any of a wide range of communication protocols, such as those mentioned herein, for example.

In a particular implementation, an IoT-type device, such as IoT-type device 200, may include a memory, such as memory 230. In a particular implementation, memory 230 may comprise a non-volatile memory, for example. Further, in a particular implementation, a memory, such as memory 230, may have stored therein executable instructions, such as for one or more operating systems, communications protocols, or applications, for example. A memory, such as 230, may further store particular instructions, such as software or firmware code 232, that may be updated via one or more example implementations or embodiments described herein. Further, in a particular implementation, an IoT-type device, such as IoT-type device 200, may comprise a display, such as display 240, or one or more sensors, such as one or more sensors 250. As utilized herein, “sensors” or the like refer to a device or component that may respond to physical stimulus, such as, for example, heat, light, sound pressure, magnetism, particular motions, or that may generate one or more signals or states in response to physical stimulus. Example sensors may include, but are not limited to, one or more accelerometers, gyroscopes, thermometers, magnetometers, barometers, light sensors, proximity sensors, hear-rate monitors, perspiration sensors, hydration sensors, breath sensors, cameras, microphones, or any combination thereof.

In particular implementations, IoT-type device 200 may include one or more timers or counters circuits, such as circuitry 260, for example. In an embodiment, one or more timers or counters or the like may track one or more aspects of device performance or operation. For example, timers, counters, or other like circuits may be utilized, at least in part, by IoT-type device 200 to determine measures of fitness, for example, or to otherwise generate feedback content related to testing results, in particular implementations.

Although FIG. 21 depicts a particular example implementation of an IoT-type device, such as IoT-type device 200, other embodiments may include other types of electronic or computing devices. Example types of electronic or computing devices may include, for example, any of a wide range of digital electronic devices, including, but not limited to, desktop or notebook computers, high-definition televisions, digital video players or recorders, game consoles, satellite television receivers, cellular telephones, tablet devices, wearable devices, personal digital assistants, mobile audio or video playback or recording devices, or any combination of the foregoing.

Unless the context indicates otherwise, the singular forms ‘a,’ ‘an,’ and ‘the’ include plural referents. The terms ‘comprise,’ ‘comprises,’ ‘including,’ and ‘includes’ are open-ended and allow the presence of additional elements or steps. Embodiments and examples are provided for illustration, not limitation The term “connection,” the term “component” or similar terms are intended to be physical, but are not necessarily always tangible. Whether or not these terms refer to tangible subject matter, thus, may vary in a particular context of usage. As an example, a tangible connection or tangible connection path may be made, such as by a tangible, electrical connection, such as an electrically conductive path comprising metal or other conductor, that is able to conduct electrical current between two tangible components. Likewise, a tangible connection path may be at least partially affected or controlled, such that, as is typical, a tangible connection path may be open or closed, at times resulting from influence of one or more externally derived signals, such as external currents or voltages, such as for an electrical switch. Non-limiting illustrations of an electrical switch include a transistor, a diode However, a “connection” or “component,” in a particular context of usage, likewise, although physical, may also be non-tangible, such as a connection between a client and a server over a network, particularly a wireless network, which generally refers to the ability for the client and server to transmit, receive, or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components or the like are not necessarily tangibly in direct physical contact, but are able to co-operate, liaise, or interact, such as, for example, by being “optically coupled.” Likewise, the term “coupled” is also understood to mean indirectly connected. It is further noted, in the context of the present patent application, since memory, such as a memory component or memory states, is intended to be non-transitory, the term physical, at least if used in relation to memory necessarily implies that such memory components or memory states, continuing with the example, are tangible.

Additionally, in the present patent application, in a particular context of usage, such as a situation in which tangible components (or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”.

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “or” may be used in an abundance of caution to make clear that all of the foregoing meanings are intended, although such usage is not required. In addition, the term “one or more” or similar terms is used to describe any feature, structure, characteristic, or the like in the singular, “or” is also used to describe a plurality or some other combination of features, structures, characteristics, or the like. Likewise, the term “based on” or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, or specification regarding degree, that the particular situation be understood in the following manner. As an example, in a given situation, assume a value of a physical property is to be measured. If alternatively, reasonable approaches to testing, measurement, or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, it is believed that claimed subject matter does not fall within the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modelled deterministically or stochastically. Employing a model permits collected measurements to potentially be identified or processed, or potentially permits estimation or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes or realized results, such as with respect to use of historical measurements, for example. Heuristics, for example, may be employed in situations where more analytical approaches may be overly complex or nearly intractable. Thus, regarding claimed subject matter, an innovative feature may include, in an example embodiment, heuristics that may be employed, for example, to estimate or predict one or more measurements.

It is further noted that the terms “type” or “like,” if used, such as with a feature, structure, characteristic, using “optical” or “electrical” as simple examples, means at least partially of or relating to the feature, structure, characteristic, or the like in such a way that presence of minor variations, even variations that might otherwise not be considered fully consistent with the feature, structure, characteristic, do not in general prevent the feature, structure, characteristic, or the like from being of a “type” or being “like,” (such as being an “optical-type” or being “optical-like,” for example) if the minor variations are sufficiently minor so that the feature, structure, characteristic, or the like would still be considered to be substantially present with such variations also present. Thus, continuing with this example, the terms optical-type or optical-like properties are necessarily intended to include optical properties. Likewise, the terms electrical-type or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description or usage provides helpful guidance regarding reasonable inferences to be drawn.

With advances in technology, it has become more typical to employ distributed computing or communication approaches in which portions of a process, such as signal processing of signal samples, for example, may be allocated among various devices, including one or more client devices or one or more server devices, via a computing or communications network, for example. A network may comprise two or more devices, such as network devices or computing devices, or may couple devices, such as network devices or computing devices, so that signal communications, such as in the form of signal packets or signal frames (e.g., comprising one or more signal samples), for example, may be exchanged, such as between a server device or a client device, as well as other types of devices, including between wired or wireless devices coupled via a wired or wireless network, for example.

An example of a distributed computing system comprises the so-called Hadoop distributed computing system, which employs a map-reduce type of architecture. In the context of the present patent application, the terms map-reduce architecture or similar terms are intended to refer to a distributed computing system implementation or embodiment for processing or for generating larger sets of signal samples employing map or reduce operations for a parallel, distributed process performed over a network of devices. A map operation or similar terms refer to processing of signals (e.g., signal samples) to generate one or more key-value pairs and to distribute the one or more pairs to one or more devices of the system (e.g., network). A reduce operation or similar terms refer to processing of signals (e.g., signal samples) via a summary operation (e.g., such as counting the number of students in a queue, yielding name frequencies). A system may employ such an architecture, such as by marshaling distributed server devices, executing various tasks in parallel, or managing communications, such as signal transfers, between various parts of the system (e.g., network), in an embodiment. As mentioned, one non-limiting, but well-known, example comprises the Hadoop distributed computing system. It refers to an open source implementation or embodiment of a map-reduce type architecture (available from the Apache Software Foundation, 1901 Munsey Drive, Forrest Hill, MD, 21050-2747), but may include other aspects, such as the Hadoop distributed file system (HDFS) (available from the Apache Software Foundation, 1901 Munsey Drive, Forrest Hill, MD, 21050-2747). In general, therefore, “Hadoop” or similar terms (e.g., “Hadoop-type”) refer to an implementation or embodiment of a scheduler for executing larger processing jobs using a map-reduce architecture over a distributed system. Furthermore, in the context of the present patent application, use of the term “Hadoop” is intended to include versions, presently known or to be later developed.

In the context of the present patent application, the term network device refers to any device capable of communicating via or as part of a network and may comprise a computing device. While network devices may be capable of communicating signals (e.g., signal packets or frames), such as via a wired or wireless network, they may also be capable of performing operations associated with a computing device, such as arithmetic or logic operations, processing or storing operations (e.g., storing signal samples), such as in memory as tangible, physical memory states, or may, for example, operate as a server device or a client device in various embodiments. Network devices capable of operating as a server device, a client device or otherwise, may include, as examples, dedicated rack-mounted servers, desktop computers, laptop computers, set top boxes, tablets, netbooks, smart phones, wearable devices, integrated devices combining two or more features of the foregoing devices, or any combination thereof. As mentioned, signal packets or frames, for example, may be exchanged, such as between a server device or a client device, as well as other types of devices, including between wired or wireless devices coupled via a wired or wireless network, for example, or any combination thereof. It is noted that the terms, server, server device, server computing device, server computing platform or similar terms are used interchangeably. Similarly, the terms client, client device, client computing device, client computing platform or similar terms are also used interchangeably. While in some instances, for ease of description, these terms may be used in the singular, such as by referring to a “client device” or a “server device,” the description is intended to encompass one or more client devices or one or more server devices, as appropriate. Along similar lines, references to a “database” are understood to mean, one or more databases or portions thereof, as appropriate.

It should be understood that for ease of description, a network device (also referred to as a networking device) may be embodied or described in terms of a computing device and vice-versa. However, it should further be understood that this description should in no way be construed so that claimed subject matter is limited to one embodiment, such as only a computing device or only a network device, but, instead, may be embodied as a variety of devices or combinations thereof, including, for example, one or more illustrative examples.

A network may also include now known, or to be later developed arrangements, derivatives, or improvements, including, for example, past, present or future mass storage, such as network attached storage (NAS), a storage area network (SAN), or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope or extent. Likewise, sub-networks, such as may employ differing architectures or may be substantially compliant or substantially compatible with differing protocols, such as network computing or communications protocols (e.g., network protocols), may interoperate within a larger network.

In the context of the present patent application, the term sub-network or similar terms, if used, for example, with respect to a network, refers to the network or a part thereof. Sub-networks may also comprise links, such as physical links, connecting or coupling nodes, so as to be capable to communicate signal packets or frames between devices of particular nodes, including via wired links, wireless links, or combinations thereof. Various types of devices, such as network devices or computing devices, may be made available so that device interoperability is enabled or, in at least some instances, may be transparent. In the context of the present patent application, the term “transparent,” if used with respect to devices of a network, refers to devices communicating via the network in which the devices are able to communicate via one or more intermediate devices, such as one or more intermediate nodes, but without the communicating devices necessarily specifying the one or more intermediate nodes or the one or more intermediate devices of the one or more intermediate nodes or, thus, may include within the network the devices communicating via the one or more intermediate nodes or the one or more intermediate devices of the one or more intermediate nodes, but may engage in signal communications as if such intermediate nodes or intermediate devices are not necessarily involved. For example, a router may provide a link or connection between otherwise separate or independent LANs.

In the context of the present patent application, a “private network” refers to a particular, limited set of devices, such as network devices or computing devices, able to communicate with other devices, such as network devices or computing devices, in the particular, limited set, such as via signal packet or signal frame communications, for example, without a need for re-routing or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet or frame communications (e.g. signal communications) may employ intermediate devices of intermediate nodes to exchange signal packets or signal frames, those intermediate devices may not necessarily be included in the private network by not being a source or designated destination for one or more signal packets or signal frames, for example. It is understood in the context of the present patent application that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, or similar terms are intended to refer to any version, now known or to be later developed. The Internet includes local area networks (LANs), wide area networks (WANs), wireless networks, or long-haul public networks that, for example, may allow signal packets or frames to be communicated between LANs. The term World Wide Web (WWW or Web) or similar terms may also be used, although it refers to a part of the Internet that complies with the Hypertext Transfer Protocol (HTTP). For example, network devices may engage in an HTTP session through an exchange of appropriately substantially compatible or substantially compliant signal packets or frames. It is noted that there are several versions of the Hypertext Transfer Protocol. The term Hypertext Transfer Protocol, HTTP, or similar terms are intended to refer to any version, now known or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet or to the Web; nonetheless, the Internet or the Web may without limitation provide a useful example of an embodiment at least for purposes of illustration. As indicated, the Internet or the Web may comprise a worldwide system of interoperable networks, including interoperable devices within those networks. The Internet or Web has evolved to a public, self-sustaining facility accessible to potentially billions of people or more worldwide. Also, in an embodiment, and as mentioned above, the terms “WWW” or “Web” refer to a part of the Internet that complies with the Hypertext Transfer Protocol. The Internet or the Web, therefore, in the context of the present patent application, may comprise a service that organizes stored digital content, such as, for example, text, images, video, through the use of hypermedia, for example. It is noted that a network, such as the Internet or Web, may be employed to store electronic files or electronic documents.

The term electronic file or the term electronic document are used throughout this document to refer to a set of stored memory states or a set of physical signals associated in a manner so as to thereby at least logically form a file (e.g., electronic) or an electronic document. That is, it is not meant to implicitly reference a particular syntax, format or approach used, for example, with respect to a set of associated memory states or a set of associated physical signals. If a particular type of file storage format or syntax, for example, is intended, it is referenced expressly. It is further noted an association of memory states, for example, may be in a logical sense and not necessarily in a tangible, physical sense. Thus, although signal or state components of a file or an electronic document, for example, are to be associated logically, storage thereof, for example, may reside in one or more different places in a tangible, physical memory, in an embodiment.

A Hyper Text Markup Language (“HTML”), for example, may be utilized to specify digital content or to specify a format thereof, such as in the form of an electronic file or an electronic document, such as a Web page, Web site, for example. An Extensible Markup Language (“XML”) may also be utilized to specify digital content or to specify a format thereof, such as in the form of an electronic file or an electronic document, such as a Web page, Web site, in an embodiment. Of course, HTML or XML are merely examples of “markup” languages, provided as non-limiting illustrations. Furthermore, HTML or XML are intended to refer to any version, now known or to be later developed, of these languages. Likewise, claimed subject matter are not intended to be limited to examples provided as illustrations, of course.

In the context of the present patent application, the term “Web site” or similar terms refer to Web pages that are associated electronically to form a particular collection thereof. Also, in the context of the present patent application, “Web page” or similar terms refer to an electronic file or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document or an electronic file in an appropriate format, such as for use in a particular application, for example. Use of the term “JavaScript” or similar terms intended to refer to one or more particular programming languages are intended to refer to any version of the one or more programming languages identified, now known or to be later developed. Thus, JavaScript is merely an example programming language. As was mentioned, claimed subject matter is not intended to be limited to examples or illustrations.

In the context of the present patent application, the terms “entry,” “electronic entry,” “document,” “electronic document,” “content,”, “digital content,” “item,” or similar terms are meant to refer to signals or states in a physical format, such as a digital signal or digital state format, e.g., that may be perceived by a user if displayed, played, tactilely generated or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations or seeing images, as examples) is referred to, with respect to the user, as “consuming” digital content, “consumption” of digital content, “consumable” digital content or similar terms. For one or more embodiments, an electronic document or an electronic file may comprise a Web page of code (e.g., computer instructions) in a markup language executed or to be executed by a computing or networking device, for example. In another embodiment, an electronic document or electronic file may comprise a portion or a region of a Web page. However, claimed subject matter is not intended to be limited in these respects.

Also, for one or more embodiments, an electronic document or electronic file may comprise a number of components. As previously indicated, in the context of the present patent application, a component is physical, but is not necessarily tangible. As an example, components with reference to an electronic document or electronic file, in one or more embodiments, may comprise text, for example, in the form of physical signals or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document or electronic file may comprise a graphical object, such as, for example, an image, such as a digital image, or sub-objects, including attributes thereof, which, again, comprise physical signals or physical states (e.g., capable of being tangibly displayed). In an embodiment, digital content may comprise, for example, text, images, audio, video, or other types of electronic documents or electronic files, including portions thereof, for example.

Also, in the context of the present patent application, the term parameters (e.g., one or more parameters) refer to material descriptive of a collection of signal samples, such as one or more electronic documents or electronic files, and exist in the form of physical signals or physical states, such as memory states. For example, one or more parameters, such as referring to an electronic document or an electronic file comprising an image, may include, as examples, time of day at which an image was captured, latitude and longitude of an image capture device, such as a camera, for example In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals or states, which may include, as parameter examples, collection name (e.g., electronic file or electronic document identifier name), technique of creation, purpose of creation, time and date of creation, logical path if stored, coding formats (e.g., type of computer instructions, such as a markup language) or standards or specifications used so as to be protocol compliant (e.g., meaning substantially compliant or substantially compatible) for one or more uses, and so forth.

Signal packet communications or signal frame communications, also referred to as signal packet transmissions or signal frame transmissions (or merely “signal packets” or “signal frames”), may be communicated between nodes of a network, where a node may comprise one or more network devices or one or more computing devices, for example. As an illustrative example, but without limitation, a node may comprise one or more sites employing a local network address, such as in a local network address space. Likewise, a device, such as a network device or a computing device, may be associated with that node. It is also noted that in the context of this patent application, the term “transmission” is intended as another term for a type of signal communication that may occur in any one of a variety of situations. Thus, it is not intended to imply a particular directionality of communication or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, or regarding which end of a communication path may be initiating communication, such as, for example, in a “push type” of signal transfer or in a “pull type” of signal transfer. In the context of the present patent application, push or pull type signal transfers are distinguished by which end of a communications path initiates signal transfer.

Thus, a signal packet or frame may, as an example, be communicated via a communication channel or a communication path, such as comprising a portion of the Internet or the Web, from a site via an access node coupled to the Internet or vice-versa. Likewise, a signal packet or frame may be forwarded via network nodes to a target site coupled to a local network, for example. A signal packet or frame communicated via the Internet or the Web, for example, may be routed via a path, such as either being “pushed” or “pulled,” comprising one or more gateways, servers that may, for example, route a signal packet or frame, such as, for example, substantially in accordance with a target or destination address and availability of a network path of network nodes to the target or destination address. Although the Internet or the Web comprise a network of interoperable networks, not all of those interoperable networks are necessarily available or accessible to the public.

In the context of the particular patent application, a network protocol, such as for communicating between devices of a network, may be characterized, at least in part, substantially in accordance with a layered description, such as the so-called Open Systems Interconnection (OSI) seven-layer type of approach or description. A network computing or communications protocol (also referred to as a network protocol) refers to a set of signaling conventions, such as for communication transmissions, for example, as may take place between or among devices in a network. In the context of the present patent application, the term “between” or similar terms are understood to include “among” if appropriate for the particular usage and vice-versa. Likewise, in the context of the present patent application, the terms “compatible with,” “comply with” or similar terms are understood to respectively include substantial compatibility or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits or bytes) are communicated as one or more signals (or signal samples) via a physical medium (e.g., twisted pair copper wire, coaxial cable, fiber optic cable, wireless air interface, combinations thereof). Progressing to higher-level layers in a network protocol stack, additional operations or features may be available via engaging in communications that are substantially compatible or substantially compliant with a particular network protocol at these higher-level layers. For example, higher-level layers of a network protocol may, for example, affect device permissions, user permissions.

A network or sub-network, in an embodiment, may communicate via signal packets or signal frames, such as via participating digital devices and may be substantially compliant or substantially compatible with, but is not limited to, now known or to be developed, versions of any of the following network protocol stacks: ARCNET, AppleTalk, ATM, Bluetooth, DEC net, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, or X.25. A network or sub-network may employ, for example, a version, now known or later to be developed, of the following: TCP/IP, UDP, DECnet, NetBEUI, IPX, AppleTalk or the like. Versions of the Internet Protocol (IP) may include IPv4, IPv6, or other later to be developed versions.

Regarding aspects related to a network, including a communications or computing network, a wireless network may couple devices, including client devices, with the network. A wireless network may employ stand-alone, ad-hoc networks, mesh networks, Wireless LAN (WLAN) networks, cellular networks, or the like. A wireless network may further include a system of terminals, gateways, routers, or the like coupled by wireless radio links, which may move freely, randomly or organize themselves arbitrarily, such that network topology may change, at times even rapidly. A wireless network may further employ a plurality of network access technologies, including a version of Long-Term Evolution (LTE), WLAN, Wireless Router (WR) mesh, 2nd, 3rd, or 4th generation (2G, 3G, 4G, or 5G) cellular technology, whether currently known or to be later developed. Network access technologies may enable wide area coverage for devices, such as computing devices or network devices, with varying degrees of mobility, for example.

A network may enable radio frequency or other wireless type communications via a wireless network access technology or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), 802.11b/g/n, or the like. A wireless network may include virtually any type of now known or to be developed wireless communication mechanism or wireless communications protocol by which signals may be communicated between devices, between networks, within a network, including the foregoing, of course.

In one example embodiment, as shown in FIG. 22, a system embodiment may comprise a local network (e.g., device 1104 and medium 1140) or another type of network, such as a computing or communications network. For purposes of illustration, therefore, FIG. 22 shows an embodiment 1100 of a system that may be employed to implement either type or both types of networks. Network 1108 may comprise one or more network connections, links, processes, services, applications, or resources to facilitate or support communications, such as an exchange of communication signals, for example, between a computing device, such as 1102, and another computing device, such as 1106, which may, for example, comprise one or more client computing devices or one or more server computing device. By way of example, but not limitation, network 1108 may comprise wireless or wired communication links, telephone or telecommunications systems, Wi-Fi networks, Wi-MAX networks, the Internet, a local area network (LAN), a wide area network (WAN), or any combinations thereof.

Example devices in FIG. 22 may comprise features, for example, of a client computing device or a server computing device, in an embodiment. It is further noted that the term computing device, in general, whether employed as a client or as a server, or otherwise, refers at least to a processor and a memory connected by a communication bus. Likewise, in the context of the present patent application at least, this is understood to refer to sufficient structure within the meaning of 35 USC § 112 (f) so that it is specifically intended that 35 USC § 112 (f) not be implicated by use of the term “computing device” or similar terms; however, if it is determined, for some reason not immediately apparent, that the foregoing understanding may not stand and that 35 USC § 112 (f), therefore, necessarily is implicated by the use of the term “computing device” or similar terms, then, it is intended, pursuant to that statutory section, that corresponding structure, material or acts for performing one or more functions be understood and be interpreted to be described at least in FIGS. 1-21 and in the text associated at least with the foregoing figure(s) of the present patent application.

Referring now to FIG. 22, in an embodiment, first and third devices 1102 and 1106 may be capable of rendering a graphical user interface (GUI) for a network device or a computing device, for example, so that a user-operator may engage in system use. Device 1104 may potentially serve a similar function in this illustration. Likewise, in FIG. 22, computing device 1102 (‘first device’ in figure) may interface with computing device 1104 (‘second device’ in figure), which may, for example, also comprise features of a client computing device or a server computing device, in an embodiment. Processor (e.g., processing device) 1120 and memory 1122, which may comprise primary memory 1124 and secondary memory 1126, may communicate by way of a communication bus 1115, for example. The term “computing device,” in the context of the present patent application, refers to a system or a device, such as a computing apparatus, that includes a capability to process (e.g., perform computations) or store digital content, such as electronic files, electronic documents, measurements, text, images, video, audio, sensor content in the form of signals or states. Thus, a computing device, in the context of the present patent application, may comprise hardware, software, firmware, or any combination thereof (other than software per se). Computing device 1104, as depicted in FIG. 22, is merely one example, and claimed subject matter is not limited in scope to this particular example.

For one or more embodiments, a device, such as a computing device or networking device, may comprise, for example, any of a wide range of digital electronic devices, including, but not limited to, desktop or notebook computers, high-definition televisions, digital versatile disc (DVD) or other optical disc players or recorders, game consoles, satellite television receivers, cellular telephones, tablet devices, wearable devices, personal digital assistants, mobile audio or video playback or recording devices, Internet of Things (IoT) type devices, endpoint or sensor nodes, gateway devices, or any combination of the foregoing. Further, unless specifically stated otherwise, a process as described, such as with reference to flow diagrams or otherwise, may also be executed or affected, in whole or in part, by a computing device or a network device. A device, such as a computing device or network device, may vary in terms of capabilities or features. Claimed subject matter is intended to cover a wide range of potential variations. For example, a device may include a numeric keypad or other display of limited functionality, such as a monochrome liquid crystal display (LCD) for displaying text, for example. In contrast, however, as another example, a web-enabled device may include a physical or a virtual keyboard, mass storage, one or more accelerometers, one or more gyroscopes, global positioning system (GPS) or other location-identifying type capability, or a display with a higher degree of functionality, such as a touch-sensitive color 2D or 3D display, for example.

As suggested previously, communications between a computing device or a network device and a wireless network may be in accordance with known or to be developed network protocols including, for example, global system for mobile communications (GSM), enhanced data rate for GSM evolution (EDGE), 802.11b/g/n/h, or worldwide interoperability for microwave access (WiMAX). A computing device or a networking device may also have a subscriber identity module (SIM) card, which, for example, may comprise a detachable or embedded smart card that is able to store subscription content of a user, or is also able to store a contact list. It is noted, however, that a SIM card may also be electronic, meaning that is may simply be stored in a particular location in memory of the computing or networking device. A user may own the computing device or network device or may otherwise be a user, such as a primary user, for example. A device may be assigned an address by a wireless network operator, a wired network operator, or an Internet Service Provider (ISP). For example, an address may comprise a domestic or international telephone number, an Internet Protocol (IP) address, or one or more other identifiers. In other embodiments, a computing or communications network may be embodied as a wired network, wireless network, or any combinations thereof.

A computing or network device may include or may execute a variety of now known or to be developed operating systems, derivatives or versions thereof, including computer operating systems, such as Windows, iOS, Linux, a mobile operating system, such as iOS, Android, Windows Mobile, or the like. A computing device or network device may include or may execute a variety of possible applications, such as a client software application enabling communication with other devices. For example, one or more messages (e.g., content) may be communicated, such as via one or more protocols, now known or later to be developed, suitable for communication of email, short message service (SMS), or multimedia message service (MMS), including via a network, such as a social network, formed at least in part by a portion of a computing or communications network, including, but not limited to, Facebook, LinkedIn, Twitter, or Flickr, to provide only a few examples. A computing or network device may also include executable computer instructions to process or communicate digital content, such as, for example, textual content, digital multimedia content, sensor content, or the like. A computing or network device may also include executable computer instructions to perform a variety of possible tasks, such as browsing, searching, playing various forms of digital content, including locally stored or streamed video, or games such as, but not limited to, fantasy sports leagues. The foregoing is provided merely to illustrate that claimed subject matter is intended to include a wide range of possible features or capabilities.

In FIG. 22, computing device 1102 may provide one or more sources of executable computer instructions in the form physical states or signals (e.g., stored in memory states), for example. Computing device 1102 may communicate with computing device 1104 by way of a network connection, such as via network 1108, for example. As previously mentioned, a connection, while physical, may not necessarily be tangible. Although computing device 1104 of FIG. 22 shows various tangible, physical components, claimed subject matter is not limited to a computing device having only these tangible components as other implementations or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 1122 may comprise any non-transitory storage mechanism. Memory 1122 may comprise, for example, primary memory 1124 and secondary memory 1126, additional memory circuits, mechanisms, or combinations thereof may be used. Memory 1122 may comprise, for example, random access memory, read only memory, such as in the form of one or more storage devices or systems, such as, for example, a disk drive including an optical disc drive, a tape drive, a solid-state memory drive, just to name a few examples.

Memory 1122 may be utilized to store a program of executable computer instructions. For example, processor 1120 may fetch executable instructions from memory and proceed to execute the fetched instructions. Memory 1122 may also comprise a memory controller for accessing device readable-medium 1140 that may carry or make accessible digital content, which may include code, or instructions, for example, executable by processor 1120 or some other device, such as a controller, as one example, capable of executing computer instructions, for example. Under direction of processor 1120, a non-transitory memory, such as memory cells storing physical states (e.g., memory states), comprising, for example, a program of executable computer instructions, may be executed by processor 1120 and able to generate signals to be communicated via a network, for example, as previously described. Generated signals may also be stored in memory, also previously suggested.

Memory 1122 may store electronic files or electronic documents, such as relating to one or more users, and may also comprise a computer-readable medium that may carry or make accessible content, including code or instructions, for example, executable by processor 1120 or some other device, such as a controller, as one example, capable of executing computer instructions, for example. As previously mentioned, the term electronic file or the term electronic document are used throughout this document to refer to a set of stored memory states or a set of physical signals associated in a manner so as to thereby form an electronic file or an electronic document. That is, it is not meant to implicitly reference a particular syntax, format or approach used, for example, with respect to a set of associated memory states or a set of associated physical signals. It is further noted an association of memory states, for example, may be in a logical sense and not necessarily in a tangible, physical sense. Thus, although signal or state components of an electronic file or electronic document, are to be associated logically, storage thereof, for example, may reside in one or more different places in a tangible, physical memory, in an embodiment.

Algorithmic descriptions or symbolic representations are examples of techniques used by those of ordinary skill in the signal processing or related arts to convey the substance of their work to others skilled in the art. An algorithm is, in the context of the present patent application, and generally, is considered to be a self-consistent sequence of operations or similar signal processing leading to a desired result. In the context of the present patent application, operations or processing involve physical manipulation of physical quantities. Typically, although not necessarily, such quantities may take the form of electrical or magnetic signals or states capable of being stored, transferred, combined, compared, processed or otherwise manipulated, for example, as electronic signals or states making up components of various forms of digital content, such as signal measurements, text, images, video, audio.

It has proven convenient at times, principally for reasons of common usage, to refer to such physical signals or physical states as bits, values, elements, parameters, symbols, characters, terms, numbers, numerals, measurements, content or the like. It should be understood, however, that all of these or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, or the like may refer to actions or processes of a specific apparatus, such as a special purpose computer or a similar special purpose computing or network device. In the context of this specification, therefore, a special purpose computer or a similar special purpose computing or network device is capable of processing, manipulating or transforming signals or states, typically in the form of physical electronic or magnetic quantities, within memories, registers, or other storage devices, processing devices, or display devices of the special purpose computer or similar special purpose computing or network device. In the context of this particular patent application, as mentioned, the term “specific apparatus” therefore includes a general-purpose computing or network device, such as a general-purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 22, processor 1120 may comprise one or more circuits, such as digital circuits, to perform at least a portion of a computing procedure or process. By way of example, but not limitation, processor 1120 may comprise one or more processors, such as controllers, microprocessors, microcontrollers, application specific integrated circuits, digital signal processors, programmable logic devices, field programmable gate arrays, the like, or any combination thereof. In various implementations or embodiments, processor 1120 may perform signal processing, typically substantially in accordance with fetched executable computer instructions, such as to manipulate signals or states, to construct signals or states, with signals or states generated in such a manner to be communicated or stored in memory, for example.

FIG. 22 also illustrates device 1104 as including a component 1132 operable with input/output devices, for example, so that signals or states may be appropriately communicated between devices, such as device 1104 and an input device or device 1104 and an output device. A user may make use of an input device, such as a computer mouse, stylus, track ball, keyboard, or any other similar device capable of receiving user actions or motions as input signals. Likewise, for a device having speech to text capability, a user may speak to a device to generate input signals. A user may make use of an output device, such as a display, a printer, or any other device capable of providing signals or generating stimuli for a user, such as visual stimuli, audio stimuli or other similar stimuli.

In the preceding description, various aspects of claimed subject matter have been described. For purposes of explanation, specifics, such as amounts, systems or configurations, as examples, were set forth. In other instances, well-known features were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all modifications or changes as fall within claimed subject matter.

### SEQUENCE LISTING

A sequence listing is not included because this application contains no nucleotide or amino-acid sequences.

### Computer Program Listing

Not Applicable.

What is claimed is:

1. An apparatus comprising:
a telecommunication switch-type infrastructure including one or more processing units configured to execute artificial intelligence (AI) processes, neural network processes, or other computer-readable instructions directed to computational linguistics, wherein said infrastructure is connected to an automatic call dispatcher and an audio record server, located between them or within a call center, and further comprising: (a) a Class-4 software-defined networking softswitch configured in a Computational Interpretation of Communication using Artificial Intelligence (CICAI) deployment; (b) one or more interpretation, transcription, translation, or transliteration operations, or any combination thereof, performed on digital signals representative of one or more telecommunication sessions; (c) one or more AI agents performing said operations for respective users in real-time or near real-time; (d) processing units including one or more FPGAs, ASICs, or SoCs dedicated at least in part to computational linguistics including semiological or hermeneutical interpretation of human language; (e) said infrastructure operating in one or more peer-to-peer, one-to-many, many-to-one, or many-to-many configurations; and (f) personalization of said operations based on a user's vernacular.

2. The apparatus of claim 1, wherein the transcription includes insertion of diacritics to mimic intonation, pauses, or vowel pronunciation.

3. The apparatus of claim 1, wherein the telecommunication switch-type infrastructure is located within 10 meters of a call center demarcation point.

4. The apparatus of claim 1, wherein the infrastructure communicates using a TCP/IP signaling protocol or equivalent packet-based protocol.

5. The apparatus of claim 1, wherein an incoming call is received via a T1/T3 PSTN/POTS line at a PBX/media gateway and directed to a call center computing device via a CTI/ACD server, with CRM data provided to the computing device via a cloud CRM system.

6. The apparatus of claim 1, wherein said one or more AI agents include a first AI agent representing an originating caller and a second AI agent representing a destination caller, each configured to perform their respective AI operations.

7. A method comprising:
performing, via a telecommunication switch-type infrastructure having one or more processing units, AI processes, neural network processes, or other computer-readable instructions directed to computational linguistics; wherein the method further includes: (a) receiving incoming calls via PSTN/POTS lines, (b) directing such calls via a PBX/media gateway and CTI/ACD server to user devices, (c) interpreting, transcribing, translating, or transliterating signals using said infrastructure in real-time or near real-time using AI agents, (d) customizing operations to the user's vernacular, and (e) using CRM systems to personalize and guide routing decisions.

8. The method of claim 7, further comprising inserting diacritics into transcriptions to reproduce intonation or pauses.

9. The method of claim 7, wherein said AI agents include separate agents for the originating and receiving parties.

10. The method of claim 7, further comprising operating the infrastructure in peer-to-peer, one-to-many, many-to-one, or many-to-many mode.

11. An article comprising: a non-transitory storage medium having stored thereon instructions executable by a special-purpose computing platform to: (a) perform, via a telecommunication switch-type infrastructure, AI and neural network processes directed to computational linguistics; (b) communicate with call dispatch and record servers; (c) interpret, transcribe, translate, or transliterate digital signals between communication endpoints in real-time or near real-time using AI agents.

12. The article of claim 11, wherein the instructions include logic for operating with Class-4 software-defined CICAI softswitch functionality.

13. The article of claim 11, wherein transcription includes diacritics representing intonation, pauses, or phonetic variation.

14. The article of claim 11, wherein CRM integration is provided to inform call routing and personalization.

15. The article of claim 11, wherein the instructions include logic to deploy AI agents specific to caller endpoints.

16. The article of claim 11, wherein said instructions perform customization based on vernacular using updated user data.

17. The article of claim 11, wherein one or more processing units comprise FPGAs, ASICs, or SoCs.

18. The article of claim 11, further comprising logic for controlling junction points between circuit-switched and packet-switched networks.
